(19) United States
(12) Patent Application Publication
(10) Pub. No.: US 2026/0099034 A1
(43) Pub. Date: Apr. 9, 2026

(54) IMAGING OPTICAL LENS SYSTEM, IMAGE CAPTURING UNIT AND ELECTRONIC DEVICE

(71) Applicant: LARGAN PRECISION CO., LTD., Taichung City (TW)

(72) Inventors: Yu Jui LIN, Taichung City (TW); Yu-Chun KE, Taichung City (TW); Cheng-Yu TSAI, Taichung City (TW)

(73) Assignee: LARGAN PRECISION CO., LTD., Taichung City (TW)

(21) Appl. No.: 18/968,859

(22) Filed: Dec. 4, 2024

(30) Foreign Application Priority Data
Oct. 9, 2024 (TW) 113138389

(51) Int. Cl. G02B 13/00; G02B 9/60

(52) U.S. Cl. CPC G02B 13/0045; G02B 9/60; G02B 13/0065

(57) ABSTRACT

An imaging optical lens system includes five lens elements which are, in order from an object side to an image side along a traveling direction of an optical path: a first lens element, a second lens element, a third lens element, a fourth lens element and a fifth lens element. The first lens element with positive refractive power has an object-side surface being convex in a paraxial region thereof. The second lens element has an object-side surface being convex in a paraxial region thereof and an image-side surface being concave in a paraxial region thereof. The third lens element with negative refractive power has an object-side surface being concave in a paraxial region thereof. The fourth lens element has positive refractive power. At least one surface of at least one lens element in the imaging optical lens system has at least one inflection point.

### RELATED APPLICATIONS

This application claims priority to Taiwan Application 113138389, filed on Oct. 9, 2024, which is incorporated by reference herein in its entirety.

### BACKGROUND

### Technical Field

The present disclosure relates to an imaging optical lens system, an image capturing unit and an electronic device, more particularly to an imaging optical lens system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

In recent years, the trend in electronic products has been towards slimmer and lighter designs, making it difficult for conventional camera lenses to meet the demands for both high specifications and miniaturization, especially in the case of micro lenses with large apertures or telephoto features. Conventional telephoto lens technologies are gradually becoming insufficient to meet the requirements (e.g., total length being too long, aperture being too small, lacking in quality, or not being compact enough). Therefore, different optical features or configurations with optical axis folding are required to overcome these challenges. Due to the thickness limitations of electronic devices, some optical systems are cut in the lens barrel or lens elements to reduce the length in a single axial direction, which helps save space in the module. Additionally, reflective elements can be utilized to provide different optical path directions in the optical system, providing the lens with more flexible space to achieve the telephoto effect of a long focal length.

As technology rapidly advances, electronic devices equipped with optical systems are trending towards multi-functionality for various applications, and therefore the functionality requirements for the optical systems have been increasing. However, it is difficult for conventional optical systems to obtain a balance between image quality, sensitivity, aperture size, size, or field of view.

### SUMMARY

According to one aspect of the present disclosure, an imaging optical lens system includes five lens elements. The five lens elements are, in order from an object side to an image side along a traveling direction of an optical path, a first lens element, a second lens element, a third lens element, a fourth lens element and a fifth lens element. Each of the five lens elements has an object-side surface facing toward the object side and an image-side surface facing toward the image side.

Preferably, the first lens element has positive refractive power. Preferably, the object-side surface of the first lens element is convex in a paraxial region thereof. Preferably, the object-side surface of the second lens element is convex in a paraxial region thereof. Preferably, the image-side surface of the second lens element is concave in a paraxial region thereof. Preferably, the third lens element has negative refractive power. Preferably, the object-side surface of the third lens element is concave in a paraxial region thereof. Preferably, the fourth lens element has positive refractive power. Preferably, at least one surface of at least one lens element in the imaging optical lens system has at least one inflection point. In addition, the imaging optical lens system is in a first state when an imaged object is at an infinite object distance.

When an axial distance between the object-side surface of one lens element closest to the object side and the image-side surface of another lens element closest to the image side in the imaging optical lens system as the imaging optical lens system is in the first state is TDL, an axial distance between the image-side surface of the another lens element closest to the image side and an image surface in the imaging optical lens system as the imaging optical lens system is in the first state is BLL, a curvature radius of the object-side surface of the first lens element is R1, a curvature radius of the object-side surface of the third lens element is R5, a focal length of the second lens element is f2, and a focal length of the third lens element is f3, the following conditions are preferably satisfied:

$$2. < BLL / TDL < 5.5 ;$$

$$- 0.5 \; 0 < ( R 1 - R 5 ) / ( R 1 + R 5 ) < 5. ; and$$

$$0 < \vert f 3 / f 2 \vert < 1. .$$

According to another aspect of the present disclosure, an imaging optical lens system includes five lens elements. The five lens elements are, in order from an object side to an image side along a traveling direction of an optical path, a first lens element, a second lens element, a third lens element, a fourth lens element and a fifth lens element. Each of the five lens elements has an object-side surface facing toward the object side and an image-side surface facing toward the image side.

Preferably, the first lens element has positive refractive power. Preferably, the object-side surface of the first lens element is convex in a paraxial region thereof. Preferably, the object-side surface of the second lens element is convex in a paraxial region thereof. Preferably, the third lens element has negative refractive power. Preferably, the object-side surface of the third lens element is concave in a paraxial region thereof. Preferably, the fourth lens element has positive refractive power. Preferably, at least one surface of at least one lens element in the imaging optical lens system has at least one inflection point. In addition, the imaging optical lens system is in a first state when an imaged object is at an infinite object distance.

When an axial distance between the object-side surface of one lens element closest to the object side and the image-side surface of another lens element closest to the image side in the imaging optical lens system as the imaging optical lens system is in the first state is TDL, an axial distance between the image-side surface of the another lens element closest to the image side and an image surface in the imaging optical lens system as the imaging optical lens system is in the first state is BLL, a refractive index of the first lens element is N1, a refractive index of the fifth lens element is N5, an Abbe number of the fifth lens element is V5, a central thickness of the fifth lens element is CT5, and an axial distance between the fourth lens element and the fifth lens element as the imaging optical lens system is in the first state is T45L, the following conditions are preferably satisfied:

$$2. < BLL / TDL < 5.5 ;$$

$$1.75 < N 1 < 2 \text{.200} ;$$

$$5. < V 5 / N 5 < 15.2 ; and$$

$$0.1 < CT 5 / T 45 L < 3.00 .$$

According to another aspect of the present disclosure, an imaging optical lens system includes a movable lens group and a last lens group in order from an object side to an image side along a traveling direction of an optical path. The movable lens group includes at least one lens element, and the last lens group includes at least one lens element. Each lens element in the imaging optical lens system has an object-side surface facing toward the object side and an image-side surface facing toward the image side.

In addition, the imaging optical lens system is in a first state when an imaged object is at an infinite object distance, and the imaging optical lens system is in a second state when an imaged object is at a finite object distance. The imaging optical lens system undergoes a focus adjustment process to transition from the first state to the second state when an imaged object is moved from an infinite object distance to a finite object distance. The movable lens group is moved along an optical axis relative to the last lens group when the imaging optical lens system transitions from the first state to the second state in the focus adjustment process.

Preferably, the object-side surface of one lens element closest to the object side in the imaging optical lens system is convex in a paraxial region thereof. Preferably, at least one surface of at least one lens element in the imaging optical lens system has at least one inflection point.

When an axial distance between the object-side surface of the one lens element closest to the object side and the image-side surface of another lens element closest to the image side in the imaging optical lens system as the imaging optical lens system is in the first state is TDL, an axial distance between the image-side surface of the another lens element closest to the image side and an image surface in the imaging optical lens system as the imaging optical lens system is in the first state is BLL, and an f-number of the imaging optical lens system in the first state is FnoL, the following conditions are preferably satisfied:

$$2. < BLL / TDL < 5.5 ; and$$

$$1.8 < FnoL < 2.5 .$$

According to another aspect of the present disclosure, an image capturing unit includes one of the aforementioned imaging optical lens systems and an image sensor, wherein the image sensor is disposed on the image surface of the imaging optical lens system.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 shows schematic views of an image capturing unit respectively in a first state and a second state according to the 1st embodiment of the present disclosure;

FIG. 2 shows spherical aberration curves, astigmatic field curves and a distortion curve of the image capturing unit in the first state according to the 1st embodiment;

FIG. 3 shows spherical aberration curves, astigmatic field curves and a distortion curve of the image capturing unit in the second state according to the 1st embodiment;

FIG. 4 shows schematic views of an image capturing unit respectively in a first state and a second state according to the 2nd embodiment of the present disclosure;

FIG. 5 shows spherical aberration curves, astigmatic field curves and a distortion curve of the image capturing unit in the first state according to the 2nd embodiment;

FIG. 6 shows spherical aberration curves, astigmatic field curves and a distortion curve of the image capturing unit in the second state according to the 2nd embodiment;

FIG. 7 shows schematic views of an image capturing unit respectively in a first state and a second state according to the 3rd embodiment of the present disclosure;

FIG. 8 shows spherical aberration curves, astigmatic field curves and a distortion curve of the image capturing unit in the first state according to the 3rd embodiment;

FIG. 9 shows spherical aberration curves, astigmatic field curves and a distortion curve of the image capturing unit in the second state according to the 3rd embodiment;

FIG. 10 shows schematic views of an image capturing unit respectively in a first state and a second state according to the 4th embodiment of the present disclosure;

FIG. 11 shows spherical aberration curves, astigmatic field curves and a distortion curve of the image capturing unit in the first state according to the 4th embodiment;

FIG. 12 shows spherical aberration curves, astigmatic field curves and a distortion curve of the image capturing unit in the second state according to the 4th embodiment;

FIG. 13 shows schematic views of an image capturing unit respectively in a first state and a second state according to the 5th embodiment of the present disclosure;

FIG. 14 shows spherical aberration curves, astigmatic field curves and a distortion curve of the image capturing unit in the first state according to the 5th embodiment;

FIG. 15 shows spherical aberration curves, astigmatic field curves and a distortion curve of the image capturing unit in the second state according to the 5th embodiment;

FIG. 16 shows schematic views of an image capturing unit respectively in a first state and a second state according to the 6th embodiment of the present disclosure;

FIG. 17 shows spherical aberration curves, astigmatic field curves and a distortion curve of the image capturing unit in the first state according to the 6th embodiment;

FIG. 18 shows spherical aberration curves, astigmatic field curves and a distortion curve of the image capturing unit in the second state according to the 6th embodiment;

FIG. 19 shows schematic views of an image capturing unit respectively in a first state and a second state according to the 7th embodiment of the present disclosure;

FIG. 20 shows spherical aberration curves, astigmatic field curves and a distortion curve of the image capturing unit in the first state according to the 7th embodiment;

FIG. 21 shows spherical aberration curves, astigmatic field curves and a distortion curve of the image capturing unit in the second state according to the 7th embodiment;

FIG. 22 shows schematic views of an image capturing unit respectively in a first state and a second state according to the 8th embodiment of the present disclosure;

FIG. 23 shows spherical aberration curves, astigmatic field curves and a distortion curve of the image capturing unit in the first state according to the 8th embodiment;

FIG. 24 shows spherical aberration curves, astigmatic field curves and a distortion curve of the image capturing unit in the second state according to the 8th embodiment;

FIG. 25 shows schematic views of an image capturing unit respectively in a first state and a second state according to the 9th embodiment of the present disclosure;

FIG. 26 shows spherical aberration curves, astigmatic field curves and a distortion curve of the image capturing unit in the first state according to the 9th embodiment;

FIG. 27 shows spherical aberration curves, astigmatic field curves and a distortion curve of the image capturing unit in the second state according to the 9th embodiment;

FIG. 28 shows schematic views of an image capturing unit respectively in a first state and a second state according to the 10th embodiment of the present disclosure;

FIG. 29 shows spherical aberration curves, astigmatic field curves and a distortion curve of the image capturing unit in the first state according to the 10th embodiment;

FIG. 30 shows spherical aberration curves, astigmatic field curves and a distortion curve of the image capturing unit in the second state according to the 10th embodiment;

FIG. 31 is a perspective view of an image capturing unit according to the 11th embodiment of the present disclosure;

FIG. 32 is one perspective view of an electronic device according to the 12th embodiment of the present disclosure;

FIG. 33 is another perspective view of the electronic device in FIG. 32;

FIG. 34 is a block diagram of the electronic device in FIG. 32;

FIG. 35 is one schematic view of an electronic device according to the 13th embodiment of the present disclosure;

FIG. 36 is another schematic view of the electronic device in FIG. 35;

FIG. 37 is one perspective view of an electronic device according to the 14th embodiment of the present disclosure;

FIG. 38 shows a schematic view of Y1R1L, Y5R2L, ET12L, Sag2R1L and ImgH as the image capturing unit is in the first state according to the 1st embodiment of the present disclosure;

FIG. 39 shows a schematic view of inflection points and critical points on lens surfaces as the image capturing unit is in the first state according to the 1st embodiment of the present disclosure;

FIG. 40 shows a schematic view of a shape configuration of an aperture stop of the imaging optical lens system according to one embodiment of the present disclosure;

FIG. 41 shows a schematic view of another shape configuration of an aperture stop of the imaging optical lens system according to one embodiment of the present disclosure;

FIG. 42 to FIG. 44 each shows a schematic view of a configuration of one reflective element in an imaging optical lens system according to one embodiment of the present disclosure;

FIG. 45 and FIG. 46 each shows a schematic view of a configuration of two reflective elements in an imaging optical lens system according to one embodiment of the present disclosure;

FIG. 47 shows a schematic view of a configuration of a double-reflection reflective element in an imaging optical lens system according to one embodiment of the present disclosure;

FIG. 48 shows a schematic view of a configuration of a triple-reflection reflective element in an imaging optical lens system according to one embodiment of the present disclosure;

FIG. 49 shows a schematic view of a configuration of a quadruple-reflection reflective element in an imaging optical lens system according to one embodiment of the present disclosure;

FIG. 50 shows a schematic view of a configuration of a quintuple-reflection reflective element in an imaging optical lens system according to one embodiment of the present disclosure;

FIG. 51 shows a schematic view of a configuration of one reflective element in an imaging optical lens system according to one embodiment of the present disclosure;

FIG. 52 shows a schematic view of a configuration of another reflective element in an imaging optical lens system according to one embodiment of the present disclosure;

FIG. 53 shows a schematic view of a configuration of a reflective element and its associated light path deflection within the image capturing unit in the first state according to the 1st embodiment;

FIG. 54 shows a schematic view of a configuration of another reflective element and its associated light path deflection within the image capturing unit in the first state according to the 1st embodiment;

FIG. 55 shows a schematic view of a configuration of another reflective element and its associated light path deflection within the image capturing unit in the first state according to the 1st embodiment;

FIG. 56 shows a schematic view of a configuration of another reflective element and its associated light path deflection within the image capturing unit in the first state according to the 1st embodiment;

FIG. 57 shows a schematic view of a configuration of another reflective element and its associated light path deflection within the image capturing unit in the first state according to the 1st embodiment;

FIG. 58 shows a schematic view of a configuration of another reflective element and its associated light path deflection within the image capturing unit in the first state according to the 1st embodiment;

FIG. 59 shows schematic views of a configuration of one reflective element and its associated light path deflection within the image capturing unit respectively in the first state and the second state according to the 1st embodiment;

FIG. 60 shows a schematic view of a configuration of a reflective element in the imaging optical lens system of the image capturing unit according to the 1st embodiment;

FIG. 61 shows a perspective view of the reflective element from FIG. 60 before forming trimmed edges and a recess; and

FIG. 62 shows a perspective view of the reflective element from FIG. 60 after forming trimmed edges and a recess.

### DETAILED DESCRIPTION

An imaging optical lens system includes a movable lens group and a last lens group in order from an object side to an image side along a traveling direction of an optical path. The movable lens group includes at least one lens element, and the last lens group includes at least one lens element. Each lens element in the imaging optical lens system has an object-side surface facing toward the object side and an image-side surface facing toward the image side. Therefore, it is favorable for achieving a balance among size, focus adjustment in an object distance range, image quality, and assembly complexity through the configuration of two lens groups.

The imaging optical lens system is in a first state when an imaged object is at an infinite object distance, and the imaging optical lens system is in a second state when an imaged object is at a finite object distance. The imaging optical lens system undergoes a focus adjustment process to transition from the first state to the second state when an imaged object is moved from an infinite object distance to a finite object distance. Conversely, the imaging optical lens system also undergoes a focus adjustment process to transition from the second state to the first state when an imaged object is moved from a finite object distance to an infinite object distance. The object distance refers to an axial distance from an imaged object to the object-side surface of one lens element closest to the object side in the imaging optical lens system. Moreover, when an object distance is greater than 1,000,000 millimeters (mm), it can be considered as an infinite object distance capturing condition. Moreover, when an object distance is less than 5,000 mm, it can be considered as a finite object distance capturing condition.

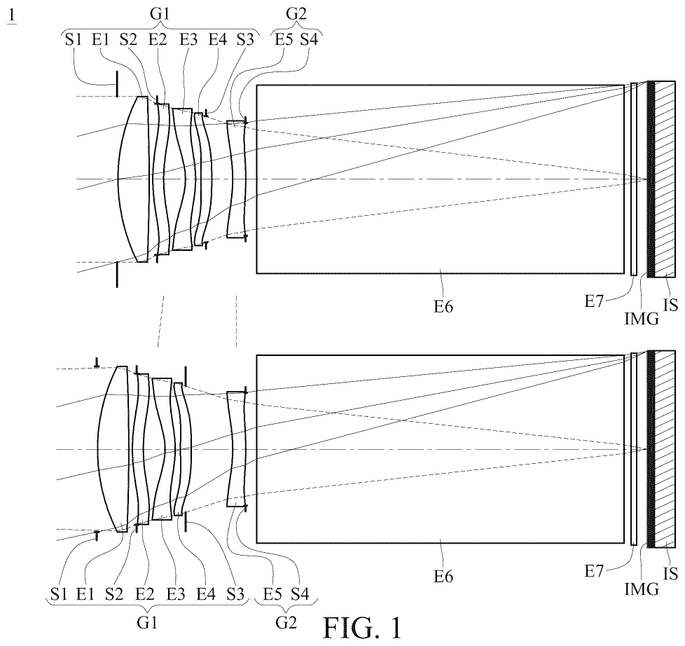

The movable lens group is moved along an optical axis relative to the last lens group when the imaging optical lens system transitions from the first state to the second state in the focus adjustment process. Therefore, it is favorable for achieving a close-up effect while simplifying the complexity of the optical design and mechanism. Moreover, the movable lens group can be moved towards the object side along the optical axis relative to the last lens group when the imaging optical lens system transitions from the first state to the second state in the focus adjustment process. Please refer to FIG. 1, which is a schematic view of an image capturing unit respectively in a first state (infinite object distance) and a second state (finite object distance) according to the 1st embodiment of the present disclosure, where the upper part of FIG. 1 is a schematic view of the imaging optical lens system in the first state, and the lower part of FIG. 1 is a schematic view of the imaging optical lens system in the second state.

All lens elements in the movable lens group can be immovable relative to one another during the focus adjustment process, and all lens elements in the last lens group can be immovable relative to one another during the focus adjustment process. Therefore, it is favorable for simplifying the complexity of the mechanism.

The object-side surface of the one lens element closest to the object side in the imaging optical lens system can be convex in a paraxial region thereof. Therefore, it is favorable for adjusting the surface shape of the one lens element closest to the object side to reduce the outer diameter of the object-side end of the imaging optical lens system.

According to the present disclosure, the imaging optical lens system can further include a reflective element located between the last lens group and an image surface along the traveling direction of the optical path, and there is no additional lens element located between the last lens group and the reflective element along the optical axis. Therefore, it is favorable for providing different optical paths for the imaging optical lens system, allowing for more flexible spatial arrangement of the lens to reduce mechanical constraints and facilitate lens miniaturization.

The last lens group can be immovable relative to the reflective element during the focus adjustment process. Therefore, it is favorable for simplifying the complexity of the mechanism design to improve lens assembly yield rates.

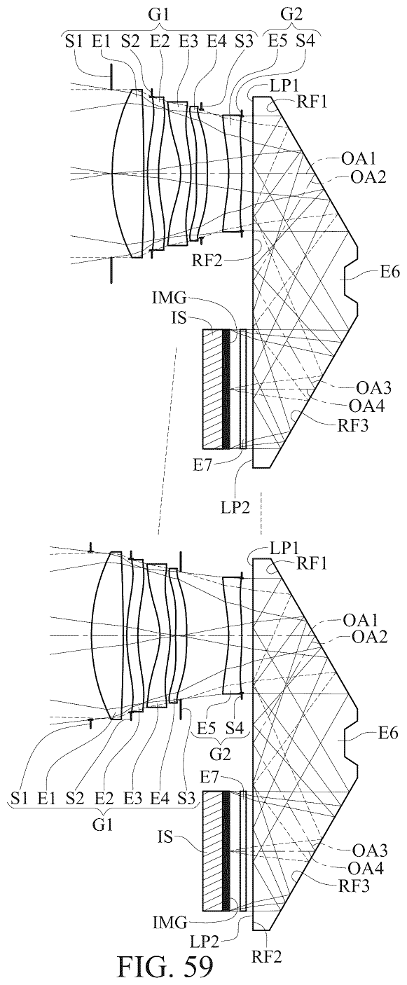

The reflective element can be a prism, and the prism can have at least two reflective surfaces. Therefore, it is favorable for reducing the overall size of the image capturing unit by allowing light to undergo multiple reflections within the prism to form an image. Moreover, the prism can further have a first light permeable surface, and the at least two reflective surfaces of the prism can include a first reflective surface and a second reflective surface in order from the object side to the image side along the traveling direction of the optical path. The first light permeable surface, the first reflective surface and the second reflective surface are arranged in order from the object side to the image side along the traveling direction of the optical path, and the first light permeable surface and the second reflective surface can be coplanar. Therefore, it is favorable for simplifying the structure of the prism and reducing the space required for the prism. Moreover, the prism can also have at least three reflective surfaces. Please refer to FIG. 59, which shows schematic views of a configuration of one reflective element and its associated light path deflection within the image capturing unit respectively in the first state and the second state according to the 1st embodiment, where the upper part of FIG. 59 is a schematic view of the imaging optical lens system in the first state, and the lower part of FIG. 59 is a schematic view of the imaging optical lens system in the second state. As shown in FIG. 59, the reflective element E6 has, in order along the traveling direction of the optical path, a first light permeable surface LP1, a first reflective surface RF1, a second reflective surface RF2, a third reflective surface RF3 and a second light permeable surface LP2, where the first light permeable surface LP1 and the second reflective surface RF2 are coplanar.

When a focal length of the imaging optical lens system in the first state is fL, and a focal length of the movable lens group is fG1, the following condition can be satisfied: 0.80<fL/fG1<1.80. Therefore, it is favorable for adjusting the focal length of the movable lens group to balance the movement range and maintain the back focal length within a limited spatial configuration during the focus adjustment process. Moreover, the following condition can also be satisfied: 0.95<fL/fG1<1.70. The focal length of the movable lens group can refer to a composite focal length of all lens elements in the movable lens group.

When an axial distance between the object-side surface of the one lens element closest to the object side and the image-side surface of another lens element closest to the image side in the imaging optical lens system as the imaging optical lens system is in the second state is TDS, and an axial distance between the object-side surface of the one lens element closest to the object side and the image-side surface of the another lens element closest to the image side in the imaging optical lens system as the imaging optical lens system is in the first state is TDL, the following condition can be satisfied: 0.30 mm<|TDS−TDL|<1.10 mm. Therefore, it is favorable for the movable lens group to achieve focus on objects at shorter object distances with a smaller amount of movement during the focus adjustment process by configuring the movable lens group with a greater number of lens elements. Moreover, the following condition can also be satisfied: 0.50 mm<|TDS−TDL|<0.95 mm.

When an axial distance between the object-side surface of one lens element closest to the object side and the image-side surface of another lens element closest to the image side in the movable lens group is DG1, and an axial distance between the object-side surface of one lens element closest to the object side and the image-side surface of another lens element closest to the image side in the last lens group is DG2, the following condition can be satisfied: 0.01<DG2/DG1<0.40. Therefore, it is favorable for adjusting the axial length of the movable lens group and the axial length of the last lens group to balance the spatial arrangement of the lens elements, thereby reducing system sensitivity during the focusing process. Moreover, the following condition can also be satisfied: 0.02<DG2/DG1<0.30. Moreover, the following condition can also be satisfied: 0.04<DG2/DG1<0.20.

When the axial distance between the object-side surface of the one lens element closest to the object side and the image-side surface of the another lens element closest to the image side in the imaging optical lens system as the imaging optical lens system is in the second state is TDS, and the axial distance between the object-side surface of the one lens element closest to the object side and the image-side surface of the another lens element closest to the image side in the imaging optical lens system as the imaging optical lens system is in the first state is TDL, the following condition can be satisfied: 1.00<10×|TDS−TDL|/TDL<2.50. Therefore, it is favorable for capturing objects at shorter object distances while meeting the specifications of large-size image sensors by controlling the movement range of the movable lens group during the focus adjustment process, thus enhancing imaging quality. Moreover, the following condition can also be satisfied: 1.40<10×|TDS−TDL|/TDL<2.42.

When an axial distance between the object-side surface of the one lens element closest to the object side and the image surface in the imaging optical lens system as the imaging optical lens system is in the second state is TLS, and an axial distance between the object-side surface of the one lens element closest to the object side and the image surface in the imaging optical lens system as the imaging optical lens system is in the first state is TLL, the following condition can be satisfied: 1.025<TLS/TLL<1.100. Therefore, it is favorable for improving image quality for objects at shorter object distances within the size constraints of the electronic device by controlling the total length of lens elements during the focus adjustment process. Moreover, the following condition can also be satisfied: 1.030<TLS/TLL<1.080.

The imaging optical lens system can include five lens elements. The five lens elements are, in order from the object side to the image side along the traveling direction of the optical path, a first lens element, a second lens element, a third lens element, a fourth lens element and a fifth lens element. In addition, the movable lens group can include the first lens element, the second lens element, the third lens element and the fourth lens element, and the last lens group can include the fifth lens element. Moreover, the first lens element can also be referred to as the one lens element closest to the object side, and the fifth lens element can also be referred to as the another lens element closest to the image side.

The first lens element can have positive refractive power. Therefore, it is favorable for adjusting the refractive power of the movable lens group to converge light, thereby controlling the shooting angle while increasing the amount of incident light. The object-side surface of the first lens element can be convex in a paraxial region thereof. Therefore, it is favorable for reducing the outer diameter of the object-side end of the imaging optical lens system. The first lens element can be made of glass material. Therefore, it is favorable for effectively reducing sensitivity to environmental factors by using glass lens element(s), thereby providing high stability across various conditions. Furthermore, employing a glass lens element near the object-side end of the imaging optical lens system is favorable for resisting humid environments and preventing surface scratches, thereby significantly enhancing the lifespan of electronic products.

The second lens element can have positive refractive power. Therefore, it is favorable for assisting in balancing the back focal length of the imaging optical lens system and correcting off-axis aberrations. The object-side surface of the second lens element can be convex in a paraxial region thereof. Therefore, it is favorable for adjusting the surface shape and refractive power of the second lens element to improve the central image quality. The image-side surface of the second lens element can be concave in a paraxial region thereof. Therefore, it is favorable for adjusting the refractive power of the second lens element to correct spherical aberration in the imaging optical lens system.

The third lens element can have negative refractive power. Therefore, it is favorable for adjusting the refractive power of the third lens element to maintain the back focal length. The object-side surface of the third lens element can be concave in a paraxial region thereof. Therefore, it is favorable for controlling the direction of peripheral light in the third lens element to prevent insufficient bending of peripheral light, ensuring effective focusing.

The fourth lens element can have positive refractive power. Therefore, it is favorable for effectively balancing the refractive power of the third lens element to prevent excessive light bending, thereby preventing excessive aberrations introduced by excessive light bending.

The fifth lens element can have negative refractive power. Therefore, it is favorable for balancing the refractive power at the image-side end of the imaging optical lens system to enhance light focusing quality across all fields of view on the image surface and reduce aberrations.

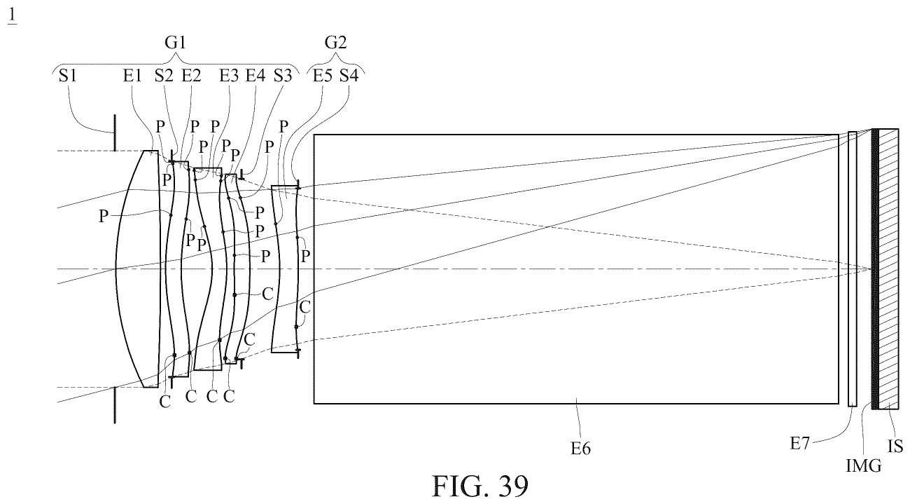

At least one surface of at least one lens element in the imaging optical lens system can have at least one inflection point. In detail, in the imaging optical lens system, there can be one or more lens elements each having at least one inflection point, and a single lens element having at least one inflection point refers to a single lens element in which at least one of the object-side surface and the image-side surface has at least one inflection point. Therefore, it is favorable for increasing the optical design flexibility for astigmatism corrections. Please refer to FIG. 39, which shows a schematic view of the inflection points P on the lens surfaces as the image capturing unit is in the first state according to the 1st embodiment of the present disclosure. In FIG. 39, the image-side surface of the fourth lens element E4, and the object-side surface and the image-side surface of the fifth lens element E5 each have one inflection point P, the image-side surface of the second lens element E2 and the object-side surface of the fourth lens element E4 each have two inflection points P, and the object-side surface of the second lens element E2, and the object-side surface and the image-side surface of the third lens element E3 each have three inflection points P. The 1st embodiment of the present disclosure shown in FIG. 39 is only exemplary. Each of the lens elements in various embodiments of the present disclosure can have one or more inflection points. Additionally, the number of inflection points is calculated only within the area of the optical maximum effective diameter of each lens element. The optical maximum effective diameter range of each lens element can be defined as the area through which the light ray tracing lines of the imaging optical lens system pass when in the first state.

At least one surface of at least one lens element in the imaging optical lens system can have at least one critical point in an off-axis region thereof. In detail, in the imaging optical lens system, there can be one or more lens elements each having at least one critical point in an off-axis region thereof, and a single lens element having at least one critical point in an off-axis region thereof refers to a single lens element in which at least one of the object-side surface and the image-side surface has at least one critical point in an off-axis region thereof. Therefore, it is favorable for adjusting the angle of light incidence on the image surface to control the peripheral light angle, thereby preventing vignetting around the image edges and reducing distortion. Please refer to FIG. 39, which shows a schematic view of the critical points C on the lens surfaces as the image capturing unit is in the first state according to the 1st embodiment of the present disclosure. In FIG. 39, the object-side surface and the image-side surface of the second lens element E2, the image-side surface of the third lens element E3, the image-side surface of the fourth lens element E4, and the image-side surface of the fifth lens element E5 each have one critical point C in an off-axis region thereof, and the object-side surface of the fourth lens element E4 has two critical points C in an off-axis region thereof. The 1st embodiment of the present disclosure shown in FIG. 39 is only exemplary. Each of the lens elements in various embodiments of the present disclosure can have one or more critical points in an off-axis region thereof. Additionally, the number of critical points is calculated only within the area of the optical maximum effective diameter of each lens element.

When an axial distance between the image-side surface of the another lens element closest to the image side and the image surface in the imaging optical lens system as the imaging optical lens system is in the first state is BLL, and the axial distance between the object-side surface of the one lens element closest to the object side and the image-side surface of the another lens element closest to the image side in the imaging optical lens system as the imaging optical lens system is in the first state is TDL, the following condition can be satisfied: 2.00<BLL/TDL<5.50. Therefore, it is favorable for adjusting the back focal length to an appropriate length to facilitate optical path folding. Moreover, the following condition can also be satisfied: 2.30<BLL/TDL<4.50. Moreover, the following condition can also be satisfied: 2.50<BLL/TDL<4.20. Moreover, the following condition can also be satisfied: 2.67≤BLL/TDL≤3.76.

When a curvature radius of the object-side surface of the first lens element is R1, and a curvature radius of the object-side surface of the third lens element is R5, the following condition can be satisfied: −0.50<(R1−R5)/(R1+R5)<5.00. Therefore, it is favorable for adjusting the curvature radii of the object-side surface of the first lens element and the object-side surface of the third lens element to create more curved lens surfaces, thereby maintaining the back focal length while enlarging the image surface. Moreover, the following condition can also be satisfied: 0.50<(R1−R5)/(R1+R5)<4.50. Moreover, the following condition can also be satisfied: 1.00<(R1−R5)/(R1+R5)<4.00. Moreover, the following condition can also be satisfied: 1.36≤(R1−R5)/(R1+R5)≤3.46.

When a focal length of the second lens element is f2, and a focal length of the third lens element is f3, the following condition can be satisfied: 0<|f3/f2|<1.00.

Therefore, it is favorable for balancing the refractive power of the second lens element and the refractive power of the third lens element to regulate light convergence or divergence, thereby enhancing light focusing quality across the entire field of view. Moreover, the following condition can also be satisfied: 0<|f3/f2| <0.80. Moreover, the following condition can also be satisfied: 0.01<|f3/f2|<0.60. Moreover, the following condition can also be satisfied: 0.02≤|f3/f2|≤0.40.

When a refractive index of the first lens element is N1, the following condition can be satisfied: 1.750<N1<2.200. Therefore, it is favorable for adjusting the refractive index of the first lens element to enhance the light-converging ability of the first lens element and reduce the impact of temperature effects on imaging quality. Moreover, the following condition can also be satisfied: 1.800<N1<2.100. Moreover, the following condition can also be satisfied: 1.850<N1<2.000. Moreover, the following condition can also be satisfied: 1.883≤N1≤1.954.

When an Abbe number of the fifth lens element is V5, and a refractive index of the fifth lens element is N5, the following condition can be satisfied: 5.00<V5/N5<15.20. Therefore, it is favorable for adjusting the material composition of the fifth lens element to balance chromatic aberration correction among different wavelengths of light, thereby enhancing image quality. Moreover, the following condition can also be satisfied: 8.00<V5/N5<14.80. Moreover, the following condition can also be satisfied: 10.91≤V5/N5≤14.34.

When a central thickness of the fifth lens element is CT5, and an axial distance between the fourth lens element and the fifth lens element as the imaging optical lens system is in the first state is T45L, the following condition can be satisfied: 0.10<CT5/T45L<3.00. Therefore, it is favorable for balancing the angle of light incidence on the image surface during the focus adjustment process by having a greater distance between the fourth lens element and the fifth lens element, thereby preventing the generation of stray light. Moreover, the following condition can also be satisfied: 0.15<CT5/T45L<2.00. Moreover, the following condition can also be satisfied: 0.20<CT5/T45L<1.20. Moreover, the following condition can also be satisfied: 0.30≤CT5/T45L≤0.87.

When an f-number of the imaging optical lens system in the first state is FnoL, the following condition can be satisfied: 1.80<FnoL<2.50. Therefore, it is favorable for achieving a balance between illuminance and depth of field, and increasing the amount of incident light to enhance image quality. Moreover, the following condition can also be satisfied: 2.00<FnoL<2.40.

When the axial distance between the object-side surface of the one lens element closest to the object side and the image surface in the imaging optical lens system as the imaging optical lens system is in the first state is TLL, and the focal length of the imaging optical lens system in the first state is fL, the following condition can be satisfied: 1.30<TLL/fL<1.70. Therefore, it is favorable for achieving a balance between the total track length and the field of view. Moreover, the following condition can also be satisfied: 1.40<TLL/fL<1.60.

When the axial distance between the fourth lens element and the fifth lens element as the imaging optical lens system is in the first state is T45L, and the focal length of the imaging optical lens system in the first state is fL, the following condition can be satisfied: 0.12<10×T45L/fL<1.00. Therefore, it is favorable for balancing the total focal length and the axial distance between the fourth lens element and the fifth lens element to maintain the telephoto effect of a long focal length and simplify the complexity of the mechanical design during the focus adjustment process. Moreover, the following condition can also be satisfied: 0.18<10×T45L/fL<0.80.

When the focal length of the imaging optical lens system in the first state is fL, and the focal length of the third lens element is f3, the following condition can be satisfied: −3.00<fL/f3<−1.00. Therefore, it is favorable for balancing light convergence or divergence to enhance high light-gathering quality for multi-range object distances and maintain the back focal length by having stronger refractive power of the third lens element. Moreover, the following condition can also be satisfied: −2.70<fL/f3<−1.20. Moreover, the following condition can also be satisfied: −2.76≤fL/f3≤−1.48.

When the curvature radius of the object-side surface of the first lens element is R1, and a curvature radius of the image-side surface of the second lens element is R4, the following condition can be satisfied: −1.00<(R1−R4)/(R1+R4)<1.50. Therefore, it is favorable for effectively balancing the curvature radii of the object-side surface of the first lens element and the image-side surface of the second lens element to improve the light-gathering quality of imaging rays, thereby effectively reducing field curvature and minimizing spherical aberration. Moreover, the following condition can also be satisfied: −0.50<(R1−R4)/(R1+R4)<1.00.

When the Abbe number of the fifth lens element is V5, the following condition can be satisfied: 5.0<V5<30.0. Therefore, it is favorable for adjusting the Abbe number of the fifth lens element to correct chromatic aberration. Moreover, the following condition can also be satisfied: 8.0<V5<27.0. Moreover, the following condition can also be satisfied: 15.0<V5<25.0.

When an axial distance between the second lens element and the third lens element as the imaging optical lens system is in the first state is T23L, and a central thickness of the fourth lens element is CT4, the following condition can be satisfied: 0.65<T23L/CT4<2.50. Therefore, it is favorable for balancing the axial distance between the second lens element and the third lens element and the central thickness of the fourth lens element to increase space utilization efficiency. Moreover, the following condition can also be satisfied: 0.70<T23L/CT4<2.20.

When half of a maximum field of view of the imaging optical lens system in the first state is HFOVL, the following condition can be satisfied: 8.0 degrees<HFOVL<20.0 degrees. Therefore, it is favorable for the imaging optical lens system to have an appropriate field of view for telephoto applications. Moreover, the following condition can also be satisfied: 10.0 degrees<HFOVL<18.0 degrees. Moreover, the following condition can also be satisfied: 12.0 degrees<HFOVL<16.5 degrees.

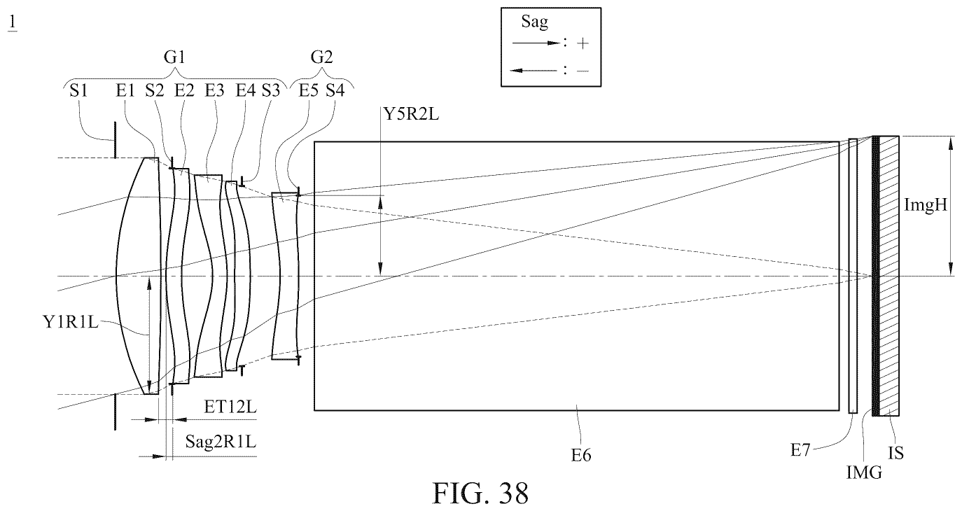

When a maximum effective radius of the object-side surface of the first lens element as the imaging optical lens system is in the first state is Y1 R1 L, and a maximum effective radius of the image-side surface of the fifth lens element as the imaging optical lens system is in the first state is Y5R2L, the following condition can be satisfied: 1.30<Y1 R1 L/Y5R2L<1.80. Therefore, it is favorable for controlling the beam size, and preventing the effective radius from becoming too large, which could hinder light from passing through the reflective element and affect the imaging performance of the imaging optical lens system. Moreover, the following condition can also be satisfied: 1.35<Y1 R1 L/Y5R2L<1.65. Please refer to FIG. 38, which shows a schematic view of Y1 R1 L and Y5R2L as the image capturing unit is in the first state according to the 1st embodiment of the present disclosure.

When the maximum effective radius of the object-side surface of the first lens element as the imaging optical lens system is in the first state is Y1 R1 L, and a maximum image height of the imaging optical lens system (which can be half of a diagonal length of an effective photosensitive area of an image sensor) is ImgH, the following condition can be satisfied: 0.65<Y1R1L/ImgH<1.20. Therefore, it is favorable for balancing the effective radius on the object side of the first lens element with the image height and adjusting of the light path direction to reduce the outer diameter of the object-side end of the imaging optical lens system and enlarge the image surface. Moreover, the following condition can also be satisfied: 0.72<Y1 R1 L/ImgH<1.00. Please refer to FIG. 38, which shows a schematic view of Y1 R1 L and ImgH as the image capturing unit is in the first state according to the 1st embodiment of the present disclosure.

When a central thickness of the first lens element is CT1, and a central thickness of the second lens element is CT2, the following condition can be satisfied: 0.50<CT1/CT2<2.20. Therefore, it is favorable for balancing a ratio of the central thickness of the first lens element to that of the second lens element, and adjusting the central thickness of the first lens element to provide the first lens element with stronger light-bending capability. Moreover, the following condition can also be satisfied: 0.80<CT1/CT2<2.00.

When the focal length of the imaging optical lens system in the first state is fL, and the curvature radius of the object-side surface of the third lens element is R5, the following condition can be satisfied: −9.00<fL/R5<−2.00. Therefore, it is favorable for adjusting the configuration of the total focal length and the curvature radius of the object-side surface of the third lens element, allowing the imaging optical lens system to correct off-axis aberrations while maintaining a smaller outer diameter and an appropriate back focal length. Moreover, the following condition can also be satisfied: −7.00<fL/R5<−2.30.

When a curvature radius of the object-side surface of the second lens element is R3, the curvature radius of the image-side surface of the second lens element is R4, and the focal length of the imaging optical lens system in the first state is fL, the following condition can be satisfied: 0.20<|R3/fL|+|R4/fL|<2.20. Therefore, it is favorable for effectively balancing the curvature radii of the object-side surface and the image-side surface of the second lens element, and adjusting the direction of peripheral light to correct astigmatism and reduce stray light in the imaging optical lens system. Moreover, the following condition can also be satisfied: 0.40<|R3/fL|+|R4/fL|<2.10.

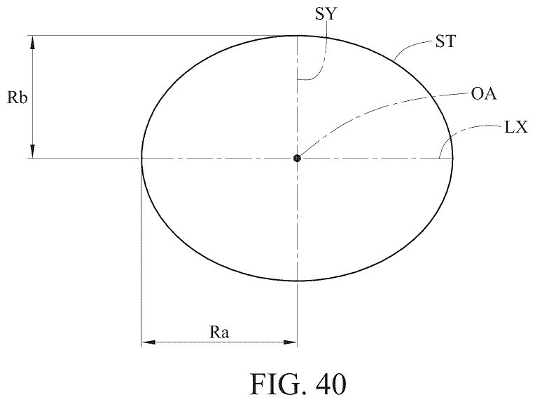

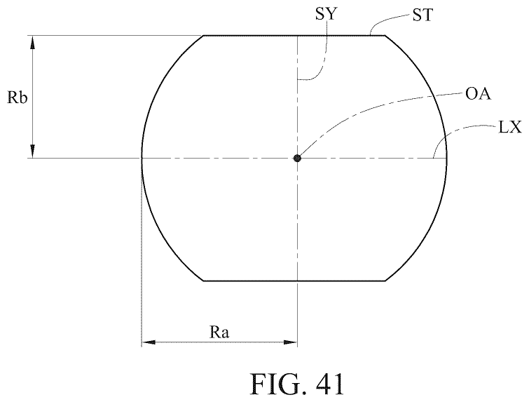

According to the present disclosure, the imaging optical lens system can further include an aperture stop. Therefore, it is favorable for controlling the shooting angle of view of the imaging optical lens system and ensuring that the lens has a sufficient amount of incident light in the telephoto structure. Moreover, the aperture stop can have a major axis direction and a minor axis direction which are perpendicular to an optical axis and different from each other, and an effective radius of the aperture stop in the major axis direction is different from an effective radius of the aperture stop in the minor axis direction. Therefore, it is favorable for adjusting the shape of the aperture stop so as to reduce stray light. For example, please refer to FIG. 40 and FIG. 41, which show schematic views of non-circular aperture stops according to some aspects of the present disclosure, where FIG. 40 shows a schematic view of a shape configuration of an aperture stop of the imaging optical lens system according to one embodiment of the present disclosure, and FIG. 41 shows a schematic view of another shape configuration of an aperture stop of the imaging optical lens system according to one embodiment of the present disclosure. As shown in FIG. 40, in some aspects of the present disclosure, a shape of an aperture stop ST is elliptical, and the aperture stop ST has a major axis LX direction and a minor axis SY direction perpendicular to an optical axis OA. The major axis LX direction and the minor axis SY direction are two different directions, and an effective radius Ra of the aperture stop ST in the major axis LX direction is larger than an effective radius Rb of the aperture stop ST in the minor axis SY direction. As shown in FIG. 41, in some aspects of the present disclosure, an aperture stop ST is shaped to have trimmed edges at an outer periphery thereof, and the aperture stop ST has a major axis LX direction and a minor axis SY direction perpendicular to an optical axis OA. The major axis LX direction and the minor axis SY direction are two different directions, and an effective radius Ra of the aperture stop ST in the major axis LX direction is larger than an effective radius Rb of the aperture stop ST in the minor axis SY direction.

When an axial distance between the aperture stop and the image-side surface of the another lens element closest to the image side in the imaging optical lens system as the imaging optical lens system is in the first state is SDL, and the axial distance between the object-side surface of the one lens element closest to the object side and the image-side surface of the another lens element closest to the image side in the imaging optical lens system as the imaging optical lens system is in the first state is TDL, the following condition can be satisfied: 0.87<SDL/TDL<1.20. Therefore, it is favorable for reducing the outer diameter of the object-side end of the imaging optical lens system and preventing stray light in the peripheral areas by positioning the aperture stop near the object-side end. Moreover, the following condition can also be satisfied: 0.95<SDL/TDL<1.10.

When an axial distance between the third lens element and the fourth lens element as the imaging optical lens system is in the first state is T34L, and the central thickness of the second lens element is CT2, the following condition can be satisfied: 0.80<T34L/CT2<2.00. Therefore, it is favorable for balancing the central thickness of the second lens element and the axial distance between the third lens element and the fourth lens element to correct spherical aberration and reduce manufacturing tolerances. Moreover, the following condition can also be satisfied: 1.00<T34L/CT2<1.50.

When a displacement in parallel with the optical axis from an axial vertex of the object-side surface of the second lens element to a maximum effective radius position of the object-side surface of the second lens element as the imaging optical lens system is in the first state is Sag2R1L, and the central thickness of the second lens element is CT2, the following condition can be satisfied: 0.40<Sag2R1L/CT2<1.20. Therefore, it is favorable for the periphery of the second lens element to control the beam direction so as to control the angle of light entering the image surface and prevent stray light from occurring after passing through the reflective element. Moreover, the following condition can also be satisfied: 0.50<Sag2R1L/CT2<1.00. Please refer to FIG. 38, which shows a schematic view of Sag2R1L as the image capturing unit is in the first state according to the 1st embodiment of the present disclosure. When the direction from the axial vertex of one surface to the maximum effective radius position of the same surface is facing towards the image side of the imaging optical lens system, the value of displacement is positive; when the direction from the axial vertex of the surface to the maximum effective radius position of the same surface is facing towards the object side of the imaging optical lens system, the value of displacement is negative.

When a distance in parallel with the optical axis between a maximum effective radius position of the image-side surface of the first lens element and the maximum effective radius position of the object-side surface of the second lens element as the imaging optical lens system is in the first state is ET12L, and the central thickness of the second lens element is CT2, the following condition can be satisfied: 0.70<ET12L/CT2<1.50. Therefore, it is favorable for balancing the peripheral distance between the first lens element and the second lens element to effectively control the angle of light deflection at the periphery of the object-side of the second lens element, thereby preventing light divergence. Moreover, the following condition can also be satisfied: 0.75<ET12L/CT2<1.40. Please refer to FIG. 38, which shows a schematic view of ET12L as the image capturing unit is in the first state according to the 1st embodiment of the present disclosure.

When the central thickness of the first lens element is CT1, and an axial distance between the object-side surface of the second lens element and the image-side surface of the fourth lens element as the imaging optical lens system is in the first state is Dr3r8L, the following condition can be satisfied: 0.15<CT1/Dr3r8L<0.65. Therefore, it is favorable for controlling the proportion of the central thickness of the first lens element within the movable lens group to meet the manufacturing constraints of the first lens element, and adjusting the spatial configuration of other lens elements in the movable lens group to reduce the size of the imaging optical lens system. Moreover, the following condition can also be satisfied: 0.20<CT1/Dr3r8L<0.48.

According to the present disclosure, the aforementioned features and conditions can be utilized in numerous combinations so as to achieve corresponding effects.

According to the present disclosure, the lens elements of the imaging optical lens system can be made of either glass or plastic material. When the lens elements are made of glass material, the refractive power distribution of the imaging optical lens system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the imaging optical lens system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the imaging optical lens system, based on the corresponding image sensor, can be flat or curved, especially a curved surface being concave facing towards the object side of the imaging optical lens system.

According to the present disclosure, an image correction unit, such as a field flattener, can be optionally disposed between the lens element closest to the image side of the imaging optical lens system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, at least one reflective element, such as a prism or a reflective mirror, can be optionally provided, but the present disclosure is not limited thereto. Therefore, the imaging optical lens system can be more flexible in space arrangement. The surface of the prism or reflective mirror can be planar, spherical, aspheric or have a freeform shape, such that the imaging optical lens system can be more flexible in space arrangement. Moreover, when the surface of the prism is, for example, spherical, aspheric or have a freeform shape, the prism can also have refractive power, thereby enabling it to converge or diverge light. The reflective element can be disposed between an imaged object and the image surface so as to reduce the size of the imaging optical lens system. The optical path can be deflected one time, two times, three times or more by a single reflective element. In addition, the reflective element can have at least one reflective surface, and an angle between the optical axis and a normal direction of the reflective surface is not limited to 45 degrees, but can be other angles depending on the space arrangement. The optical path along an optical axis at the object side can be redirected to an optical axis at the image side by the reflective element. An angle between a vector of the optical axis at the object side and that at the image side can be any angle, not limited to 0, 90 or 180 degrees. In addition, in order to reduce the size of the imaging optical lens system, the length and the width of the reflective mirror may be different from each other, and the length, the width and the height of the prism may be different from one another. The surface of the reflective element (e.g., the surface of the prism or the reflective mirror) can be planar, spherical, aspheric or have a freeform shape according to the optical design requirements, but the present disclosure is not limited thereto. The reflective element can consist of more than one prism depending on the design requirements. The prism can be made of glass material or plastic material depending on the design requirements. It is noted that the prism with optical path folding function and light converging or diverging function is not one of the lens elements; that is, the prism with optical path folding function and light converging or diverging function is not included in the five lens elements of the imaging optical lens system.

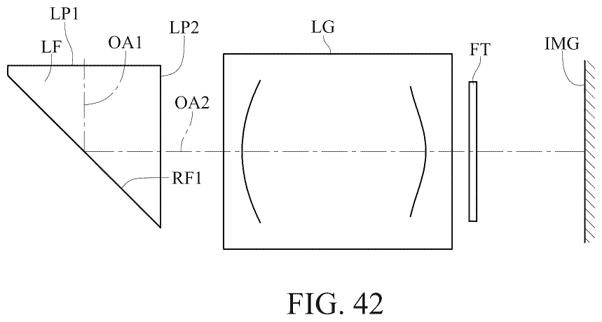

Furthermore, please refer to FIG. 42 through FIG. 44, each of which shows a schematic view of a configuration of one reflective element in an imaging optical lens system according to one embodiment of the present disclosure. As shown in FIG. 42 to FIG. 44, the imaging optical lens system can include, in order from an object side to an image side along a traveling direction of an optical path, a reflective element LF, a lens group LG, a filter FT, and an image surface IMG.

In FIG. 42, the reflective element LF is a prism and has, in sequence along the traveling direction of the optical path, a first light permeable surface LP1, a reflective surface RF1, and a second light permeable surface LP2. The optical path enters the reflective element LF through the first light permeable surface LP1 and reaches the reflective surface RF1 along a first optical axis OA1. The reflective surface RF1 deflects the optical path from the first optical axis OA1 to a second optical axis OA2, and the optical path then passes through the second light permeable surface LP2, travels through the lens group LG and the filter FT, and ultimately arrives at the image surface IMG along the second optical axis OA2. As shown in FIG. 42, both of the first light permeable surface LP1 and the second light permeable surface LP2 of the reflective element LF can be planar.

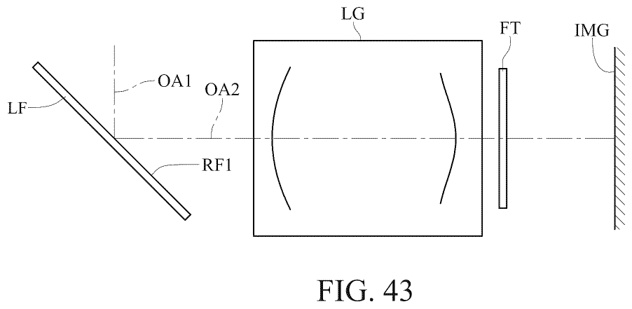

In FIG. 43, the reflective element LF is a flat reflective mirror having a reflective surface RF1. The optical path reaches the reflective surface RF1 along a first optical axis OA1. The reflective surface RF1 deflects the optical path from the first optical axis OA1 to a second optical axis OA2. Subsequently, the optical path travels through the lens group LG and the filter FT, and ultimately arrives at the image surface IMG along the second optical axis OA2.

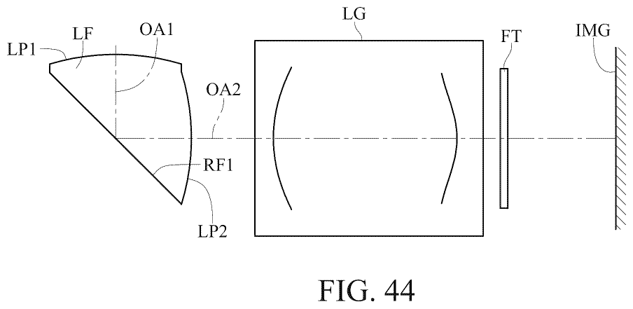

In FIG. 44, the reflective element LF is a prism and has, in sequence along the traveling direction of the optical path, a first light permeable surface LP1, a reflective surface RF1, and a second light permeable surface LP2. The optical path enters the reflective element LF through the first light permeable surface LP1 and reaches the reflective surface RF1 along a first optical axis OA1. The reflective surface RF1 deflects the optical path from the first optical axis OA1 to a second optical axis OA2, and the optical path then passes through the second light permeable surface LP2, travels through the lens group LG and the filter FT, and ultimately arrives at the image surface IMG along the second optical axis OA2. As shown in FIG. 44, both of the first light permeable surface LP1 and the second light permeable surface LP2 of the reflective element LF can be curved.

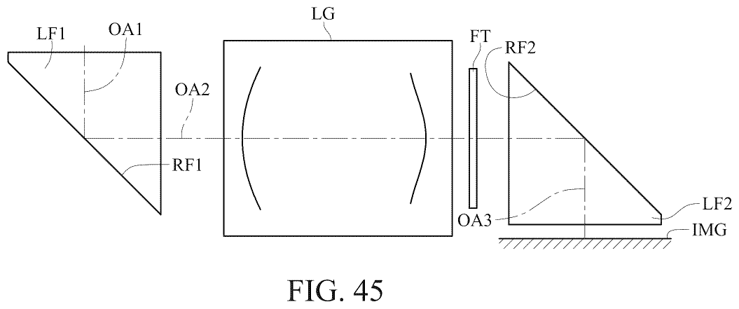

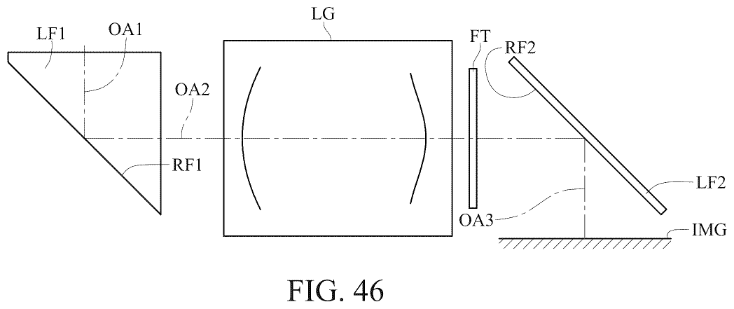

Moreover, please refer to FIG. 45 and FIG. 46, each of which shows a schematic view of a configuration of two reflective elements in an imaging optical lens system according to one embodiment of the present disclosure. As shown in FIG. 45 and FIG. 46, the imaging optical lens system can include, in order from an object side to an image side along a traveling direction of an optical path, a first reflective element LF1, a lens group LG, a filter FT, a second reflective element LF2 and an image surface IMG. The optical path enters the first reflective element LF1 and reaches a first reflective surface RF1 of the first reflective element LF1 along a first optical axis OA1, and the first reflective surface RF1 deflects the optical path from the first optical axis OA1 to a second optical axis OA2. The optical path travels through the lens group LG and the filter FT along the second optical axis OA2. Subsequently, the optical path enters the second reflective element LF2 and reaches a second reflective surface RF2 of the second reflective element LF2 along the second optical axis OA2, and the second reflective surface RF2 deflects the optical path from the second optical axis OA2 to a third optical axis OA3. The optical path ultimately arrives at the image surface IMG along the third optical axis OA3. In FIG. 45, each of the first reflective element LF1 and the second reflective element LF2 can be a prism. In FIG. 46, the first reflective element LF1 and the second reflective element LF2 can be a prism and a flat reflective mirror, respectively.

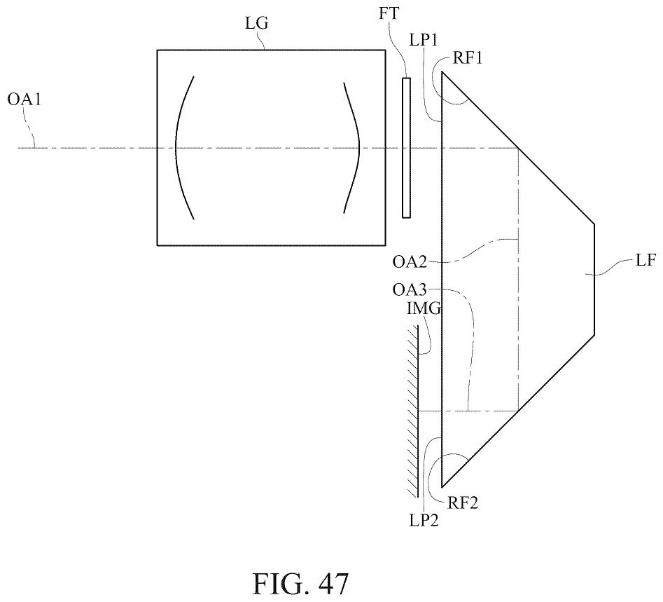

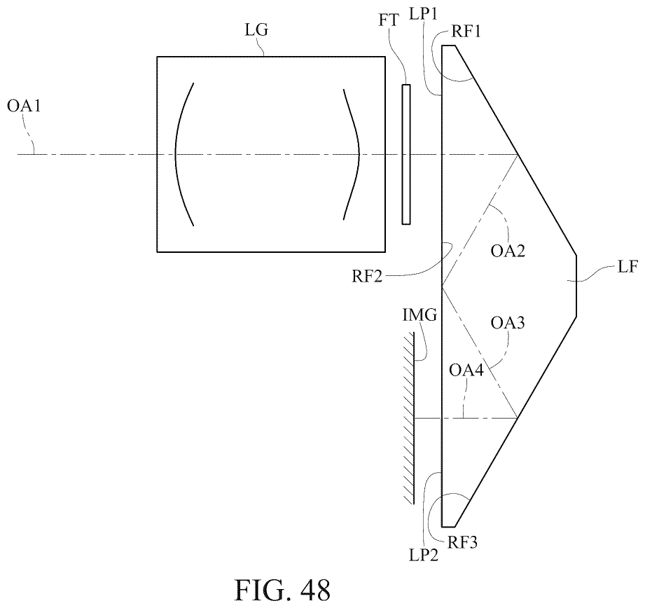

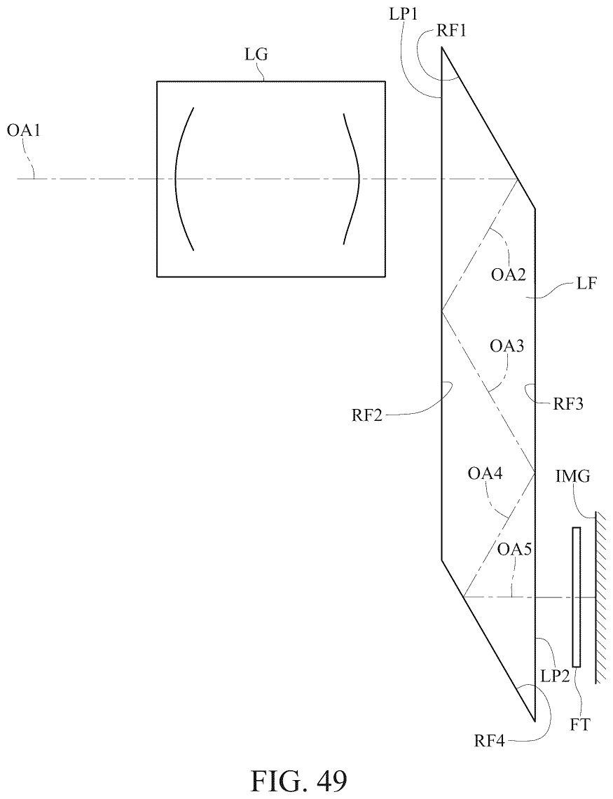

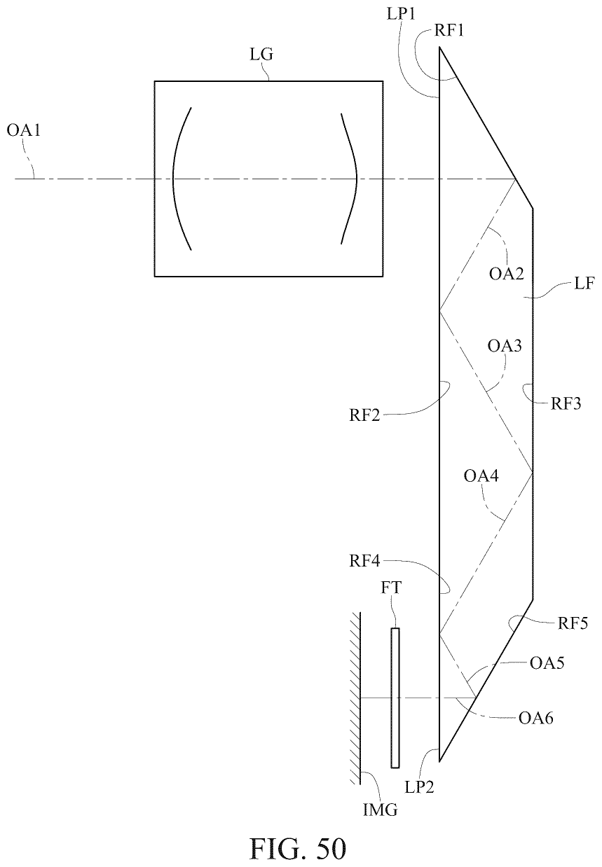

In addition, please refer to FIG. 47 to FIG. 50. FIG. 47 shows a schematic view of a configuration of a double-reflection reflective element in an imaging optical lens system according to one embodiment of the present disclosure, FIG. 48 shows a schematic view of a configuration of a triple-reflection reflective element in an imaging optical lens system according to one embodiment of the present disclosure, FIG. 49 shows a schematic view of a configuration of a quadruple-reflection reflective element in an imaging optical lens system according to one embodiment of the present disclosure, and FIG. 50 shows a schematic view of a configuration of a quintuple-reflection reflective element in an imaging optical lens system according to one embodiment of the present disclosure.

As shown in FIG. 47, the imaging optical lens system can include, in order from an object side to an image side along a traveling direction of an optical path, a lens group LG, a filter FT, a reflective element LF and an image surface IMG. The reflective element LF can be a prism and has, in sequence along the traveling direction of the optical path, a first light permeable surface LP1, a first reflective surface RF1, a second reflective surface RF2 and a second light permeable surface LP2. The optical path travels through the lens group LG and the filter FT, enters the reflective element LF through the first light permeable surface LP1, and reaches the first reflective surface RF1 along a first optical axis OA1. The first reflective surface RF1 deflects the optical path from the first optical axis OA1 to a second optical axis OA2, the second reflective surface RF2 deflects the optical path from the second optical axis OA2 to a third optical axis OA3, and then the optical path passes through the second light permeable surface LP2 and ultimately arrives at the image surface IMG along the third optical axis OA3.

As shown in FIG. 48, the imaging optical lens system can include, in order from an object side to an image side along a traveling direction of an optical path, a lens group LG, a filter FT, a reflective element LF and an image surface IMG. The reflective element LF can be a prism and has, in sequence along the traveling direction of the optical path, a first light permeable surface LP1, a first reflective surface RF1, a second reflective surface RF2, a third reflective surface RF3 and a second light permeable surface LP2. The optical path travels through the lens group LG and the filter FT, enters the reflective element LF through the first light permeable surface LP1 and reaches the first reflective surface RF1 along a first optical axis OA1. The first reflective surface RF1 deflects the optical path from the first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, and then the optical path passes through the second light permeable surface LP2 and ultimately arrives at the image surface IMG along the fourth optical axis OA4. Moreover, the first light permeable surface LP1 and the second reflective surface RF2 can be coplanar.

As shown in FIG. 49, the imaging optical lens system can include, in order from an object side to an image side along a traveling direction of an optical path, a lens group LG, a reflective element LF, a filter FT and an image surface IMG. The reflective element LF can be a prism and has, in sequence along the traveling direction of the optical path, a first light permeable surface LP1, a first reflective surface RF1, a second reflective surface RF2, a third reflective surface RF3, a fourth reflective surface RF4 and a second light permeable surface LP2. The optical path travels through the lens group LG, enters the reflective element LF through the first light permeable surface LP1 and reaches the first reflective surface RF1 along a first optical axis OA1. The first reflective surface RF1 deflects the optical path from the first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, the fourth reflective surface RF4 deflects the optical path from the fourth optical axis OA4 to a fifth optical axis OA5. Subsequently, the optical path passes through the second light permeable surface LP2, travels through the filter FT, and ultimately arrives at the image surface IMG along the fifth optical axis OA5. Moreover, the first light permeable surface LP1 and the second reflective surface RF2 can be coplanar.

As shown in FIG. 50, the imaging optical lens system can include, in order from an object side to an image side along a traveling direction of an optical path, a lens group LG, a reflective element LF, a filter FT and an image surface IMG. The reflective element LF can be a prism and has, in sequence along the traveling direction of the optical path, a first light permeable surface LP1, a first reflective surface RF1, a second reflective surface RF2, a third reflective surface RF3, a fourth reflective surface RF4, a fifth reflective surface RF5 and a second light permeable surface LP2. The optical path travels through the lens group LG, enters the reflective element LF through the first light permeable surface LP1 and reaches the first reflective surface RF1 along a first optical axis OA1. The first reflective surface RF1 deflects the optical path from the first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, the fourth reflective surface RF4 deflects the optical path from the fourth optical axis OA4 to a fifth optical axis OA5, and the fifth reflective surface RF5 deflects the optical path from the fifth optical axis OA5 to a sixth optical axis OA6. Subsequently, the optical path passes through the second light permeable surface LP2, travels through the filter FT, and ultimately arrives at the image surface IMG along the sixth optical axis OA6. Moreover, the first light permeable surface LP1 and the second reflective surface RF2 can be coplanar.

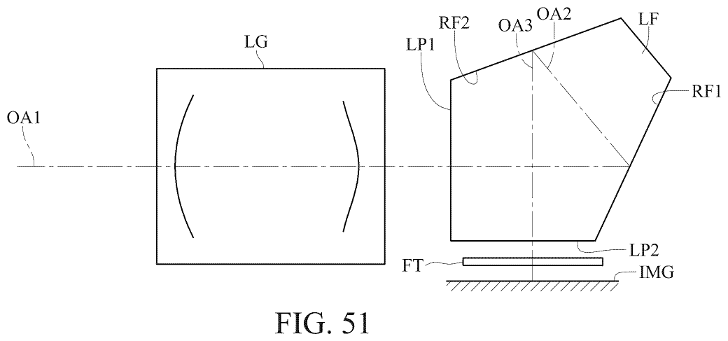

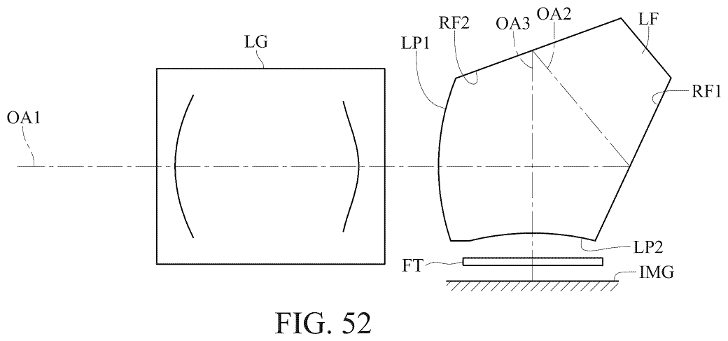

Moreover, please refer to FIG. 51 and FIG. 52. FIG. 51 shows a schematic view of a configuration of one reflective element in an imaging optical lens system according to one embodiment of the present disclosure, and FIG. 52 shows a schematic view of a configuration of another reflective element in an imaging optical lens system according to one embodiment of the present disclosure. As shown in FIG. 51 and FIG. 52, the imaging optical lens system can include, in order from an object side to an image side along a travelling direction of an optical path, a lens group LG, a reflective element LF, a filter FT and an image surface IMG. The reflective element LF can be a pentaprism and has, in sequence along the traveling direction of the optical path, a first light permeable surface LP1, a first reflective surface RF1, a second reflective surface RF2 and a second light permeable surface LP2. The optical path enters the reflective element LF through the first light permeable surface LP1 and reaches the first reflective surface RF1 along a first optical axis OA1. The first reflective surface RF1 deflects the optical path from the first optical axis OA1 to a second optical axis OA2, and the second reflective surface RF2 deflects the optical path from the second optical axis OA2 to a third optical axis OA3. Subsequently, the optical path passes through the second light permeable surface LP2, then travels through the filter FT, and ultimately arrives at the image surface IMG along the third optical axis OA3. In FIG. 51, both of the first light permeable surface LP1 and the second light permeable surface LP2 can be planar. In FIG. 52, both of the first light permeable surface LP1 and the second light permeable surface LP2 can be curved. Furthermore, as shown in FIG. 51 and FIG. 52, the first optical axis OA1 and third optical axis OA3 can intersect and be perpendicular to each other.

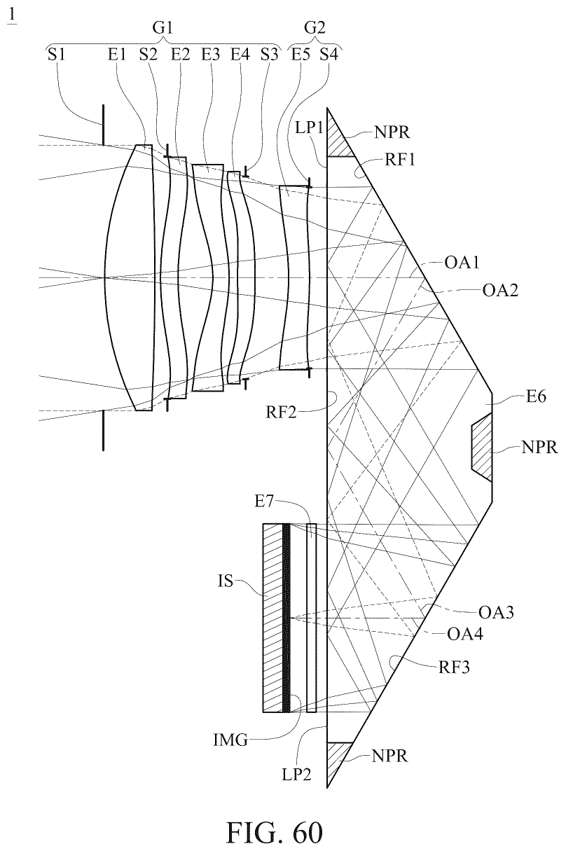

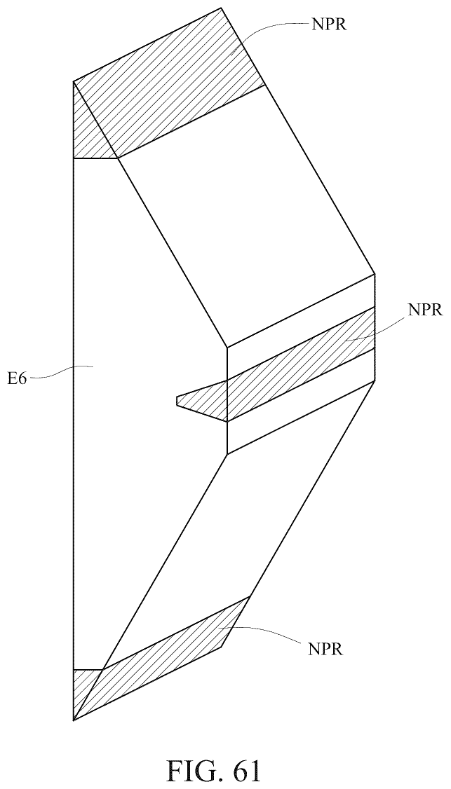

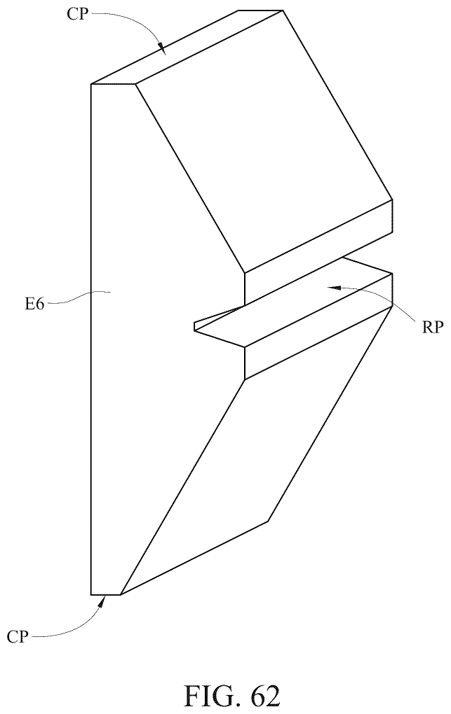

Furthermore, in order to reduce the size of the imaging optical lens system, the length and the width of the reflective mirror may be different from each other, the length, the width and the height of the prism may also be different from one another, and the prism can have at least one trimmed edge or at least one recess at its optically non-effective area so as to reduce its weight and size and to be configured in accordance with other components in the electronic device. Moreover, a light absorbing layer can be coated on the surface in the recess so as to prevent light reflection and block stray light. Please refer to FIG. 60 through FIG. 62, where FIG. 60 shows a schematic view of a configuration of a reflective element in the imaging optical lens system of the image capturing unit according to the 1st embodiment, FIG. 61 shows a perspective view of the reflective element from FIG. 60 before forming trimmed edges and a recess, and FIG. 62 shows a perspective view of the reflective element from FIG. 60 after forming trimmed edges and recess. As shown in FIG. 60 and FIG. 61, the reflective element E6 has optically non-effective areas NPR; that is, imaging light does not pass through the optically non-effective areas NPR in the reflective element E6. Therefore, in design, the parts of the reflective element E6 that correspond to the optically non-effective areas NPR as shown in FIG. 60 and FIG. 61 can be removed, and thus, the reflective element E6 can be formed with trimmed edges CP and a recess RP (as shown in FIG. 62).

The imaging optical lens system can be optionally provided with three or more reflective elements, and the present disclosure is not limited to the type, number and position of the reflective elements of the embodiments as disclosed in the aforementioned figures.

According to the present disclosure, the imaging optical lens system can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. Afront stop disposed between an imaged object and the first lens element can provide a longer distance between an exit pupil of the imaging optical lens system and the image surface to produce a telecentric effect, and thereby improves the image-sensing efficiency of an image sensor (for example, CCD or CMOS). A middle stop disposed between the first lens element and the image surface is favorable for enlarging the viewing angle of the imaging optical lens system and thereby provides a wider field of view for the same.

According to the present disclosure, the imaging optical lens system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the imaging optical lens system can include one or more optical elements for limiting the form of light passing through the imaging optical lens system. Each optical element can be, but not limited to, a filter, a polarizer, etc., and each optical element can be, but not limited to, a single-piece element, a composite component, a thin film, etc. The optical element can be located at the object side or the image side of the imaging optical lens system or between any two adjacent lens elements so as to allow light in a specific form to pass through, thereby meeting application requirements.

According to the present disclosure, the imaging optical lens system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and image side are defined in accordance with the direction of the optical axis, and the axial optical data are calculated along the optical axis. Furthermore, if the optical axis is deflected by a reflective element, the axial optical data are also calculated along the deflected optical axis.

According to the above description of the present disclosure, the following specific embodiments are provided for further explanation.

### 1st Embodiment

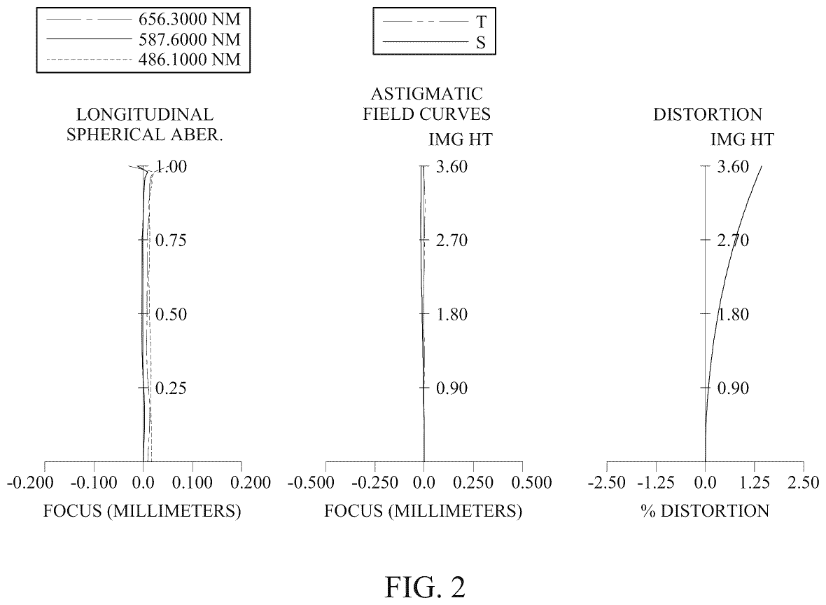

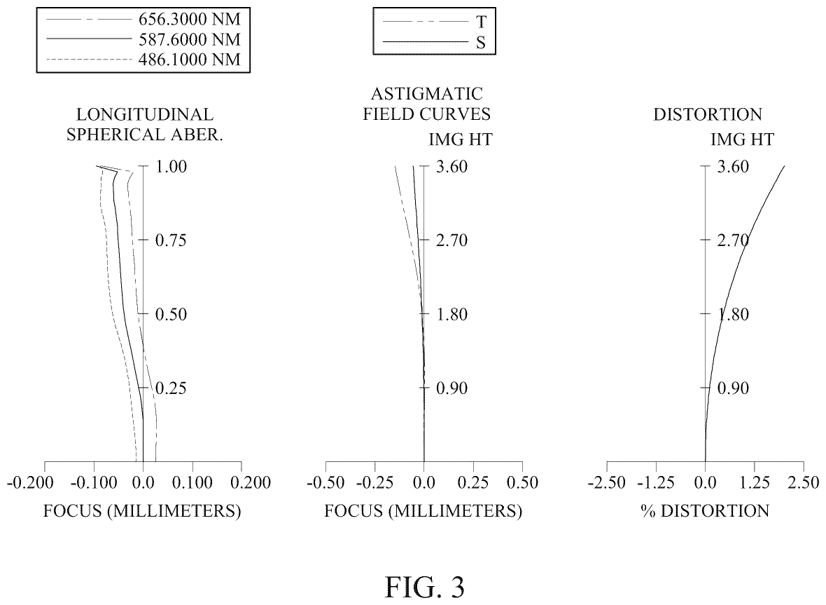

FIG. 1 shows schematic views of an image capturing unit respectively in a first state and a second state according to the 1st embodiment of the present disclosure. FIG. 2 shows, in order from left to right, spherical aberration curves, astigmatic field curves and a distortion curve of the image capturing unit in the first state according to the 1st embodiment. FIG. 3 shows, in order from left to right, spherical aberration curves, astigmatic field curves and a distortion curve of the image capturing unit in the second state according to the 1st embodiment. Moreover, the upper part of FIG. 1 shows the schematic view of the imaging optical lens system in the first state, and the lower part of FIG. 1 shows the schematic view of the imaging optical lens system in the second state. In FIG. 1, the image capturing unit 1 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along an optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 1. When an imaged object is located at a finite object distance, the imaging optical lens system is in the second state as shown in the lower part of FIG. 1. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 1, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has three inflection points. The image-side surface of the second lens element E2 has two inflection points. The object-side surface of the second lens element E2 has one critical point in an off-axis region thereof. The image-side surface of the second lens element E2 has one critical point in an off-axis region thereof.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has three inflection points. The image-side surface of the third lens element E3 has three inflection points. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has two critical points in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The image-side surface of the fifth lens element E5 has one critical point in an off-axis region thereof.

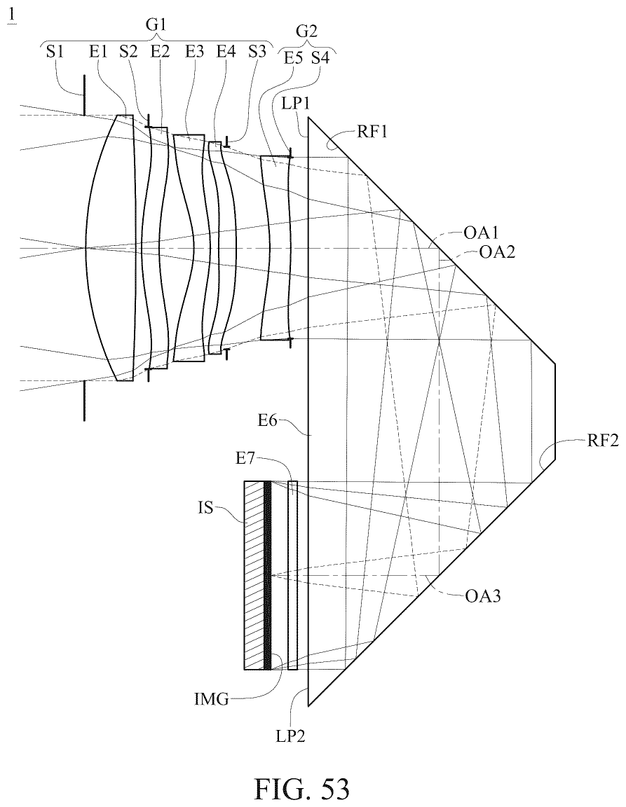

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 1 does not show the folding effect caused by the reflective element E6 on the optical path. However, the reflective element E6 can have various configurations depending on the actual design requirements, thereby creating different folding effects on the optical path. For example, please refer to FIG. 53 through FIG. 58, each of which shows a schematic view of a configuration of a reflective element and its associated light path deflection within the image capturing unit in the first state according to the 1st embodiment.

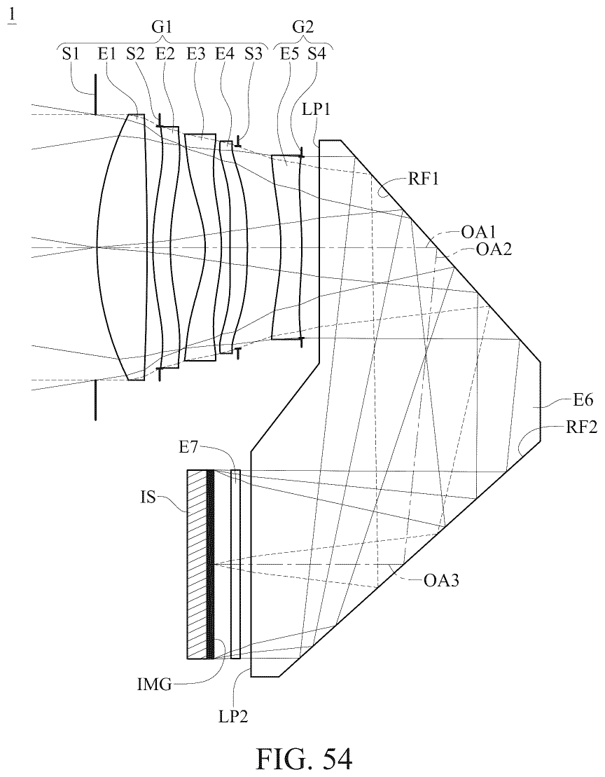

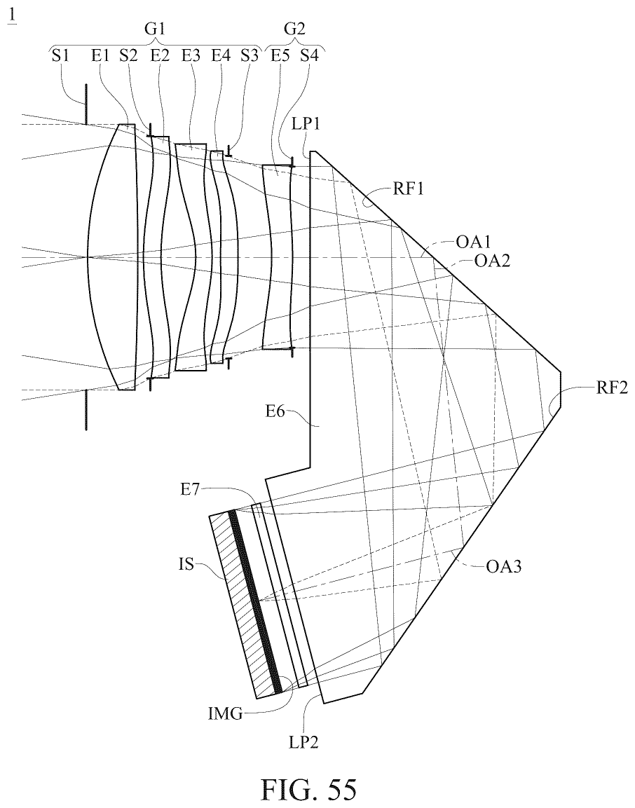

In FIG. 53 to FIG. 55, the reflective element E6 has, in sequence along the traveling direction of the optical path, a first light permeable surface LP1, a first reflective surface RF1, a second reflective surface RF2 and a second light permeable surface LP2. The first reflective surface RF1 deflects the optical path from a first optical axis OA1 to a second optical axis OA2, the second reflective surface RF2 deflects the optical path from the second optical axis OA2 to a third optical axis OA3, and then the optical path arrives at the image surface IMG along the third optical axis OA3. In FIG. 53 to FIG. 55, the reflective element E6 deflects the optical path two times. Moreover, FIG. 53 shows a configuration where the first light permeable surface LP1 and the second light permeable surface LP2 are coplanar, a normal direction of the first reflective surface RF1 can be at an angle of 45.0 degrees to both the first optical axis OA1 and the second optical axis OA2, and a normal direction of the second reflective surface RF2 can be at an angle of 45.0 degrees to both the second optical axis OA2 and the third optical axis OA3, such that an angle between a vector of the optical axis at the object side (e.g., the first optical axis OA1) and a vector of the optical axis at the image side (e.g., the third optical axis OA3) can be 180 degrees, and the vector of the optical axis at the object side and the vector of the optical axis at the image side can be in opposite directions. FIG. 54 shows a configuration where the first light permeable surface LP1 and the second light permeable surface LP2 are parallel to each other and non-coplanar, a normal direction of the first reflective surface RF1 can be at an angle of 42.0 degrees to both the first optical axis OA1 and the second optical axis OA2, and a normal direction of the second reflective surface RF2 can be at an angle of 48.0 degrees to both the second optical axis OA2 and the third optical axis OA3, such that an angle between a vector of the optical axis at the object side (e.g., the first optical axis OA1) and a vector of the optical axis at the image side (e.g., the third optical axis OA3) can be 180 degrees, and the vector of the optical axis at the object side and the vector of the optical axis at the image side can be in opposite directions. FIG. 55 shows a configuration where the first light permeable surface LP1 and the second light permeable surface LP2 are non-parallel to each other and non-coplanar, a normal direction of the first reflective surface RF1 can be at an angle of 47.0 degrees to both the first optical axis OA1 and the second optical axis OA2, and a normal direction of the second reflective surface RF2 can be at an angle of 55.6 degrees to both the second optical axis OA2 and the third optical axis OA3, such that an angle between a vector of the optical axis at the object side (e.g., the first optical axis OA1) and a vector of the optical axis at the image side (e.g., the third optical axis OA3) can be an obtuse angle.

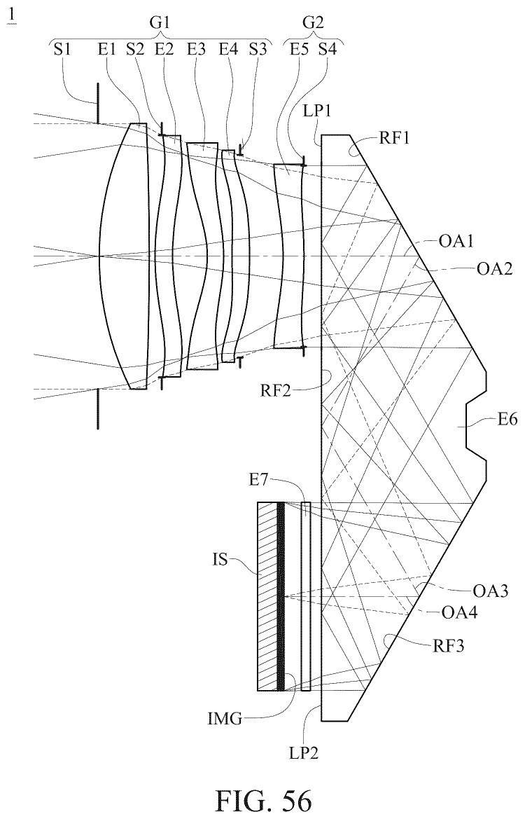

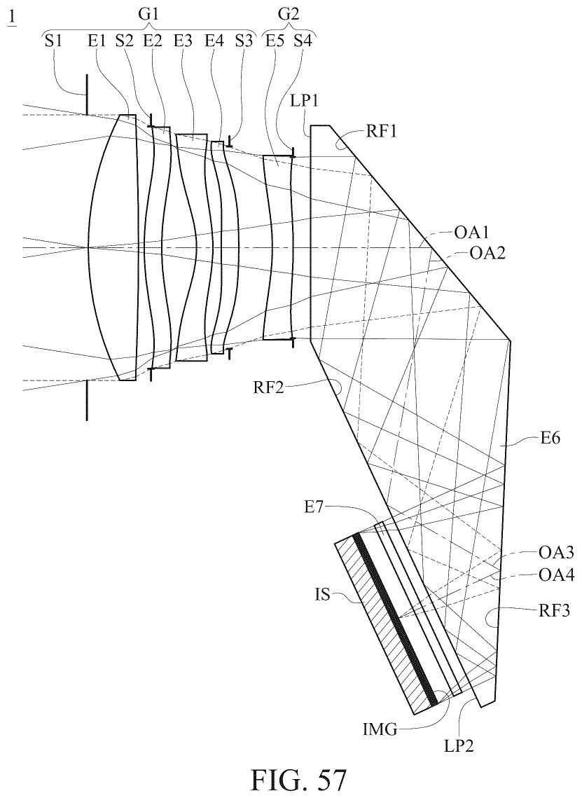

In FIG. 56 and FIG. 57, the reflective element E6 has, in sequence along the traveling direction of the optical path, a first light permeable surface LP1, a first reflective surface RF1, a second reflective surface RF2, a third reflective surface RF3 and a second light permeable surface LP2. The first reflective surface RF1 deflects the optical path from a first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, and then the optical path arrives at the image surface IMG along the fourth optical axis OA4. In FIG. 56 and FIG. 57, the reflective element E6 deflects the optical path three times. Moreover, FIG. 56 shows a configuration where the first light permeable surface LP1, the second reflective surface RF2 and the second light permeable surface LP2 are coplanar, a normal direction of the first reflective surface RF1 can be at an angle of 30.0 degrees to both the first optical axis OA1 and the second optical axis OA2, a normal direction of the second reflective surface RF2 can be at an angle of 60.0 degrees to both the second optical axis OA2 and the third optical axis OA3, and a normal direction of the third reflective surface RF3 can be at an angle of 30.0 degrees to both the third optical axis OA3 and the fourth optical axis OA4, such that an angle between a vector of the optical axis at the object side (e.g., the first optical axis OA1) and a vector of the optical axis at the image side (e.g., the fourth optical axis OA4) can be 180 degrees, and the vector of the optical axis at the object side and the vector of the optical axis at the image side can be in opposite directions. FIG. 57 shows a configuration where the first light permeable surface LP1 and the second reflective surface RF2 are non-parallel to each other and non-coplanar, a normal direction of the first reflective surface RF1 can be at an angle of 40.0 degrees to both the first optical axis OA1 and the second optical axis OA2, a normal direction of the second reflective surface RF2 can be at an angle of 55.0 degrees to both the second optical axis OA2 and the third optical axis OA3, and a normal direction of the third reflective surface RF3 can be at an angle of 27.5 degrees to both the third optical axis OA3 and the fourth optical axis OA4, such that an angle between a vector of the optical axis at the object side (e.g., the first optical axis OA1) and a vector of the optical axis at the image side (e.g., the fourth optical axis OA4) can be an obtuse angle.

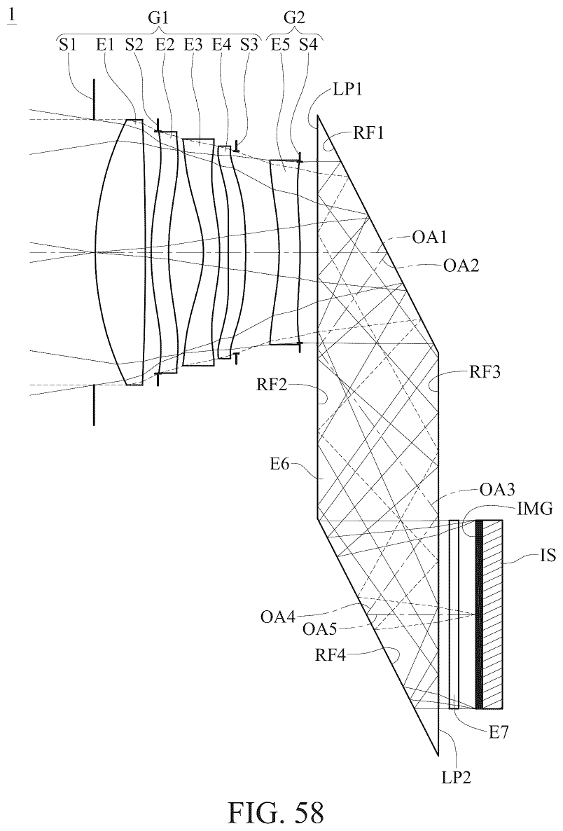

In FIG. 58, the reflective element E6 has, in sequence along the traveling direction of the optical path, a first light permeable surface LP1, a first reflective surface RF1, a second reflective surface RF2, a third reflective surface RF3, a fourth reflective surface RF4 and a second light permeable surface LP2. The first reflective surface RF1 deflects the optical path from a first optical axis OA1 to a second optical axis OA2, the second reflective surface RF2 deflects the optical path from the second optical axis OA2 to a third optical axis OA3, the third reflective surface RF3 deflects the optical path from the third optical axis OA3 to a fourth optical axis OA4, the fourth reflective surface RF4 deflects the optical path from the fourth optical axis OA4 to a fifth optical axis OA5, and the optical path arrives at the image surface IMG along the fifth optical axis OA5. In FIG. 58, the reflective element E6 deflects the optical path four times. A normal direction of the first reflective surface RF1 can be at an angle of 28.0 degrees to both the first optical axis OA1 and the second optical axis OA2, a normal direction of the second reflective surface RF2 can be at an angle of 56.0 degrees to both the second optical axis OA2 and the third optical axis OA3, a normal direction of the third reflective surface RF3 can be at an angle of 56.0 degrees to both the third optical axis OA3 and the fourth optical axis OA4, and a normal direction of the fourth reflective surface RF4 can be at an angle of 28.0 degrees to both the fourth optical axis OA4 and the fifth optical axis OA5, such that an angle between a vector of the optical axis at the object side (e.g., the first optical axis OA1) and a vector of the optical axis at the image side (e.g., the fifth optical axis OA5) can be 0 degree, and the vector of the optical axis at the object side and the vector of the optical axis at the image side can be in the same direction.

Furthermore, the reflective element E6 in the 1st embodiment can also have a configuration similar to that shown in FIG. 50, which deflects the optical path five times. Further details on this can be found in the descriptions corresponding to FIG. 50 and will not be repeated here.

The filter E7 is made of plastic material and located between the reflective element E6 and the image surface IMG, and will not affect the focal length of the imaging optical lens system. The image sensor IS is disposed on or near the image surface IMG of the imaging optical lens system.

The equation of the aspheric surface profiles of the aforementioned lens elements of the 1st embodiment is expressed as follows:

X(Y)=(Y²/R)/(1+sqrt(1−(1+k)×(Y/R)²))+Σ(Ai)×(Yⁱ),
where,
X is the displacement in parallel with the optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26, 28 and 30.

In the imaging optical lens system of the image capturing unit 1 according to the 1st embodiment, the first lens element E1 is referred to as one lens element closest to the object side within the imaging optical lens system, and the fifth lens element E5 is referred to as another lens element closest to the image side within the imaging optical lens system.

An axial distance between an imaged object and an object-side surface of the one lens element closest to the object side (i.e., the object-side surface of the first lens element E1) is referred to as an object distance. In this embodiment, the imaging optical lens system is transitioned to the second state to capture an imaged object at a finite object distance of 114.281 millimeters (mm) as an example, but the present disclosure is not limited to this distance.

When a focal length of the imaging optical lens system in the first state is fL, an f-number of the imaging optical lens system in the first state is FnoL, and half of a maximum field of view of the imaging optical lens system in the first state is HFOVL, these parameters have the following values: fL=13.72 mm, FnoL=2.26, and HFOVL=14.5 degrees (deg.).

When a focal length of the imaging optical lens system in the second state is fS, an f-number of the imaging optical lens system in the second state is FnoS, and half of a maximum field of view of the imaging optical lens system in the second state is HFOVS, these parameters have the following values: fS=12.91 mm, FnoS=2.51, and HFOVS=13.0 degrees.

An axial distance between an imaged object and the stop S1 is DO, and an axial distance between a surface closest to the image side within the movable lens group G1 and a surface closest to the object side within the last lens group G2 is D1. In this embodiment, D1 is referred to as an axial distance between the stop S3 and the object-side surface of the fifth lens element E5. Values of the object distance, D0 and D1 may be different when the imaging optical lens system is in the first state or the second state for focus adjustment. As the imaging optical lens system is in the first state, these parameters have the following values: object distance=∞(infinity); D0=∞(infinity); and D1=0.984 mm. As the imaging optical lens system is in the second state, these parameters have the following values: object distance=114.281 mm; 114.251 mm; and D1=1.733 mm.

When the maximum field of view of the imaging optical lens system in the first state is FOVL, the following condition is satisfied: FOVL=29.0 degrees.

When the maximum field of view of the imaging optical lens system in the second state is FOVS, the following condition is satisfied: FOVS=26.0 degrees.

When an axial distance between the object-side surface of the one lens element closest to the object side and the image surface IMG in the imaging optical lens system as the imaging optical lens system is in the second state is TLS, and an axial distance between the object-side surface of the one lens element closest to the object side and the image surface IMG in the imaging optical lens system as the imaging optical lens system is in the first state is TLL, the following condition is satisfied: TLS/TLL=1.039. In this embodiment, TLS is referred to as an axial distance between the object-side surface of the first lens element E1 and the image surface IMG as the imaging optical lens system is in the second state, and TLL is referred to as an axial distance between the object-side surface of the first lens element E1 and the image surface IMG as the imaging optical lens system is in the first state.

When the focal length of the imaging optical lens system in the first state is fL, and a focal length of the movable lens group G1 is fG1, the following condition is satisfied: fL/fG1=1.51.

When an axial distance between the object-side surface of the one lens element closest to the object side and an image-side surface of the another lens element closest to the image side in the imaging optical lens system as the imaging optical lens system is in the second state is TDS, and an axial distance between the object-side surface of the one lens element closest to the object side and the image-side surface of the another lens element closest to the image side in the imaging optical lens system as the imaging optical lens system is in the first state is TDL, the following condition is satisfied: |TDS−TDL|=0.75 mm. In this embodiment, TDS is referred to as an axial distance between the object-side surface of the first lens element E1 and the image-side surface of the fifth lens element E5 as the imaging optical lens system is in the second state, and TDL is referred to as an axial distance between the object-side surface of the first lens element E1 and the image-side surface of the fifth lens element E5 as the imaging optical lens system is in the first state.

When the axial distance between the object-side surface of the one lens element closest to the object side and the image-side surface of the another lens element closest to the image side in the imaging optical lens system as the imaging optical lens system is in the second state is TDS, and the axial distance between the object-side surface of the one lens element closest to the object side and the image-side surface of the another lens element closest to the image side in the imaging optical lens system as the imaging optical lens system is in the first state is TDL, the following condition is satisfied: 10×|TDS−TDL|/TDL=1.60.

When an axial distance between an object-side surface of one lens element closest to the object side and an image-side surface of another lens element closest to the image side in the movable lens group G1 is DG1, and an axial distance between an object-side surface of one lens element closest to the object side and an image-side surface of another lens element closest to the image side in the last lens group G2 is DG2, the following condition is satisfied: DG2/DG1=0.14. In this embodiment, DG1 is referred to as an axial distance between the object-side surface of the first lens element E1 and the image-side surface of the fourth lens element E4, and DG2 is referred to as an axial distance between the object-side surface of the fifth lens element E5 and the image-side surface of the fifth lens element E5.

When the axial distance between the object-side surface of the one lens element closest to the object side and the image surface IMG in the imaging optical lens system as the imaging optical lens system is in the first state is TLL, and the focal length of the imaging optical lens system in the first state is fL, the following condition is satisfied: TLL/fL=1.42.

When an axial distance between the image-side surface of the another lens element closest to the image side and the image surface IMG in the imaging optical lens system as the imaging optical lens system is in the first state is BLL, and the axial distance between the object-side surface of the one lens element closest to the object side and the image-side surface of the another lens element closest to the image side in the imaging optical lens system as the imaging optical lens system is in the first state is TDL, the following condition is satisfied: BLL/TDL=3.14. In this embodiment, BLL is referred to as an axial distance between the image-side surface of the fifth lens element E5 and the image surface IMG as the imaging optical lens system is in the first state.

When an axial distance between an aperture stop and the image-side surface of the another lens element closest to the image side in the imaging optical lens system as the imaging optical lens system is in the first state is SDL, and the axial distance between the object-side surface of the one lens element closest to the object side and the image-side surface of the another lens element closest to the image side in the imaging optical lens system as the imaging optical lens system is in the first state is TDL, the following condition is satisfied: SDL/TDL=1.01. In this embodiment, SDL is referred to as an axial distance between the aperture stop and the image-side surface of the fifth lens element E5 as the imaging optical lens system is in the first state.

When the focal length of the imaging optical lens system in the first state is fL, and a focal length of the third lens element E3 is f3, the following condition is satisfied: fL/f3=−1.48.

When an axial distance between the third lens element E3 and the fourth lens element E4 as the imaging optical lens system is in the first state is T34L, and a central thickness of the second lens element E2 is CT2, the following condition is satisfied: T34L/CT2=0.48. In this embodiment, an axial distance between two adjacent lens elements is a distance in a paraxial region between two adjacent lens surfaces of the two adjacent lens elements.

When the focal length of the imaging optical lens system in the first state is fL, and a curvature radius of the object-side surface of the third lens element E3 is R5, the following condition is satisfied: fL/R5=−5.94.

When a focal length of the second lens element E2 is f2, and the focal length of the third lens element E3 is f3, the following condition is satisfied: |f3/f2|=0.06.

When a curvature radius of the object-side surface of the second lens element E2 is R3, a curvature radius of the image-side surface of the second lens element E2 is R4, and the focal length of the imaging optical lens system in the first state is fL, the following condition is satisfied: |R3/fL|+|R4/fL|=0.85.

When a curvature radius of the object-side surface of the first lens element E1 is R1, and the curvature radius of the image-side surface of the second lens element E2 is R4, the following condition is satisfied: (R1−R4)/(R1+R4)=0.10.

When the curvature radius of the object-side surface of the first lens element E1 is R1, and the curvature radius of the object-side surface of the third lens element E3 is R5, the following condition is satisfied: (R1−R5)/(R1+R5)=2.04.

When a central thickness of the first lens element E1 is CT1, and the central thickness of the second lens element E2 is CT2, the following condition is satisfied: CT1/CT2=2.87.

When the central thickness of the first lens element E1 is CT1, and an axial distance between the object-side surface of the second lens element E2 and the image-side surface of the fourth lens element E4 as the imaging optical lens system is in the first state is Dr3r8L, the following condition is satisfied: CT1/Dr3r8L=0.53.

When an axial distance between the second lens element E2 and the third lens element E3 as the imaging optical lens system is in the first state is T23L, and a central thickness of the fourth lens element E4 is CT4, the following condition is satisfied: T23L/CT4=1.99.

When an axial distance between the fourth lens element E4 and the fifth lens element E5 as the imaging optical lens system is in the first state is T45L, and the focal length of the imaging optical lens system in the first state is fL, the following condition is satisfied: 10×T45L/fL=0.56.

When a central thickness of the fifth lens element E5 is CT5, and the axial distance between the fourth lens element E4 and the fifth lens element E5 as the imaging optical lens system is in the first state is T45L, the following condition is satisfied: CT5/T45L=0.62.

When a refractive index of the first lens element E1 is N1, the following condition is satisfied: N1=1.883.

When an Abbe number of the fifth lens element E5 is V5, the following condition is satisfied: V5=19.5.

When the Abbe number of the fifth lens element E5 is V5, and a refractive index of the fifth lens element E5 is N5, the following condition is satisfied: V5/N5=11.68.

When a distance in parallel with the optical axis between a maximum effective radius position of the image-side surface of the first lens element E1 and a maximum effective radius position of the object-side surface of the second lens element E2 as the imaging optical lens system is in the first state is ET12L, and the central thickness of the second lens element E2 is CT2, the following condition is satisfied: ET12L/CT2=0.93.

When a displacement in parallel with the optical axis from an axial vertex of the object-side surface of the second lens element E2 to the maximum effective radius position of the object-side surface of the second lens element E2 as the imaging optical lens system is in the first state is Sag2R1L, and the central thickness of the second lens element E2 is CT2, the following condition is satisfied: Sag2R1L/CT2=0.44. In this embodiment, the direction of Sag2R1L points toward the image side of the imaging optical lens system, and the value of Sag2R1L is positive.

When a maximum effective radius of the object-side surface of the first lens element E1 as the imaging optical lens system is in the first state is Y1 R1 L, and a maximum effective radius of the image-side surface of the fifth lens element E5 as the imaging optical lens system is in the first state is Y5R2L, the following condition is satisfied: Y1 R1 L/Y5R2L=1.47.

When the maximum effective radius of the object-side surface of the first lens element E1 as the imaging optical lens system is in the first state is Y1 R1 L, and a maximum image height of the imaging optical lens system is ImgH, the following condition is satisfied: Y1 R1 L/ImgH=0.84.

The detailed optical data of the 1st embodiment are shown in Table 1A and Table 1B, and the aspheric surface data are shown in Table 1C below.

TABLE 1A
1st Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | 0.030 | | | | |
| 2 | Lens 1 | 6.7545 | (SPH) | 1.150 | Glass | 1.883 | 37.2 | 7.00 |
| 3 | | −66.6125 | (SPH) | 0.287 | | | | |
| 4 | Stop | Plano | | −0.156 | | | | |
| 5 | Lens 2 | 6.0728 | (ASP) | 0.401 | Plastic | 1.545 | 56.1 | −160.56 |
| 6 | | 5.5464 | (ASP) | 0.797 | | | | |
| 7 | Lens 3 | −2.3098 | (ASP) | 0.374 | Plastic | 1.669 | 19.5 | −9.28 |
| 8 | | −3.9179 | (ASP) | 0.194 | | | | |
| 9 | Lens 4 | 16.4261 | (ASP) | 0.400 | Plastic | 1.567 | 37.4 | 13.62 |
| 10 | | −14.4246 | (ASP) | −0.215 | | | | |
| 11 | Stop | Plano | | D1 | | | | |
| 12 | Lens 5 | −5.1113 | (ASP) | 0.479 | Plastic | 1.669 | 19.5 | −18.02 |
| 13 | | −9.2069 | (ASP) | −0.006 | | | | |

| | | | | | | | |
|---|---|---|---|---|---|---|---|
| 14 | Stop | Plano | 0.406 | | | | |
| 15 | Prism | Plano | 13.500 | Glass | 1.835 | 42.7 | — |
| 16 | | Plano | 0.250 | | | | |
| 17 | Filter | Plano | 0.210 | Plastic | 1.517 | 64.2 | — |
| 18 | | Plano | 0.398 | | | | |
| 19 | Image | Plano | — | | | | |

Note:
Reference wavelength is 587.6 nm (d-line).
An effective radius of the stop S1 (Surface 1) is 3.040 mm.
An effective radius of the stop S2 (Surface 4) is 2.773 mm.
An effective radius of the stop S3 (Surface 11) is 2.320 mm.
An effective radius of the stop S4 (Surface 14) is 2.074 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 11 as the imaging optical lens system is in the second state (corresponding to finite object distance).

In Table 1A, the curvature radius, the thickness and the focal length are shown in millimeters (mm). Surface numbers 0-19 represent the surfaces sequentially arranged from the object side to the image side along the traveling direction of the optical path.

TABLE 1B
Values of Optical And Physical Parameters/Definitions

| First State (Infinite | | Second State (Finite | |
|---|---|---|---|
| Object Distance) | | Object Distance) | |
| fL [mm] | 13.72 | fS [mm] | 12.91 |
| FnoL | 2.26 | FnoS | 2.51 |
| HFOVL [deg.] | 14.5 | HFOVS [deg.] | 13.0 |
| Object Distance [mm] | ∞ | Object Distance [mm] | 114.281 |
| D0 [mm] | ∞ | D0 [mm] | 114.251 |
| D1 [mm] | 0.984 | D1 [mm] | 1.733 |

Table 1B shows optical and physical parameters/definitions of the imaging optical lens system for the first state and the second state under different focusing conditions. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 1B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 114.281 mm, the imaging optical lens system is transitioned from the first state to the second state, the axial distance D1 between the movable lens group G1 and the last lens group G2 increases from 0.984 mm in the first state to 1.733 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 1C
Aspheric Coefficients

| Surface # | 5 | 6 | 7 | 8 |
|---|---|---|---|---|
| k= | −8.878520000E−02 | 1.928610000E−01 | −6.347110000E−01 | −8.237730000E−02 |
| A4= | −1.031175878E−02 | −1.720608270E−02 | 4.145102059E−02 | 7.162815996E−03 |
| A6= | 8.724675928E−03 | 1.636254330E−02 | 3.734201412E−02 | 6.872351074E−02 |
| A8= | −1.059391330E−02 | −1.931775484E−02 | −6.707142718E−02 | −9.347204645E−02 |
| A10= | 8.733407892E−03 | 1.629157359E−02 | 5.829486861E−02 | 6.792082009E−02 |
| A12= | −5.241039171E−03 | −1.053128660E−02 | −3.254042298E−02 | −2.770479681E−02 |
| A14= | 2.276332110E−03 | 5.173139571E−03 | 1.243480219E−02 | 4.296962473E−03 |
| A16= | −7.105315760E−04 | −1.889674012E−03 | −3.299516228E−03 | 1.748158927E−03 |
| A18= | 1.574902247E−04 | 5.034385227E−04 | 5.943005809E−04 | −1.326018629E−03 |
| A20= | −2.423938592E−05 | −9.616886167E−05 | −6.619390816E−05 | 4.288525593E−04 |
| A22= | 2.478159001E−06 | 1.290450968E−05 | 2.875625629E−06 | −8.601277490E−05 |
| A24= | −1.521818670E−07 | −1.177330832E−06 | 3.219494505E−07 | 1.135733954E−05 |
| A26= | 4.001773605E−09 | 6.888717210E−08 | −6.024392560E−08 | −9.686016169E−07 |
| A28= | 7.150044639E−11 | −2.301945595E−09 | 3.903560954E−09 | 4.867492768E−08 |
| A30= | −5.151389748E−12 | 3.275738998E−11 | −9.694598095E−11 | −1.099164464E−09 |
| Surface # | 9 | 10 | 12 | 13 |
| k= | 9.934530000E−01 | −4.970450000E+00 | −9.618260000E+00 | −2.434800000E+01 |
| A4= | −5.245438159E−02 | −1.579366939E−02 | 7.091546058E−03 | 1.056733510E−02 |
| A6= | 4.885106137E−02 | −1.869668843E−03 | 9.408068953E−04 | 7.422437772E−04 |
| A8= | −4.497410923E−02 | 1.547100820E−02 | −9.676571623E−04 | −1.858986663E−03 |
| A10= | 7.799875686E−03 | −3.471106238E−02 | −2.889297561E−04 | 2.294773370E−03 |
| A12= | 2.561279434E−02 | 4.145825513E−02 | 1.787409000E−03 | −1.842406627E−03 |
| A14= | −2.996844635E−02 | −3.086480623E−02 | −2.195640252E−03 | 9.328632664E−04 |
| A16= | 1.775062871E−02 | 1.554988762E−02 | 1.494333561E−03 | −2.982583936E−04 |
| A18= | −6.761369099E−03 | −5.516246679E−03 | −6.479566265E−04 | 5.805031718E−05 |
| A20= | 1.766478022E−03 | 1.399939413E−03 | 1.865463674E−04 | −5.852301659E−06 |
| A22= | −3.216387120E−04 | −2.536970661E−04 | −3.564346171E−05 | 5.460160696E−08 |
| A24= | 4.030004602E−05 | 3.215729283E−05 | 4.353352684E−06 | 4.575162142E−08 |
| A26= | −3.323516515E−06 | −2.715785750E−06 | −3.080936816E−07 | −3.104713544E−09 |
| A28= | 1.628158470E−07 | 1.375852904E−07 | 9.619559604E−09 | — |
| A30= | −3.596251989E−09 | −3.168430536E−09 | — | — |

In Table 10C, k represents the conic coefficient of the equation of the aspheric surface profiles. A4-A30 represent the aspheric coefficients ranging from the 4th order to the 30th order. The tables presented below for each embodiment are the corresponding schematic parameter and aberration curves, and the definitions of the tables are the same as Table 1A to Table 1C of the 1st embodiment. Therefore, an explanation in this regard will not be provided again.

### 2nd Embodiment

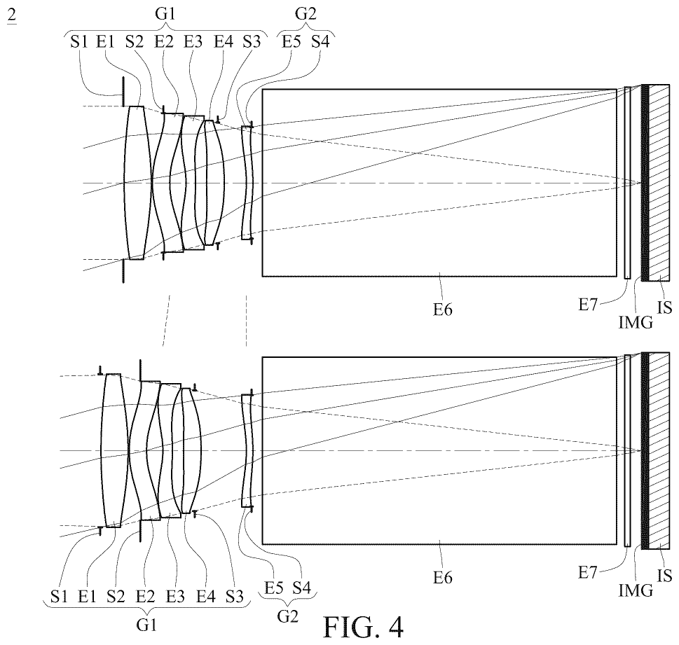

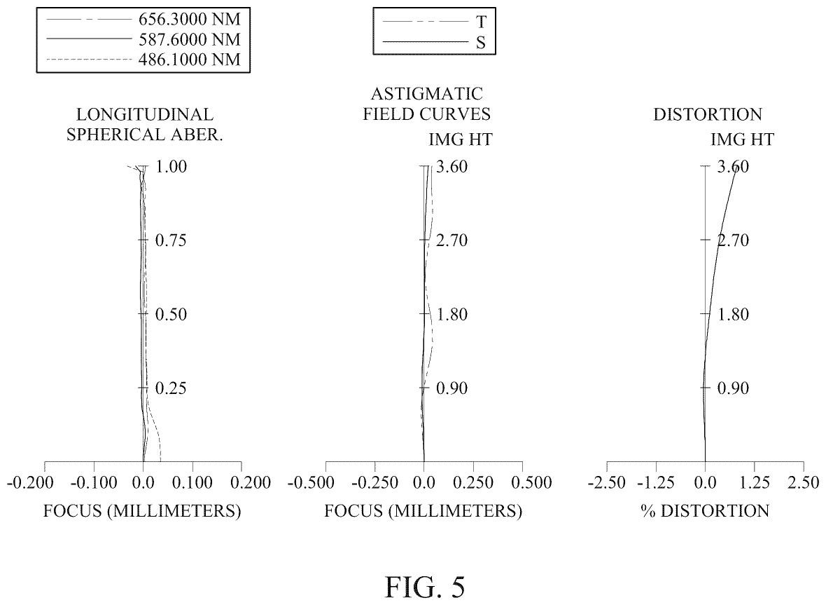

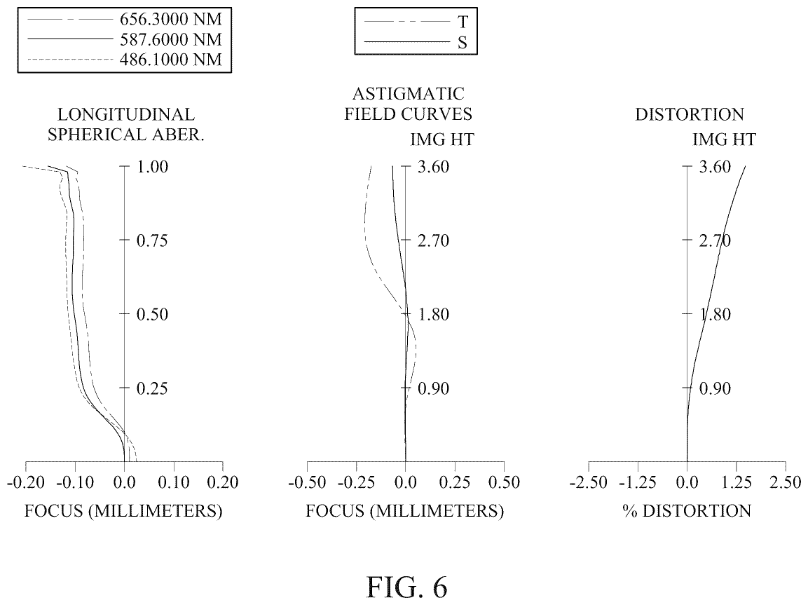

FIG. 4 shows schematic views of an image capturing unit respectively in a first state and a second state according to the 2nd embodiment of the present disclosure. FIG. 5 shows, in order from left to right, spherical aberration curves, astigmatic field curves and a distortion curve of the image capturing unit in the first state according to the 2nd embodiment. FIG. 6 shows, in order from left to right, spherical aberration curves, astigmatic field curves and a distortion curve of the image capturing unit in the second state according to the 2nd embodiment. Moreover, the upper part of FIG. 4 shows the schematic view of the imaging optical lens system in the first state, and the lower part of FIG. 4 shows the schematic view of the imaging optical lens system in the second state. In FIG. 4, the image capturing unit 2 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 4. When an imaged object is located at a finite object distance, the imaging optical lens system is in the second state as shown in the lower part of FIG. 4. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 4, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The image-side surface of the first lens element E1 has one inflection point.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has two critical points in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 4 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface IMG of the imaging optical lens system.

The detailed optical data of the 2nd embodiment are shown in Table 2A and Table 2B, and the aspheric surface data are shown in Table 20 below.

TABLE 2A
2nd Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | 0.030 | | | | |
| 2 | Lens 1 | 19.2224 | (ASP) | 0.997 | Glass | 1.954 | 32.3 | 6.42 |
| 3 | | −8.7505 | (ASP) | 0.444 | | | | |
| 4 | Stop | Plano | | −0.404 | | | | |
| 5 | Lens 2 | 3.9614 | (ASP) | 0.636 | Plastic | 1.544 | 56.0 | −41.22 |
| 6 | | 3.1762 | (ASP) | 0.598 | | | | |
| 7 | Lens 3 | −2.9536 | (ASP) | 0.349 | Plastic | 1.660 | 20.4 | −6.18 |
| 8 | | −11.1929 | (ASP) | 0.407 | | | | |
| 9 | Lens 4 | 9.2997 | (ASP) | 0.647 | Plastic | 1.544 | 56.0 | 9.32 |
| 10 | | −10.8835 | (ASP) | −0.237 | | | | |
| 11 | Stop | Plano | | D1 | | | | |
| 12 | Lens 5 | −5.2488 | (ASP) | 0.240 | Plastic | 1.686 | 18.4 | −34.02 |
| 13 | | −6.8976 | (ASP) | −0.051 | | | | |

| | | | | | | | |
|---|---|---|---|---|---|---|---|
| 14 | Stop | Plano | 0.401 | | | | |
| 15 | Prism | Plano | 13.000 | Glass | 1.835 | 42.7 | — |
| 16 | | Plano | 0.300 | | | | |
| 17 | Filter | Plano | 0.210 | Plastic | 1.517 | 64.2 | — |
| 18 | | Plano | 0.414 | | | | |
| 19 | Image | Plano | — | | | | |

Note:
Reference wavelength is 587.6 nm (d-line).
An effective radius of the stop S1 (Surface 1) is 2.815 mm.
An effective radius of the stop S2 (Surface 4) is 2.560 mm.
An effective radius of the stop S3 (Surface 11) is 2.220 mm.
An effective radius of the stop S4 (Surface 14) is 2.046 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 4 as the imaging optical lens system is in the second state (corresponding to finite object distance).

In this embodiment, the imaging optical lens system is transitioned to the second state to capture an imaged object at a finite object distance of 119.180 mm as an example, but the present disclosure is not limited to this distance.

TABLE 2B
Values of Optical And Physical Parameters/Definitions

| First State (Infinite | | Second State (Finite | |
|---|---|---|---|
| Object Distance) | | Object Distance) | |
| fL [mm] | 12.70 | fS [mm] | 12.31 |
| FnoL | 2.26 | FnoS | 2.50 |
| HFOVL [deg.] | 15.7 | HFOVS [deg.] | 14.4 |
| Object Distance [mm] | ∞ | Object Distance [mm] | 119.180 |
| D0 [mm] | ∞ | D0 [mm] | 119.150 |
| D1 [mm] | 1.048 | D1 [mm] | 1.898 |

The definitions of the parameters shown in Table 2B are the same as those stated in the 1st embodiment, with corresponding values for the 2nd embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 2B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 119.180 mm, the imaging optical lens system is transitioned from the first state to the second state, the axial distance D1 between the movable lens group G1 and the last lens group G2 increases from 1.048 mm in the first state to 1.898 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 2C
Aspheric Coefficients

| Surface # | 2 | 3 | 5 | 6 |
|---|---|---|---|---|
| k= | 8.605470000E−01 | −3.457300000E+01 | −7.438190000E−01 | −9.666710000E−01 |
| A4= | −7.248834493E−04 | 7.199996202E−05 | 3.399690516E−03 | −8.889860585E−03 |
| A6= | 7.731312862E−04 | −1.209027285E−04 | −1.045713334E−02 | −2.322938938E−03 |
| A8= | −3.182500881E−04 | −4.131654970E−05 | 1.715476287E−02 | 3.424229163E−02 |
| A10= | 5.530850417E−05 | 9.470980602E−06 | −2.291717523E−02 | −7.288778152E−02 |
| A12= | −4.294125735E−06 | 1.035052321E−06 | 1.851980798E−02 | 7.297246931E−02 |
| A14= | 1.237530185E−07 | −2.839934758E−07 | −9.716454717E−03 | −4.444309907E−02 |
| A16= | 3.110308404E−10 | 1.431960412E−08 | 3.497411516E−03 | 1.818881924E−02 |
| A18= | — | — | −8.874081279E−04 | −5.243008127E−03 |
| A20= | — | — | 1.597058744E−04 | 1.087805919E−03 |
| A22= | — | — | −2.012706034E−05 | −1.630901291E−04 |
| A24= | — | — | 1.713628781E−06 | 1.740663367E−05 |
| A26= | — | — | −9.159606605E−08 | −1.265844490E−06 |
| A28= | — | — | 2.632933670E−09 | 5.661383967E−08 |
| A30= | — | — | −2.671690136E−11 | −1.179099065E−09 |
| Surface # | 7 | 8 | 9 | 10 |
| k= | −6.701910000E−01 | 1.681580000E+00 | 6.646010000E+00 | 3.282770000E−02 |
| A4= | 1.496818664E−02 | −5.756310242E−02 | −1.268118360E−01 | −5.626352125E−02 |
| A6= | 1.725294542E−01 | 2.582160319E−01 | 1.988857039E−01 | 7.083057608E−02 |
| A8= | −2.820029566E−01 | −3.504270439E−01 | −2.192991442E−01 | −5.482230990E−02 |
| A10= | 2.504008863E−01 | 2.636187969E−01 | 1.488887339E−01 | 5.626209262E−03 |
| A12= | −1.445822082E−01 | −1.056262800E−01 | −5.233727883E−02 | 3.575077282E−02 |
| A14= | 5.742190931E−02 | 5.078505601E−03 | −3.889803962E−03 | −4.313653958E−02 |
| A16= | −1.585748667E−02 | 1.992038332E−02 | 1.531432748E−02 | 2.810127977E−02 |
| A18= | 2.944981433E−03 | −1.291465480E−02 | −9.103620787E−03 | −1.211369399E−02 |
| A20= | −3.186648544E−04 | 4.536008703E−03 | 3.159510198E−03 | 3.647023084E−03 |
| A22= | 5.003959367E−06 | −1.035648055E−03 | −7.275134379E−04 | −7.745152896E−04 |
| A24= | 4.201643435E−06 | 1.580842014E−04 | 1.129248801E−04 | 1.140236212E−04 |
| A26= | −6.644420117E−07 | −1.563768870E−05 | −1.139707568E−05 | −1.108513830E−05 |
| A28= | 4.583429986E−08 | 9.087281664E−07 | 6.762147446E−07 | 6.400301299E−07 |
| A30= | −1.272090185E−09 | −2.357262944E−08 | −1.789528936E−08 | −1.661043702E−08 |

| Surface # | 12 | 13 |
|---|---|---|
| k= | −1.510090000E+01 | −4.849910000E+01 |
| A4= | −2.498168645E−02 | −2.545188692E−02 |
| A6= | 9.698874550E−02 | 9.762334286E−02 |
| A8= | −1.861534170E−01 | −1.997230568E−01 |
| A10= | 2.610163255E−01 | 3.011606929E−01 |
| A12= | −2.715886676E−01 | −3.324958207E−01 |
| A14= | 2.100733662E−01 | 2.690238006E−01 |
| A16= | −1.206925538E−01 | −1.599776808E−01 |
| A18= | 5.132774092E−02 | 6.993426820E−02 |
| A20= | −1.602819125E−02 | −2.235274397E−02 |
| A22= | 3.616651104E−03 | 5.149467337E−03 |
| A24= | −5.725041614E−04 | −8.310272018E−04 |
| A26= | 6.021583929E−05 | 8.904083255E−05 |
| A28= | −3.775134830E−06 | −5.684474982E−06 |
| A30= | 1.066739939E−07 | 1.635462326E−07 |

In the 2nd embodiment, the equation of the aspheric surface profiles of the aforementioned lens elements is the same as the equation of the 1st embodiment. Also, the definitions of these parameters shown in Table 2D below are the same as those stated in the 1st embodiment, with corresponding values for the 2nd embodiment; therefore, an explanation in this regard will not be provided again.

Moreover, these parameters can be calculated from Table 2A to Table 20 as the following values and satisfy the following conditions:

TABLE 2D
Values of Optical and Physical Parameters/Definitions

| | | | |
|---|---|---|---|
| fL [mm] | 12.70 | fL/R5 | −4.30 |
| FnoL | 2.26 | \|f3/f2\| | 0.15 |
| HFOVL [deg.] | 15.7 | \|R3/fL\| + \|R4/fL\| | 0.56 |
| FOVL [deg.] | 31.4 | (R1 − R4)/(R1 + R4) | 0.72 |
| fS [mm] | 12.31 | (R1 − R5)/(R1 + R5) | 1.36 |
| FnoS | 2.50 | CT1/CT2 | 1.57 |
| HFOVS [deg.] | 14.4 | CT1/Dr3r8L | 0.38 |
| FOVS [deg.] | 28.8 | T23L/CT4 | 0.92 |
| TLS/TLL | 1.045 | 10 × T45L/fL | 0.64 |
| fL/fG1 | 1.26 | CT5/T45L | 0.30 |
| \|TDS − TDL\| [mm] | 0.85 | N1 | 1.954 |
| 10 × \|TDS − TDL\|/TDL | 1.80 | V5 | 18.4 |
| DG2/DG1 | 0.07 | V5/N5 | 10.91 |
| TLL/fL | 1.50 | ET12L/CT2 | 1.20 |
| BLL/TDL | 3.02 | Sag2R1L/CT2 | 0.68 |
| SDL/TDL | 1.01 | Y1R1L/Y5R2L | 1.37 |
| fL/f3 | −2.06 | Y1R1L/ImgH | 0.78 |
| T34L/CT2 | 0.64 | — | — |

### 3rd Embodiment

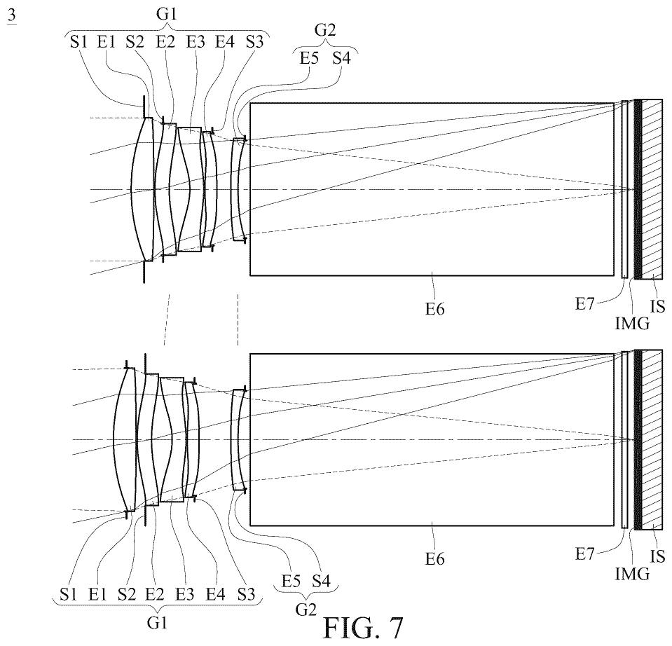

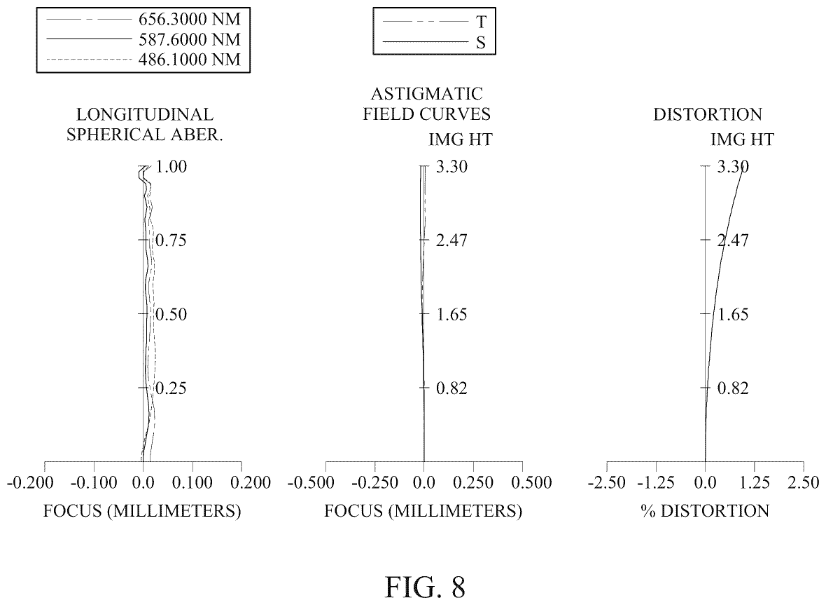

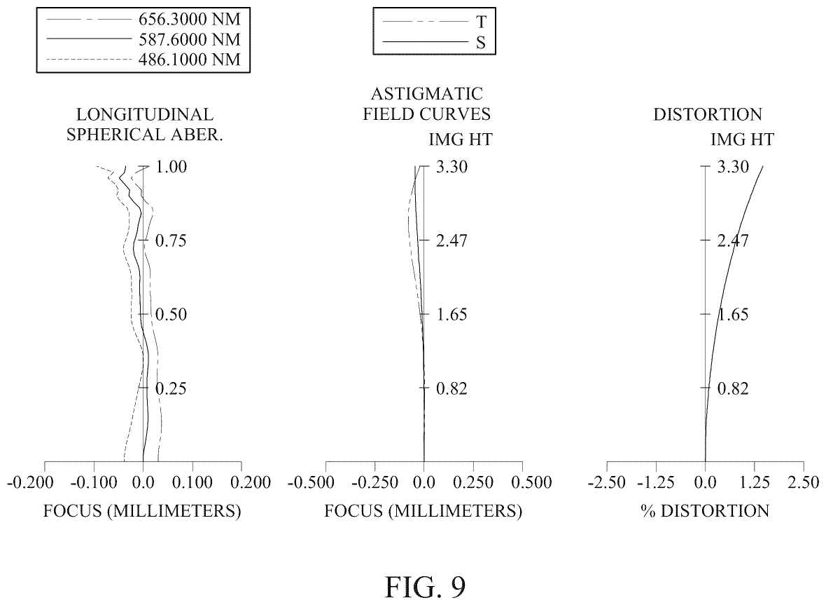

FIG. 7 shows schematic views of an image capturing unit respectively in a first state and a second state according to the 3rd embodiment of the present disclosure. FIG. 8 shows, in order from left to right, spherical aberration curves, astigmatic field curves and a distortion curve of the image capturing unit in the first state according to the 3rd embodiment. FIG. 9 shows, in order from left to right, spherical aberration curves, astigmatic field curves and a distortion curve of the image capturing unit in the second state according to the 3rd embodiment. Moreover, the upper part of FIG. 7 shows the schematic view of the imaging optical lens system in the first state, and the lower part of FIG. 7 shows the schematic view of the imaging optical lens system in the second state. In FIG. 7, the image capturing unit 3 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 7. When an imaged object is located at a finite object distance, the imaging optical lens system is in the second state as shown in the lower part of FIG. 7. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 7, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The image-side surface of the first lens element E1 has one inflection point.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has three inflection points. The image-side surface of the third lens element E3 has two inflection points. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has five inflection points. The image-side surface of the fourth lens element E4 has one inflection point. The object-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 7 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface IMG of the imaging optical lens system.

The detailed optical data of the 3rd embodiment are shown in Table 3A and

TABLE 3A
3rd Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.478 | | | | |
| 2 | Lens 1 | 6.8046 | (ASP) | 0.830 | Glass | 1.883 | 39.2 | 7.11 |
| 3 | | −76.2079 | (ASP) | 0.340 | | | | |
| 4 | Stop | Plano | | −0.300 | | | | |
| 5 | Lens 2 | 5.2348 | (ASP) | 0.529 | Plastic | 1.544 | 56.0 | 498.35 |
| 6 | | 5.1478 | (ASP) | 0.756 | | | | |
| 7 | Lens 3 | −2.3016 | (ASP) | 0.510 | Plastic | 1.639 | 23.5 | −8.35 |
| 8 | | −4.3997 | (ASP) | 0.044 | | | | |
| 9 | Lens 4 | 8.0068 | (ASP) | 0.433 | Plastic | 1.566 | 37.4 | 11.70 |
| 10 | | −37.5334 | (ASP) | −0.163 | | | | |
| 11 | Stop | Plano | | D1 | | | | |
| 12 | Lens 5 | 78.3923 | (ASP) | 0.260 | Plastic | 1.669 | 19.5 | −16.56 |
| 13 | | 9.6965 | (ASP) | 0.255 | | | | |

| | | | | | | | |
|---|---|---|---|---|---|---|---|
| 14 | Stop | Plano | 0.185 | | | | |
| 15 | Prism | Plano | 13.350 | Glass | 1.835 | 42.7 | — |
| 16 | | Plano | 0.300 | | | | |
| 17 | Filter | Plano | 0.210 | Plastic | 1.517 | 64.2 | — |
| 18 | | Plano | 0.260 | | | | |
| 19 | Image | Plano | — | | | | |

Note:
Reference wavelength is 587.6 nm (d-line).
An effective radius of the stop S1 (Surface 1) is 2.632 mm.
An effective radius of the stop S2 (Surface 4) is 2.419 mm.
An effective radius of the stop S3 (Surface 11) is 2.063 mm.
An effective radius of the stop S4 (Surface 14) is 1.793 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 4 as the imaging optical lens system is in the second state (corresponding to finite object distance).

In this embodiment, the imaging optical lens system is transitioned to the second state to capture an imaged object at a finite object distance of 118.872 mm as an example, but the present disclosure is not limited to this distance.

TABLE 3B
Values of Optical And Physical Parameters/Definitions

| First State (Infinite | | Second State (Finite | |
|---|---|---|---|
| Object Distance) | | Object Distance) | |
| fL [mm] | 12.91 | fS [mm] | 12.19 |
| FnoL | 2.45 | FnoS | 2.67 |
| HFOVL [deg.] | 14.2 | HFOVS [deg.] | 13.1 |
| Object Distance [mm] | ∞ | Object Distance [mm] | 118.872 |
| D0 [mm] | ∞ | D0 [mm] | 119.350 |
| D1 [mm] | 0.685 | D1 [mm] | 1.335 |

The definitions of the parameters shown in Table 3B are the same as those stated in the 1st embodiment, with corresponding values for the 3rd embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 3B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 118.872 mm, the imaging optical lens system is transitioned from the first state to the second state, the axial distance D1 between the movable lens group G1 and the last lens group G2 increases from 0.685 mm in the first state to 1.335 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 3C
Aspheric Coefficients

| Surface # | 2 | 3 | 5 | 6 |
|---|---|---|---|---|
| k= | −5.317060000E−02 | −9.942030000E+00 | 2.635000000E−03 | 5.454210000E−02 |
| A4= | 5.917426869E−04 | 5.953631148E−03 | 2.883945559E−04 | −1.460876233E−02 |
| A6= | 8.290025526E−04 | −8.195140608E−03 | −1.090027164E−02 | −2.018598484E−03 |
| A8= | −1.134209776E−03 | 6.240415193E−03 | −4.871579079E−04 | 4.821271649E−03 |
| A10= | 6.534606717E−04 | −3.004057287E−03 | 1.584737555E−02 | −5.036564657E−03 |
| A12= | −2.207697453E−04 | 9.271526125E−04 | −2.007370738E−02 | 8.776211725E−03 |
| A14= | 4.640677018E−05 | −1.813040366E−04 | 1.409538943E−02 | −1.228894331E−02 |
| A16= | −5.977347907E−06 | 2.155888718E−05 | −6.592613240E−03 | 1.090231913E−02 |
| A18= | 4.303621684E−07 | −1.415867311E−06 | 2.161176552E−03 | −6.344943191E−03 |
| A20= | −1.319446930E−08 | 3.930025817E−08 | −5.006267590E−04 | 2.491960072E−03 |
| A22= | — | — | 8.078187046E−05 | −6.635544860E−04 |
| A24= | — | — | −8.774371811E−06 | 1.177909999E−04 |
| A26= | — | — | 6.017869249E−07 | −1.332130278E−05 |
| A28= | — | — | −2.296607890E−08 | 8.669674085E−07 |
| A30= | — | — | 3.551825523E−10 | −2.468781274E−08 |

| Surface # | 7 | 8 | 9 | 10 |
|---|---|---|---|---|
| k= | −6.445920000E−01 | −1.628180000E−02 | −4.448040000E−01 | 9.776460000E+01 |
| A4= | 5.910719057E−02 | 3.040802907E−02 | −3.549985394E−02 | −1.352341730E−02 |
| A6= | −6.729221508E−03 | 9.104500434E−02 | 8.643058561E−02 | −1.263417373E−02 |
| A8= | −3.754058588E−04 | −2.078061632E−01 | −1.059882357E−01 | 1.221007304E−01 |
| A10= | −3.522067892E−02 | 1.271881859E−01 | −1.736636502E−01 | −3.705393415E−01 |
| A12= | 7.985815919E−02 | 1.059609808E−01 | 5.567695860E−01 | 5.699047758E−01 |
| A14= | −8.545173843E−02 | −2.415152553E−01 | −6.513063998E−01 | −5.351528157E−01 |
| A16= | 5.595094118E−02 | 2.035687976E−01 | 4.489338579E−01 | 3.347965277E−01 |
| A18= | −2.459663606E−02 | −1.043432595E−01 | −2.052258895E−01 | −1.458998223E−01 |
| A20= | 7.550794988E−03 | 3.611897327E−02 | 6.513388064E−02 | 4.519247158E−02 |
| A22= | −1.633737202E−03 | −8.690188175E−03 | −1.453229184E−02 | −9.962211061E−03 |
| A24= | 2.451154835E−04 | 1.439899166E−03 | 2.248590471E−03 | 1.533534091E−03 |
| A26= | −2.430519104E−05 | −1.570105560E−04 | −2.305093521E−04 | −1.571068215E−04 |
| A28= | 1.432232807E−06 | 1.014058783E−05 | 1.410052981E−05 | 9.640488677E−06 |
| A30= | −3.793743882E−08 | −2.934927360E−07 | −3.896330311E−07 | −2.682584151E−07 |

| Surface # | 12 | 13 |
|---|---|---|
| k= | 9.900000000E+01 | 5.031110000E+00 |
| A4= | 1.037773961E−02 | 1.138460421E−02 |
| A6= | −1.021420713E−02 | −1.151295574E−02 |
| A8= | 6.370482968E−02 | 5.738027913E−02 |
| A10= | −1.832736888E−01 | −1.569426588E−01 |
| A12= | 3.004166948E−01 | 2.590480301E−01 |
| A14= | −3.188965098E−01 | −2.844149070E−01 |
| A16= | 2.329825409E−01 | 2.179636031E−01 |
| A18= | −1.208058779E−01 | −1.194083534E−01 |
| A20= | 4.499929479E−02 | 4.713274459E−02 |
| A22= | −1.199690382E−02 | −1.331742855E−02 |
| A24= | 2.239582122E−03 | 2.630207893E−03 |
| A26= | −2.785818159E−04 | −3.450953969E−04 |
| A28= | 2.077097836E−05 | 2.703741840E−05 |
| A30= | −7.029634203E−07 | −9.575376210E−07 |

In the 3rd embodiment, the equation of the aspheric surface profiles of the aforementioned lens elements is the same as the equation of the 1st embodiment. Also, the definitions of these parameters shown in Table 30 below are the same as those stated in the 1st embodiment, with corresponding values for the 3rd embodiment; therefore, an explanation in this regard will not be provided again.

Moreover, these parameters can be calculated from Table 3A to Table 30 as the following values and satisfy the following conditions:

TABLE 3D
Values of Optical and Physical Parameters/Definitions

| | | | |
|---|---|---|---|
| fL [mm] | 12.91 | fL/R5 | −5.61 |
| FnoL | 2.45 | \|f3/f2\| | 0.02 |
| HFOVL [deg.] | 14.2 | \|R3/fL\| + \|R4/fL\| | 0.80 |
| FOVL [deg.] | 28.4 | (R1 − R4)/(R1 + R4) | 0.14 |
| fS [mm] | 12.19 | (R1 − R5)/(R1 + R5) | 2.02 |
| FnoS | 2.67 | CT1/CT2 | 1.57 |
| HFOVS [deg.] | 13.1 | CT1/Dr3r8L | 0.37 |
| FOVS [deg.] | 26.2 | T23L/CT4 | 1.75 |
| TLS/TLL | 1.035 | 10 × T45L/fL | 0.40 |
| fL/fG1 | 1.51 | CT5/T45L | 0.50 |
| \|TDS − TDL\| [mm] | 0.65 | N1 | 1.883 |
| 10 × \|TDS − TDL\|/TDL | 1.66 | V5 | 19.5 |
| DG2/DG1 | 0.08 | V5/N5 | 11.68 |
| TLL/fL | 1.43 | ET12L/CT2 | 0.76 |
| BLL/TDL | 3.71 | Sag2R1L/CT2 | 0.59 |
| SDL/TDL | 0.88 | Y1R1L/Y5R2L | 1.47 |
| fL/f3 | −1.55 | Y1R1L/ImgH | 0.80 |
| T34L/CT2 | 0.08 | — | — |

### 4th Embodiment

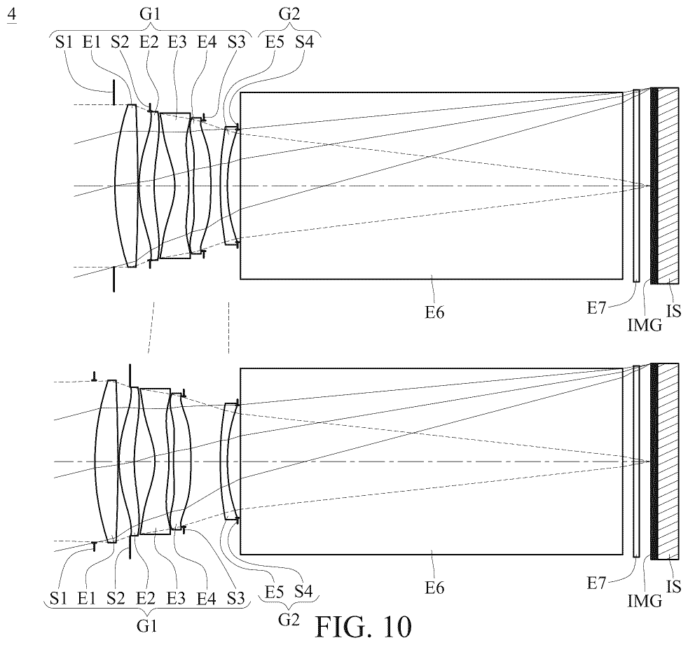

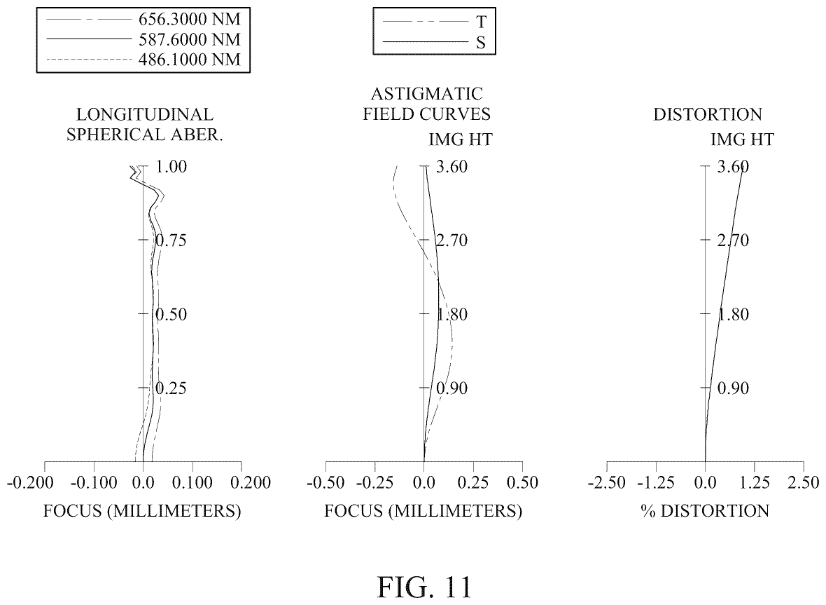

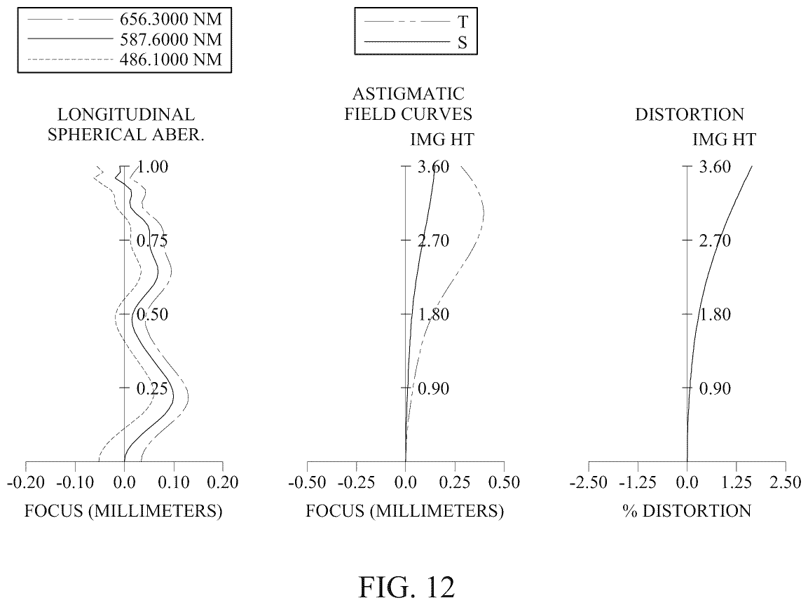

FIG. 10 shows schematic views of an image capturing unit respectively in a first state and a second state according to the 4th embodiment of the present disclosure. FIG. 11 shows, in order from left to right, spherical aberration curves, astigmatic field curves and a distortion curve of the image capturing unit in the first state according to the 4th embodiment. FIG. 12 shows, in order from left to right, spherical aberration curves, astigmatic field curves and a distortion curve of the image capturing unit in the second state according to the 4th embodiment. Moreover, the upper part of FIG. 10 shows the schematic view of the imaging optical lens system in the first state, and the lower part of FIG. 10 shows the schematic view of the imaging optical lens system in the second state. In FIG. 10, the image capturing unit 4 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 10. When an imaged object is located at a finite object distance, the imaging optical lens system is in the second state as shown in the lower part of FIG. 10. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 10, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof. The image-side surface of the second lens element E2 has one critical point in an off-axis region thereof.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has three inflection points. The image-side surface of the third lens element E3 has three inflection points. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has two critical points in an off-axis region thereof. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 10 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface IMG of the imaging optical lens system.

The detailed optical data of the 4th embodiment are shown in Table 4A and Table 4B, and the aspheric surface data are shown in Table 4C below.

TABLE 4A
4th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | 0.030 | | | | |
| 2 | Lens 1 | 9.5007 | (SPH) | 0.848 | Glass | 1.954 | 32.3 | 8.64 |
| 3 | | −59.4117 | (SPH) | 0.445 | | | | |
| 4 | Stop | Plano | | −0.405 | | | | |
| 5 | Lens 2 | 4.4741 | (ASP) | 0.555 | Plastic | 1.544 | 56.0 | 31.94 |
| 6 | | 5.7619 | (ASP) | 0.761 | | | | |
| 7 | Lens 3 | −2.2395 | (ASP) | 0.516 | Plastic | 1.614 | 26.0 | −7.29 |
| 8 | | −4.8782 | (ASP) | 0.166 | | | | |
| 9 | Lens 4 | 9.6320 | (ASP) | 0.639 | Plastic | 1.544 | 56.0 | 10.65 |
| 10 | | −14.2131 | (ASP) | −0.259 | | | | |
| 11 | Stop | Plano | | D1 | | | | |
| 12 | Lens 5 | 25.3444 | (ASP) | 0.260 | Plastic | 1.660 | 20.4 | −18.07 |
| 13 | | 8.0756 | (ASP) | 0.368 | | | | |

| | | | | | | | |
|---|---|---|---|---|---|---|---|
| 14 | Stop | Plano | 0.111 | | | | |
| 15 | Prism | Plano | 14.032 | Glass | 1.835 | 42.7 | — |
| 16 | | Plano | 0.400 | | | | |
| 17 | Filter | Plano | 0.210 | Plastic | 1.517 | 64.2 | — |
| 18 | | Plano | 0.423 | | | | |
| 19 | Image | Plano | — | | | | |

Note:
Reference wavelength is 587.6 nm (d-line).
An effective radius of the stop S1 (Surface 1) is 2.983 mm.
An effective radius of the stop S2 (Surface 4) is 2.738 mm.
An effective radius of the stop S3 (Surface 11) is 2.399 mm.
An effective radius of the stop S4 (Surface 14) is 2.069 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 4 as the imaging optical lens system is in the second state (corresponding to finite object distance).

In this embodiment, the imaging optical lens system is transitioned to the second state to capture an imaged object at a finite object distance of 119.299 mm as an example, but the present disclosure is not limited to this distance.

TABLE 4B
Values of Optical And Physical Parameters/Definitions

| First State (Infinite | | Second State (Finite | |
|---|---|---|---|
| Object Distance) | | Object Distance) | |
| fL [mm] | 13.47 | fS [mm] | 12.70 |
| FnoL | 2.26 | FnoS | 2.46 |
| HFOVL [deg.] | 14.8 | HFOVS [deg.] | 13.6 |
| Object Distance [mm] | ∞ | Object Distance [mm] | 119.299 |
| D0 [mm] | ∞ | D0 [mm] | 119.269 |
| D1 [mm] | 0.609 | D1 [mm] | 1.340 |

The definitions of the parameters shown in Table 4B are the same as those stated in the 1st embodiment, with corresponding values for the 4th embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 4B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 119.299 mm, the imaging optical lens system is transitioned from the first state to the second state, the axial distance D1 between the movable lens group G1 and the last lens group G2 increases from 0.609 mm in the first state to 1.340 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 4C
Aspheric Coefficients

| Surface # | 5 | 6 | 7 | 8 |
|---|---|---|---|---|
| k= | 9.853990000E−03 | −1.553550000E−03 | −6.402240000E−01 | 8.397570000E−03 |
| A4= | −5.661552842E−03 | −1.837245335E−02 | 5.049044071E−02 | 4.121602659E−02 |
| A6= | 2.004547015E−03 | 1.543190547E−02 | −1.424281444E−02 | −1.819968322E−02 |
| A8= | −5.417387896E−03 | −3.766781815E−02 | 2.245010004E−02 | 1.492633587E−02 |
| A10= | 5.939285073E−03 | 5.508151688E−02 | −2.637081092E−02 | −1.071064435E−02 |
| A12= | −3.070788816E−03 | −4.848067348E−02 | 1.853225738E−02 | 5.759795956E−03 |
| A14= | 5.262034530E−04 | 2.787106801E−02 | −8.472966932E−03 | −2.257115029E−03 |
| A16= | 2.410580717E−04 | −1.103573734E−02 | 2.638165574E−03 | 6.794320028E−04 |
| A18= | −1.779465346E−04 | 3.098227994E−03 | −5.657076218E−04 | −1.703848092E−04 |
| A20= | 5.453561811E−05 | −6.234049110E−04 | 8.185734329E−05 | 3.701124252E−05 |
| A22= | −1.002644419E−05 | 8.940650309E−05 | −7.456377712E−06 | −6.652772361E−06 |
| A24= | 1.177395263E−06 | −8.922364390E−06 | 3.403762253E−07 | 9.010006776E−07 |
| A26= | −8.686467212E−08 | 5.884170444E−07 | 2.641576710E−09 | −8.305180085E−08 |
| A28= | 3.681113170E−09 | −2.303168661E−08 | −1.018175267E−09 | 4.571738253E−09 |
| A30= | −6.846616675E−11 | 4.047762866E−10 | 3.260494283E−11 | −1.128176946E−10 |
| Surface # | 9 | 10 | 12 | 13 |
| k= | −1.242180000E−01 | −5.390780000E−02 | 5.901200000E−02 | 2.673060000E−02 |
| A4= | −1.134849085E−02 | 8.061783036E−03 | 2.161234819E−02 | 1.764727427E−02 |
| A6= | −1.175828700E−02 | −3.608792652E−02 | −8.795660758E−04 | −1.233379499E−03 |
| A8= | −2.836476535E−02 | 2.745955969E−02 | −4.862421536E−02 | −1.333178191E−02 |
| A10= | 6.009778365E−02 | −1.463208884E−02 | 1.129219842E−01 | 1.755357052E−02 |
| A12= | −5.935390163E−02 | 6.643543550E−03 | −1.499804861E−01 | −1.070775351E−02 |
| A14= | 3.835423460E−02 | −2.516704253E−03 | 1.340286676E−01 | 2.368742132E−03 |
| A16= | −1.743572349E−02 | 7.361426865E−04 | −8.420399083E−02 | 1.263632791E−03 |
| A18= | 5.704842097E−03 | −1.578853088E−04 | 3.774511353E−02 | −1.363219312E−03 |
| A20= | −1.348717808E−03 | 2.471366836E−05 | −1.209463693E−02 | 6.357049570E−04 |
| A22= | 2.281147351E−04 | −2.976207835E−06 | 2.743936756E−03 | −1.884516651E−04 |
| A24= | −2.688560380E−05 | 3.012469825E−07 | −4.298751016E−04 | 3.745077263E−05 |
| A26= | 2.095107404E−06 | −2.522793322E−08 | 4.418992964E−05 | −4.844026659E−06 |
| A28= | −9.693157584E−08 | 1.412254872E−09 | −2.680148420E−06 | 3.685282165E−07 |
| A30= | 2.014318294E−09 | −3.555981065E−11 | 7.264042917E−08 | −1.249438152E−08 |

In the 4th embodiment, the equation of the aspheric surface profiles of the aforementioned lens elements is the same as the equation of the 1st embodiment. Also, the definitions of these parameters shown in Table 4D below are the same as those stated in the 1st embodiment, with corresponding values for the 4th embodiment; therefore, an explanation in this regard will not be provided again.

Moreover, these parameters can be calculated from Table 4A to Table 40 as the following values and satisfy the following conditions:

TABLE 4D
Values of Optical and Physical Parameters/Definitions

| | | | |
|---|---|---|---|
| fL [mm] | 13.47 | fL/R5 | −6.01 |
| FnoL | 2.26 | \|f3/f2\| | 0.23 |
| HFOVL [deg.] | 14.8 | \|R3/fL\| + \|R4/fL\| | 0.76 |
| FOVL [deg.] | 29.6 | (R1 − R4)/(R1 + R4) | 0.24 |
| fS [mm] | 12.70 | (R1 − R5)/(R1 + R5) | 1.62 |
| FnoS | 2.46 | CT1/CT2 | 1.53 |
| HFOVS [deg.] | 13.6 | CT1/Dr3r8L | 0.32 |
| FOVS [deg.] | 27.2 | T23L/CT4 | 1.19 |
| TLS/TLL | 1.037 | 10 × T45L/fL | 0.26 |
| fL/fG1 | 1.50 | CT5/T45L | 0.74 |
| \|TDS − TDL\| [mm] | 0.73 | N1 | 1.954 |
| 10 × \|TDS − TDL\|/TDL | 1.77 | V5 | 20.4 |
| DG2/DG1 | 0.07 | V5/N5 | 12.29 |
| TLL/fL | 1.46 | ET12L/CT2 | 0.98 |
| BLL/TDL | 3.76 | Sag2R1L/CT2 | 0.78 |
| SDL/TDL | 1.01 | Y1R1L/Y5R2L | 1.44 |
| fL/f3 | −1.85 | Y1R1L/ImgH | 0.83 |
| T34L/CT2 | 0.30 | — | — |

### 5th Embodiment

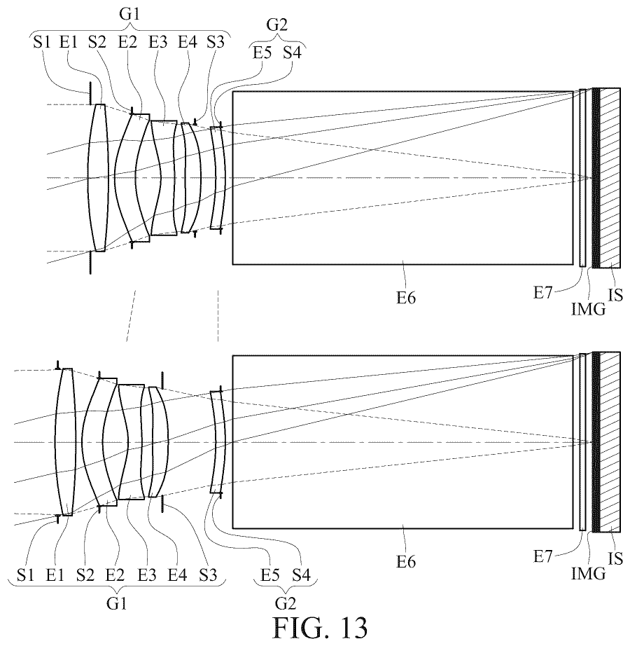

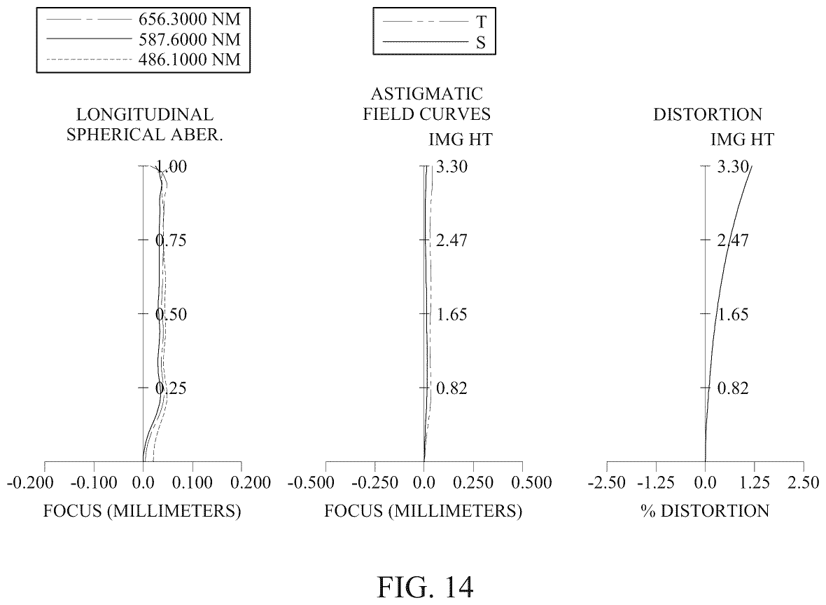

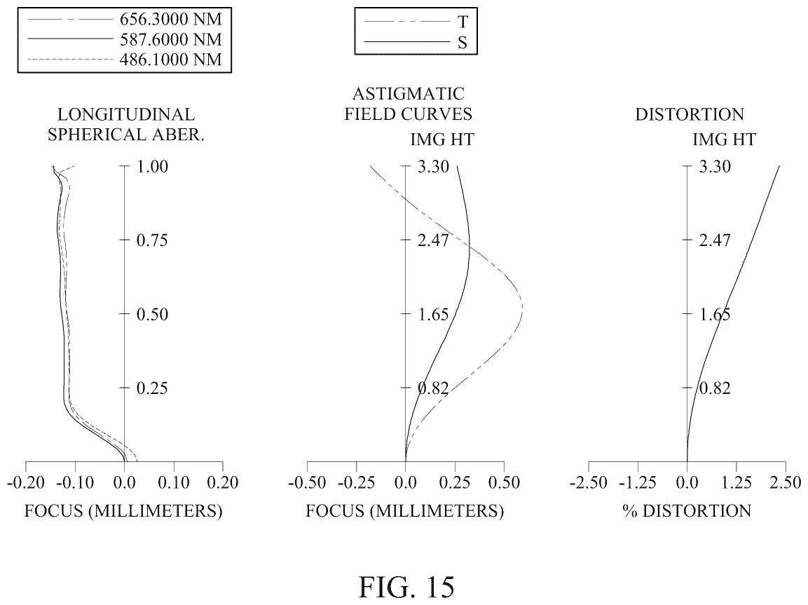

FIG. 13 shows schematic views of an image capturing unit respectively in a first state and a second state according to the 5th embodiment of the present disclosure. FIG. 14 shows, in order from left to right, spherical aberration curves, astigmatic field curves and a distortion curve of the image capturing unit in the first state according to the 5th embodiment. FIG. 15 shows, in order from left to right, spherical aberration curves, astigmatic field curves and a distortion curve of the image capturing unit in the second state according to the 5th embodiment. Moreover, the upper part of FIG. 13 shows the schematic view of the imaging optical lens system in the first state, and the lower part of FIG. 13 shows the schematic view of the imaging optical lens system in the second state. In FIG. 13, the image capturing unit includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 13. When an imaged object is located at a finite object distance, the imaging optical lens system is in the second state as shown in the lower part of FIG. 13. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 13, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The image-side surface of the first lens element E1 has one inflection point.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has three inflection points.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has one critical point in an off-axis region thereof.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 13 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface IMG of the imaging optical lens system.

The detailed optical data of the 5th embodiment are shown in Table 5A and Table 5B, and the aspheric surface data are shown in Table 5C below.

TABLE 5A
5th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.099 | | | | |
| 2 | Lens 1 | 13.3021 | (ASP) | 0.762 | Glass | 1.954 | 32.3 | 9.53 |
| 3 | | −27.9169 | (ASP) | 0.862 | | | | |
| 4 | Stop | Plano | | −0.638 | | | | |
| 5 | Lens 2 | 3.3258 | (ASP) | 0.763 | Plastic | 1.544 | 56.0 | 38.38 |
| 6 | | 3.6361 | (ASP) | 0.938 | | | | |
| 7 | Lens 3 | −2.3876 | (ASP) | 0.505 | Plastic | 1.660 | 20.4 | −5.56 |
| 8 | | −7.3978 | (ASP) | 0.389 | | | | |
| 9 | Lens 4 | 9.4579 | (ASP) | 0.577 | Plastic | 1.544 | 56.0 | 9.54 |
| 10 | | −11.2590 | (ASP) | −0.218 | | | | |
| 11 | Stop | Plano | | D1 | | | | |
| 12 | Lens 5 | −8.1449 | (ASP) | 0.350 | Plastic | 1.669 | 19.5 | 1239.25 |
| 13 | | −8.2046 | (ASP) | −0.172 | | | | |

| | | | | | | | |
|---|---|---|---|---|---|---|---|
| 14 | Stop | Plano | 0.450 | | | | |
| 15 | Prism | Plano | 12.500 | Glass | 1.835 | 42.7 | — |
| 16 | | Plano | 0.250 | | | | |
| 17 | Filter | Plano | 0.210 | Plastic | 1.517 | 64.2 | — |
| 18 | | Plano | 0.260 | | | | |
| 19 | Image | Plano | — | | | | |

Note:
Reference wavelength is 587.6 nm (d-line).
An effective radius of the stop S1 (Surface 1) is 2.698 mm.
An effective radius of the stop S2 (Surface 4) is 2.249 mm.
An effective radius of the stop S3 (Surface 11) is 1.968 mm.
An effective radius of the stop S4 (Surface 14) is 1.864 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 11 as the imaging optical lens system is in the second state (corresponding to finite object distance).

In this embodiment, the imaging optical lens system is transitioned to the second state to capture an imaged object at a finite object distance of 118.701 mm as an example, but the present disclosure is not limited to this distance.

TABLE 5B
Values of Optical And Physical Parameters/Definitions

| First State (Infinite | | Second State (Finite | |
|---|---|---|---|
| Object Distance) | | Object Distance) | |
| fL [mm] | 12.17 | fS [mm] | 12.19 |
| FnoL | 2.26 | FnoS | 2.56 |
| HFOVL [deg.] | 15.0 | HFOVS [deg.] | 13.0 |
| Object Distance [mm] | ∞ | Object Distance [mm] | 118.701 |
| D0 [mm] | ∞ | D0 [mm] | 118.800 |
| D1 [mm] | 0.766 | D1 [mm] | 1.966 |

The definitions of the parameters shown in Table 5B are the same as those stated in the 1st embodiment, with corresponding values for the 5th embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 5B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 118.701 mm, the imaging optical lens system is transitioned from the first state to the second state, the axial distance D1 between the movable lens group G1 and the last lens group G2 increases from 0.766 mm in the first state to 1.966 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 5C
Aspheric Coefficients

| Surface # | 2 | 3 | 5 | 6 |
|---|---|---|---|---|
| k= | 2.960400000E+00 | 2.681490000E+01 | −3.392450000E−01 | 6.051890000E−01 |
| A4= | 1.121369374E−04 | −2.177738177E−03 | −5.644791183E−03 | −3.920766410E−03 |
| A6= | 3.181855611E−04 | 3.751710245E−04 | −2.911878417E−03 | 7.441362830E−03 |
| A8= | −9.452319319E−05 | 4.861110560E−04 | 4.419150232E−03 | −4.070827173E−02 |
| A10= | 1.632358908E−05 | −2.757728166E−04 | −1.055235193E−02 | 7.152205725E−02 |
| A12= | −3.147246786E−06 | 6.490756992E−05 | 1.542520387E−02 | −8.371373083E−02 |
| A14= | 3.711563070E−07 | −8.185489245E−06 | −1.367517198E−02 | 7.290950885E−02 |
| A16= | −1.499699128E−08 | 5.518060371E−07 | 8.030718419E−03 | −4.752608607E−02 |
| A18= | — | −1.563824671E−08 | −3.278602078E−03 | 2.292247214E−02 |
| A20= | — | — | 9.467213807E−04 | −8.095877461E−03 |
| A22= | — | — | −1.926702452E−04 | 2.062783641E−03 |
| A24= | — | — | 2.701747590E−05 | −3.685099410E−04 |
| A26= | — | — | −2.483536084E−06 | 4.371672947E−05 |
| A28= | — | — | 1.346864661E−07 | −3.086704100E−06 |
| A30= | — | — | −3.266573941E−09 | 9.795969820E−08 |
| Surface # | 7 | 8 | 9 | 10 |
| k= | −6.729020000E−01 | 6.285900000E−01 | −3.048960000E+01 | 1.654370000E+01 |
| A4= | 5.508569629E−02 | −9.896540910E−03 | −1.216775605E−01 | −9.770411521E−02 |
| A6= | 6.156310514E−02 | 1.889760270E−01 | 3.029526449E−01 | 2.630186382E−01 |
| A8= | −2.195615162E−01 | −4.529926033E−01 | −6.000750315E−01 | −5.412886192E−01 |
| A10= | 3.620226183E−01 | 6.804543975E−01 | 8.216184049E−01 | 7.808532123E−01 |
| A12= | −3.871398377E−01 | −7.091967434E−01 | −8.063505296E−01 | −8.162824041E−01 |
| A14= | 2.922744637E−01 | 5.379440598E−01 | 5.843641188E−01 | 6.317295097E−01 |
| A16= | −1.615178675E−01 | −3.040727515E−01 | −3.176624136E−01 | −3.655564784E−01 |
| A18= | 6.620784901E−02 | 1.289331575E−01 | 1.298625141E−01 | 1.582668050E−01 |
| A20= | −2.010611412E−02 | −4.077503331E−02 | −3.959529460E−02 | −5.087898817E−02 |
| A22= | 4.462601517E−03 | 9.457589323E−03 | 8.837268758E−03 | 1.193994872E−02 |
| A24= | −7.033079895E−04 | −1.559821760E−03 | −1.397268647E−03 | −1.983080504E−03 |
| A26= | 7.453463997E−05 | 1.730375597E−04 | 1.477755460E−04 | 2.204776059E−04 |
| A28= | −4.762184004E−06 | −1.157138660E−05 | −9.351233028E−06 | −1.470172251E−05 |
| A30= | 1.385816301E−07 | 3.524628490E−07 | 2.669939991E−07 | 4.441251833E−07 |

| Surface # | 12 | 13 |
|---|---|---|
| k= | 1.013390000E+01 | 1.208720000E+01 |
| A4= | −7.017555548E−02 | −3.613499425E−02 |
| A6= | 2.937624530E−01 | 1.600109336E−01 |
| A8= | −7.169325574E−01 | −3.626246804E−01 |
| A10= | 1.196781691E+00 | 5.477588013E−01 |
| A12= | −1.422129962E+00 | −5.753876848E−01 |
| A14= | 1.233844912E+00 | 4.316107069E−01 |
| A16= | −7.926959229E−01 | −2.343144293E−01 |
| A18= | 3.789608291E−01 | 9.225078206E−02 |
| A20= | −1.342600112E−01 | −2.607595909E−02 |
| A22= | 3.473969718E−02 | 5.155924662E−03 |
| A24= | −6.374473435E−03 | −6.768238279E−04 |
| A26= | 7.851958631E−04 | 5.297734337E−05 |
| A28= | −5.819678697E−05 | −1.870883129E−06 |
| A30= | 1.960759988E−06 | — |

In the 5th embodiment, the equation of the aspheric surface profiles of the aforementioned lens elements is the same as the equation of the 1st embodiment. Also, the definitions of these parameters shown in Table 5D below are the same as those stated in the 1st embodiment, with corresponding values for the 5th embodiment; therefore, an explanation in this regard will not be provided again.

Moreover, these parameters can be calculated from Table 5A to Table 50 as the following values and satisfy the following conditions:

TABLE 5D
Values of Optical and Physical Parameters/Definitions

| | | | |
|---|---|---|---|
| fL [mm] | 12.17 | fL/R5 | −5.10 |
| FnoL | 2.26 | \|f3/f2\| | 0.14 |
| HFOVL [deg.] | 15.0 | \|R3/fL\| + \|R4/fL\| | 0.57 |
| FOVL [deg.] | 30.0 | (R1 − R4)/(R1 + R4) | 0.57 |
| fS [mm] | 12.19 | (R1 − R5)/(R1 + R5) | 1.44 |
| FnoS | 2.56 | CT1/CT2 | 1.00 |
| HFOVS [deg.] | 13.0 | CT1/Dr3r8L | 0.24 |
| FOVS [deg.] | 26.0 | T23L/CT4 | 1.63 |
| TLS/TLL | 1.065 | 10 × T45L/fL | 0.45 |
| fL/fG1 | 1.01 | CT5/T45L | 0.64 |
| \|TDS − TDL\| [mm] | 1.20 | N1 | 1.954 |
| 10 × \|TDS − TDL\|/TDL | 2.37 | V5 | 19.5 |
| DG2/DG1 | 0.08 | V5/N5 | 11.68 |
| TLL/fL | 1.52 | ET12L/CT2 | 1.32 |
| BLL/TDL | 2.67 | Sag2R1L/CT2 | 0.85 |
| SDL/TDL | 0.98 | Y1R1L/Y5R2L | 1.45 |
| fL/f3 | −2.19 | Y1R1L/ImgH | 0.82 |
| T34L/CT2 | 0.51 | — | — |

### 6th Embodiment

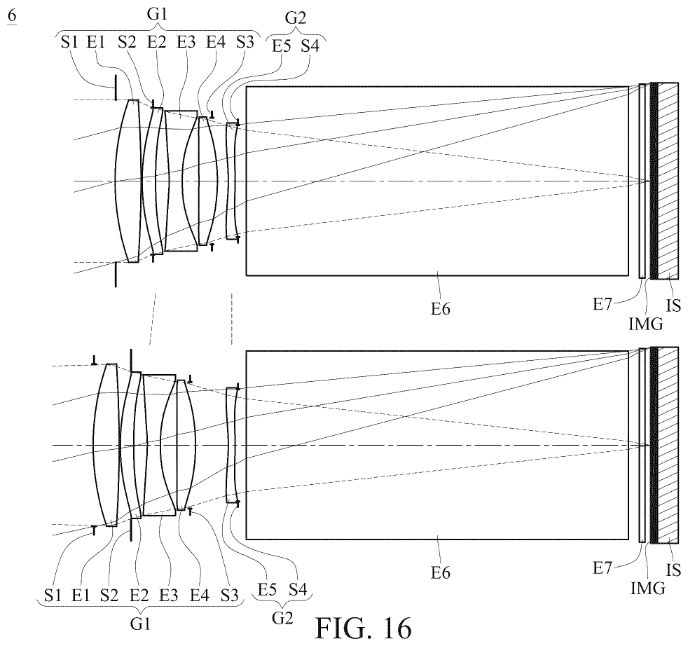

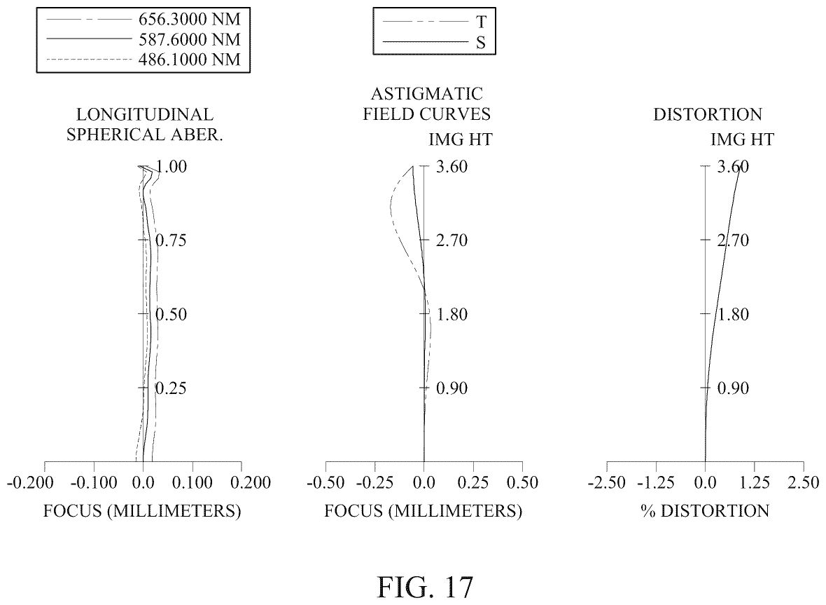

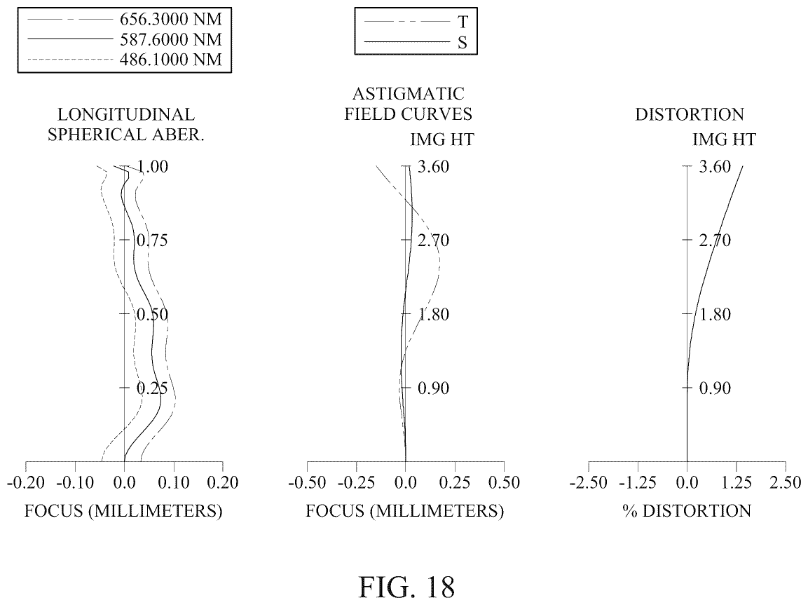

FIG. 16 shows schematic views of an image capturing unit respectively in a first state and a second state according to the 6th embodiment of the present disclosure. FIG. 17 shows, in order from left to right, spherical aberration curves, astigmatic field curves and a distortion curve of the image capturing unit in the first state according to the 6th embodiment. FIG. 18 shows, in order from left to right, spherical aberration curves, astigmatic field curves and a distortion curve of the image capturing unit in the second state according to the 6th embodiment. Moreover, the upper part of FIG. 16 shows the schematic view of the imaging optical lens system in the first state, and the lower part of FIG. 16 shows the schematic view of the imaging optical lens system in the second state. In FIG. 16, the image capturing unit 6 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 16. When an imaged object is located at a finite object distance, the imaging optical lens system is in the second state as shown in the lower part of FIG. 16. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 16, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both aspheric. The object-side surface of the second lens element E2 has one inflection point. The image-side surface of the second lens element E2 has one inflection point.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has three inflection points. The image-side surface of the third lens element E3 has two inflection points.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has one inflection point. The object-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 16 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface IMG of the imaging optical lens system.

The detailed optical data of the 6th embodiment are shown in Table 6A and Table 6B, and the aspheric surface data are shown in Table 60 below.

TABLE 6A
6th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.030 | | | | |
| 2 | Lens 1 | 9.1593 | (SPH) | 0.957 | Glass | 1.954 | 32.3 | 7.99 |
| 3 | | −43.1711 | (SPH) | 0.436 | | | | |
| 4 | Stop | Plano | | −0.396 | | | | |
| 5 | Lens 2 | 7.4591 | (ASP) | 0.493 | Glass | 1.851 | 40.1 | 14.06 |
| 6 | | 19.1983 | (ASP) | 0.500 | | | | |
| 7 | Lens 3 | −5.0557 | (ASP) | 0.481 | Plastic | 1.615 | 25.4 | −5.56 |
| 8 | | 10.9223 | (ASP) | 0.609 | | | | |
| 9 | Lens 4 | −36.6596 | (ASP) | 0.680 | Plastic | 1.544 | 56.0 | 13.67 |
| 10 | | −6.2243 | (ASP) | −0.202 | | | | |
| 11 | Stop | Plano | | D1 | | | | |
| 12 | Lens 5 | −6.6010 | (ASP) | 0.250 | Plastic | 1.656 | 21.3 | −21.07 |
| 13 | | −12.8250 | (ASP) | 0.105 | | | | |

| | | | | | | | |
|---|---|---|---|---|---|---|---|
| 14 | Stop | Plano | 0.308 | | | | |
| 15 | Prism | Plano | 14.032 | Glass | 1.835 | 42.7 | — |
| 16 | | Plano | 0.400 | | | | |
| 17 | Filter | Plano | 0.210 | Plastic | 1.517 | 64.2 | — |
| 18 | | Plano | 0.202 | | | | |
| 19 | Image | Plano | — | | | | |

Note:
Reference wavelength is 587.6 nm (d-line).
An effective radius of the stop S1 (Surface 1) is 2.981 mm.
An effective radius of the stop S2 (Surface 4) is 2.696 mm.
An effective radius of the stop S3 (Surface 11) is 2.234 mm.
An effective radius of the stop S4 (Surface 14) is 2.058 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 4 as the imaging optical lens system is in the second state (corresponding to finite object distance).

In this embodiment, the imaging optical lens system is transitioned to the second state to capture an imaged object at a finite object distance of 119.197 mm as an example, but the present disclosure is not limited to this distance.

TABLE 6B
Values of Optical And Physical Parameters/Definitions

| First State (Infinite | | Second State (Finite | |
|---|---|---|---|
| Object Distance) | | Object Distance) | |
| fL [mm] | 13.47 | fS [mm] | 12.77 |
| FnoL | 2.26 | FnoS | 2.48 |
| HFOVL [deg.] | 14.8 | HFOVS [deg.] | 13.5 |
| Object Distance [mm] | ∞ | Object Distance [mm] | 119.197 |
| D0 [mm] | ∞ | D0 [mm] | 119.227 |
| D1 [mm] | 0.602 | D1 [mm] | 1.405 |

The definitions of the parameters shown in Table 6B are the same as those stated in the 1st embodiment, with corresponding values for the 6th embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 6B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 119.197 mm, the imaging optical lens system is transitioned from the first state to the second state, the axial distance D1 between the movable lens group G1 and the last lens group G2 increases from 0.602 mm in the first state to 1.405 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 6C
Aspheric Coefficients

| Surface # | 5 | 6 | 7 | 8 |
|---|---|---|---|---|
| k= | 0.000000000E+00 | 0.000000000E+00 | 7.869100000E−01 | 0.000000000E+00 |
| A4= | −1.629514583E−03 | 5.437045707E−03 | 8.021921023E−02 | 8.036268126E−02 |
| A6= | 1.353478272E−03 | 9.591737004E−04 | −5.465178573E−02 | −5.696824913E−02 |
| A8= | −8.980727897E−04 | −1.993365770E−03 | 2.946739771E−02 | 2.070974372E−02 |
| A10= | 2.654629308E−04 | 9.253466337E−04 | −1.331558520E−02 | 8.021514293E−04 |
| A12= | −2.410189560E−05 | −1.897204866E−04 | 5.323416140E−03 | −5.004929039E−03 |
| A14= | −5.583685153E−06 | 1.260725678E−05 | −1.805387754E−03 | 2.700688206E−03 |
| A16= | 1.682795561E−06 | 1.583028520E−06 | 4.782796958E−04 | −7.908864942E−04 |
| A18= | −1.665909704E−07 | −3.138433038E−07 | −9.257843648E−05 | 1.435813411E−04 |
| A20= | 5.967523498E−09 | 1.486173317E−08 | 1.242646800E−05 | −1.621167962E−05 |
| A22= | — | — | −1.087250454E−06 | 1.049772204E−06 |
| A24= | — | — | 5.555066907E−08 | −2.988287491E−08 |
| A26= | — | — | −1.254047085E−09 | — |
| Surface # | 9 | 10 | 12 | 13 |
| k= | 0.000000000E+00 | 0.000000000E+00 | 0.000000000E+00 | 0.000000000E+00 |
| A4= | 2.676760158E−02 | 2.096172230E−02 | 3.970619346E−02 | 3.000906870E−02 |
| A6= | −3.010868550E−02 | −4.117171815E−02 | −3.137166106E−02 | −8.086125163E−03 |
| A8= | 1.564877631E−02 | 4.686096639E−02 | 2.872903440E−02 | −4.608435249E−03 |
| A10= | 2.457016232E−03 | −3.370169277E−02 | −1.872137632E−02 | 1.121796070E−02 |
| A12= | −9.248990371E−03 | 1.595925921E−02 | 8.232624904E−03 | −9.134437804E−03 |
| A14= | 6.549628198E−03 | −5.092422976E−03 | −2.430533674E−03 | 4.187658643E−03 |
| A16= | −2.599633965E−03 | 1.098243360E−03 | 4.739770475E−04 | −1.173144862E−03 |
| A18= | 6.585499577E−04 | −1.565434397E−04 | −5.841911117E−05 | 1.993614394E−04 |
| A20= | −1.088455555E−04 | 1.392274860E−05 | 4.111514781E−06 | −1.891139133E−05 |
| A22= | 1.137767342E−05 | −6.821890754E−07 | −1.254758745E−07 | 7.692039023E−07 |
| A24= | −6.826667222E−07 | 1.337663722E−08 | — | — |
| A26= | 1.789641218E−08 | — | — | — |

In the 6th embodiment, the equation of the aspheric surface profiles of the aforementioned lens elements is the same as the equation of the 1st embodiment. Also, the definitions of these parameters shown in Table 6D below are the same as those stated in the 1st embodiment, with corresponding values for the 6th embodiment; therefore, an explanation in this regard will not be provided again.

Moreover, these parameters can be calculated from Table 6A to Table 60 as the following values and satisfy the following conditions:

TABLE 6D
Values of Optical and Physical Parameters/Definitions

| | | | |
|---|---|---|---|
| fL [mm] | 13.47 | fL/R5 | −2.66 |
| FnoL | 2.26 | \|f3/f2\| | 0.40 |
| HFOVL [deg.] | 14.8 | \|R3/fL\| + \|R4/fL\| | 1.98 |
| FOVL [deg.] | 29.6 | (R1 − R4)/(R1 + R4) | −0.35 |
| fS [mm] | 12.77 | (R1 − R5)/(R1 + R5) | 3.46 |
| FnoS | 2.48 | CT1/CT2 | 1.94 |
| HFOVS [deg.] | 13.5 | CT1/Dr3r8L | 0.35 |
| FOVS [deg.] | 27.0 | T23L/CT4 | 0.74 |
| TLS/TLL | 1.041 | 10 × T45L/fL | 0.30 |
| fL/fG1 | 1.43 | CT5/T45L | 0.63 |
| \|TDS − TDL\| [mm] | 0.80 | N1 | 1.954 |
| 10 × \|TDS − TDL\|/TDL | 1.82 | V5 | 21.3 |
| DG2/DG1 | 0.07 | V5/N5 | 12.86 |
| TLL/fL | 1.46 | ET12L/CT2 | 1.11 |
| BLL/TDL | 3.46 | Sag2R1L/CT2 | 0.83 |
| SDL/TDL | 0.99 | Y1R1L/Y5R2L | 1.45 |
| fL/f3 | −2.42 | Y1R1L/ImgH | 0.83 |
| T34L/CT2 | 1.24 | — | — |

### 7th Embodiment

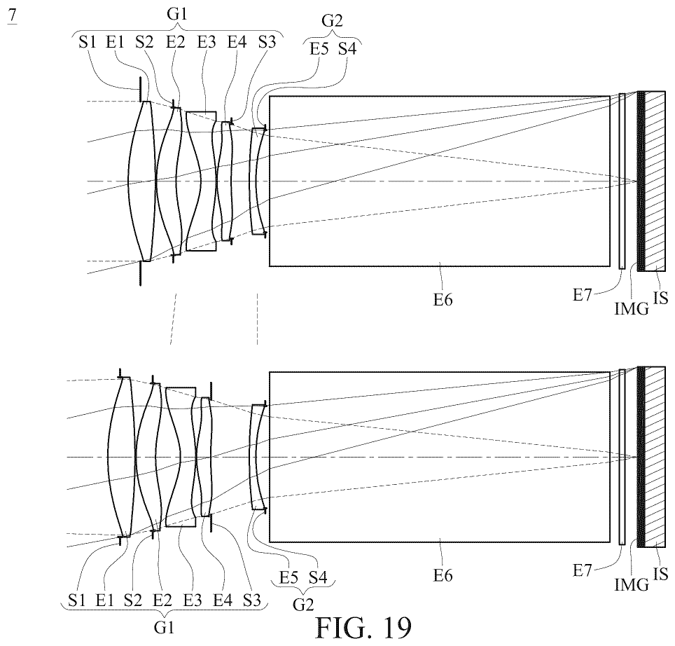

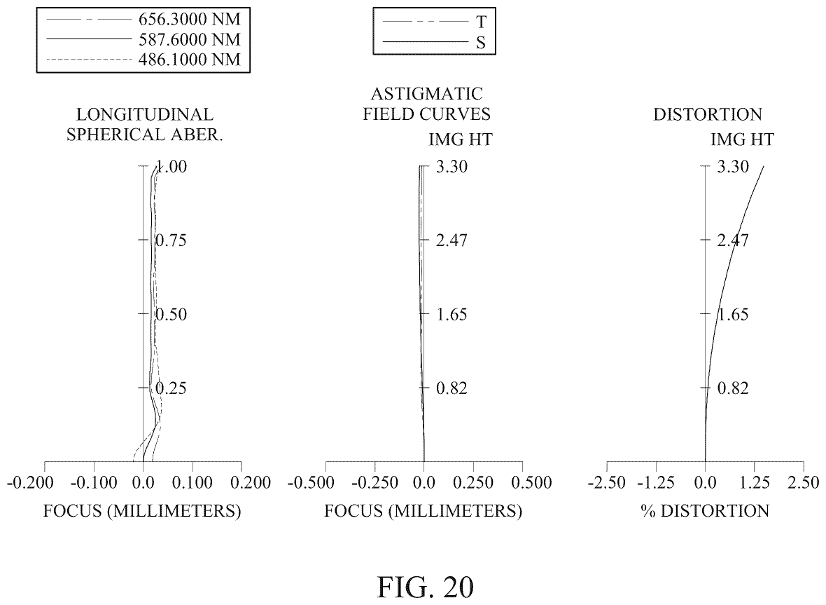

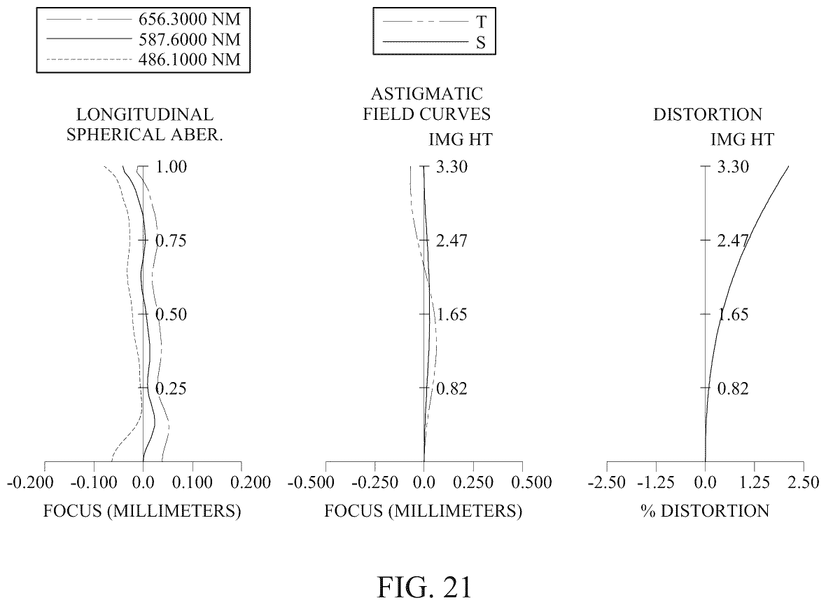

FIG. 19 shows schematic views of an image capturing unit respectively in a first state and a second state according to the 7th embodiment of the present disclosure. FIG. 20 shows, in order from left to right, spherical aberration curves, astigmatic field curves and a distortion curve of the image capturing unit in the first state according to the 7th embodiment. FIG. 21 shows, in order from left to right, spherical aberration curves, astigmatic field curves and a distortion curve of the image capturing unit in the second state according to the 7th embodiment. Moreover, the upper part of FIG. 19 shows the schematic view of the imaging optical lens system in the first state, and the lower part of FIG. 19 shows the schematic view of the imaging optical lens system in the second state. In FIG. 19, the image capturing unit 7 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 19. When an imaged object is located at a finite object distance, the imaging optical lens system is in the second state as shown in the lower part of FIG. 19. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 19, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The image-side surface of the first lens element E1 has two inflection points.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The image-side surface of the second lens element E2 has one critical point in an off-axis region thereof.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points. The object-side surface of the fourth lens element E4 has two critical points in an off-axis region thereof. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 19 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface LMG of the imaging optical lens system.

The detailed optical data of the 7th embodiment are shown in Table 7A and Table 7B3, and the aspheric surface data are shown in Table 70 below.

TABLE 7A
7th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.448 | | | | |
| 2 | Lens 1 | 6.8084 | (ASP) | 0.997 | Plastic | 1.545 | 56.1 | 10.07 |
| 3 | | −26.8774 | (ASP) | 0.657 | | | | |
| 4 | Stop | Plano | | −0.617 | | | | |
| 5 | Lens 2 | 4.0561 | (ASP) | 0.719 | Plastic | 1.642 | 22.5 | 37.95 |
| 6 | | 4.5295 | (ASP) | 0.914 | | | | |
| 7 | Lens 3 | −2.1066 | (ASP) | 0.559 | Plastic | 1.669 | 19.5 | −6.93 |
| 8 | | −4.2723 | (ASP) | 0.030 | | | | |
| 9 | Lens 4 | 3.1400 | (ASP) | 0.523 | Plastic | 1.587 | 28.3 | 7.74 |
| 10 | | 9.5310 | (ASP) | 0.010 | | | | |
| 11 | Stop | Plano | | D1 | | | | |
| 12 | Lens 5 | 24.4450 | (ASP) | 0.240 | Plastic | 1.639 | 23.5 | −13.30 |
| 13 | | 6.2784 | (ASP) | 0.338 | | | | |

| | | | | | | | |
|---|---|---|---|---|---|---|---|
| 14 | Stop | Plano | 0.162 | | | | |
| 15 | Prism | Plano | 12.500 | Glass | 1.835 | 42.7 | — |
| 16 | | Plano | 0.350 | | | | |
| 17 | Filter | Plano | 0.210 | Plastic | 1.517 | 64.2 | — |
| 18 | | Plano | 0.463 | | | | |
| 19 | Image | Plano | — | | | | |

Note:
Reference wavelength is 587.6 nm (d-line).
An effective radius of the stop S1 (Surface 1) is 2.935 mm.
An effective radius of the stop S2 (Surface 4) is 2.710 mm.
An effective radius of the stop S3 (Surface 11) is 2.105 mm.
An effective radius of the stop S4 (Surface 14) is 1.877 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 11 as the imaging optical lens system is in the second state (corresponding to finite object distance).

In this embodiment, the imaging optical lens system is transitioned to the second state to capture an imaged object at a finite object distance of 103.052 mm as an example, but the present disclosure is not limited to this distance.

TABLE 7B
Values of Optical And Physical Parameters/Definitions

| First State (Infinite | | Second State (Finite | |
|---|---|---|---|
| Object Distance) | | Object Distance) | |
| fL [mm] | 13.79 | fS [mm] | 12.64 |
| FnoL | 2.35 | FnoS | 2.63 |
| HFOVL [deg.] | 13.2 | HFOVS [deg.] | 11.7 |
| Object Distance [mm] | ∞ | Object Distance [mm] | 103.052 |
| D0 [mm] | ∞ | D0 [mm] | 103.500 |
| D1 [mm] | 0.661 | D1 [mm] | 1.411 |

The definitions of the parameters shown in Table 71B are the same as those stated in the 1st embodiment, with corresponding values for the 7th embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 7B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 103.052 mm, the imaging optical lens system is transitioned from the first state to the second state, the axial distance D1 between the movable lens group G1 and the last lens group G2 increases from 0.661 mm in the first state to 1.411 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 7C
Aspheric Coefficients

| Surface # | 2 | 3 | 5 | 6 |
|---|---|---|---|---|
| k= | −1.611540000E+00 | 7.147020000E+01 | 2.112450000E−01 | −1.841170000E+00 |
| A4= | 9.519015624E−04 | −1.948309813E−02 | −2.772140012E−02 | −1.785814383E−02 |
| A6= | −1.473623089E−03 | 2.912775165E−02 | 3.227006487E−02 | 4.833660047E−03 |
| A8= | 1.449721798E−03 | −2.132344096E−02 | −2.713267074E−02 | 3.451293157E−04 |
| A10= | −8.919109221E−04 | 9.130504572E−03 | 1.876042476E−02 | 4.717881292E−04 |
| A12= | 3.220301984E−04 | −2.464318032E−03 | −1.211535567E−02 | −4.850085924E−03 |
| A14= | −7.108943622E−05 | 4.339179485E−04 | 6.444789378E−03 | 5.416563527E−03 |
| A16= | 9.667522979E−06 | −4.989901396E−05 | −2.535350900E−03 | −3.055006313E−03 |
| A18= | −7.689635487E−07 | 3.623223691E−06 | 7.166741542E−04 | 1.072157930E−03 |
| A20= | 2.940916594E−08 | −1.517010078E−07 | −1.453135970E−04 | −2.518353566E−04 |
| A22= | −5.197807447E−11 | 2.864026497E−09 | 2.103915726E−05 | 4.054307076E−05 |
| A24= | −2.198617571E−11 | −4.575404616E−12 | −2.131877601E−06 | −4.440360152E−06 |
| A26= | — | — | 1.440839733E−07 | 3.174775715E−07 |
| A28= | — | — | −5.845671791E−09 | −1.339992456E−08 |
| A30= | — | — | 1.077605878E−10 | 2.537083204E−10 |

| Surface # | 7 | 8 | 9 | 10 |
|---|---|---|---|---|
| k= | −6.981170000E−01 | −7.301070000E−01 | −3.427800000E+00 | −4.487720000E+01 |
| A4= | 7.766619442E−02 | 6.300620551E−02 | −3.022235122E−03 | −9.432546791E−03 |
| A6= | −4.286473521E−02 | −9.505629497E−02 | −6.677381261E−02 | 2.559370788E−02 |
| A8= | 3.572732883E−02 | 1.428458559E−01 | 1.089163054E−01 | −8.002286293E−02 |
| A10= | −3.082807301E−02 | −1.583397467E−01 | −1.310479838E−01 | 1.219317077E−01 |
| A12= | 2.138126832E−02 | 1.300011253E−01 | 1.207387120E−01 | −1.237273300E−01 |
| A14= | −1.080026411E−02 | −7.946368837E−02 | −8.505107874E−02 | 8.913463244E−02 |
| A16= | 3.934968601E−03 | 3.637274980E−02 | 4.512828443E−02 | −4.685824515E−02 |
| A18= | −1.042861154E−03 | −1.246934114E−02 | −1.773180608E−02 | 1.825813134E−02 |
| A20= | 2.018407014E−04 | 3.177555140E−03 | 5.078632997E−03 | −5.294096184E−03 |
| A22= | −2.830955830E−05 | −5.915123032E−04 | −1.039937049E−03 | 1.131315280E−03 |
| A24= | 2.807120124E−06 | 7.791478492E−05 | 1.476119067E−04 | −1.733318460E−04 |
| A26= | −1.867923587E−07 | −6.858747273E−06 | −1.374442702E−05 | 1.801849592E−05 |
| A28= | 7.485090824E−09 | 3.607491912E−07 | 7.520864699E−07 | −1.137288830E−06 |
| A30= | −1.364465830E−10 | −8.537256074E−09 | −1.824206526E−08 | 3.285593300E−08 |

| Surface # | 12 | 13 |
|---|---|---|
| k= | −9.900000000E+01 | −7.178850000E+00 |
| A4= | 7.016251433E−04 | 4.599275711E−03 |
| A6= | 2.528955201E−02 | 2.690813612E−02 |
| A8= | −5.655804843E−02 | −7.002819995E−02 |
| A10= | 7.843657972E−02 | 1.172324890E−01 |
| A12= | −7.321378984E−02 | −1.378919990E−01 |
| A14= | 4.525895807E−02 | 1.154946967E−01 |
| A16= | −1.698876599E−02 | −6.926760811E−02 |
| A18= | 2.408556691E−03 | 2.971174815E−02 |
| A20= | 1.056975931E−03 | −9.021125335E−03 |
| A22= | −7.197545288E−04 | 1.891173303E−03 |
| A24= | 2.030486657E−04 | −2.602463426E−04 |
| A26= | −3.230467876E−05 | 2.115054348E−05 |
| A28= | 2.828235857E−06 | −7.693559602E−07 |
| A30= | −1.065308331E−07 | — |

In the 7th embodiment, the equation of the aspheric surface profiles of the aforementioned lens elements is the same as the equation of the 1st embodiment. Also, the definitions of these parameters shown in Table 7D below are the same as those stated in the 1st embodiment, with corresponding values for the 7th embodiment; therefore, an explanation in this regard will not be provided again.

Moreover, these parameters can be calculated from Table 7A to Table 70 as the following values and satisfy the following conditions:

TABLE 7D
Values of Optical and Physical Parameters/Definitions

| | | | |
|---|---|---|---|
| fL [mm] | 13.79 | fL/R5 | −6.55 |
| FnoL | 2.35 | \|f3/f2\| | 0.18 |
| HFOVL [deg.] | 13.2 | \|R3/fL\| + \|R4/fL\| | 0.62 |
| FOVL [deg.] | 26.4 | (R1 − R4)/(R1 + R4) | 0.20 |
| fS [mm] | 12.64 | (R1 − R5)/(R1 + R5) | 1.90 |
| FnoS | 2.63 | CT1/CT2 | 1.39 |
| HFOVS [deg.] | 11.7 | CT1/Dr3r8L | 0.36 |
| FOVS [deg.] | 23.4 | T23L/CT4 | 1.75 |
| TLS/TLL | 1.040 | 10 × T45L/fL | 0.49 |
| fL/fG1 | 1.62 | CT5/T45L | 0.36 |
| \|TDS − TDL\| [mm] | 0.75 | N1 | 1.545 |
| 10 × \|TDS − TDL\|/TDL | 1.60 | V5 | 23.5 |
| DG2/DG1 | 0.06 | V5/N5 | 14.34 |
| TLL/fL | 1.36 | ET12L/CT2 | 1.22 |
| BLL/TDL | 2.99 | Sag2R1L/CT2 | 0.90 |
| SDL/TDL | 0.90 | Y1R1L/Y5R2L | 1.56 |
| fL/f3 | −1.99 | Y1R1L/ImgH | 0.89 |
| T34L/CT2 | 0.04 | — | — |

### 8th Embodiment

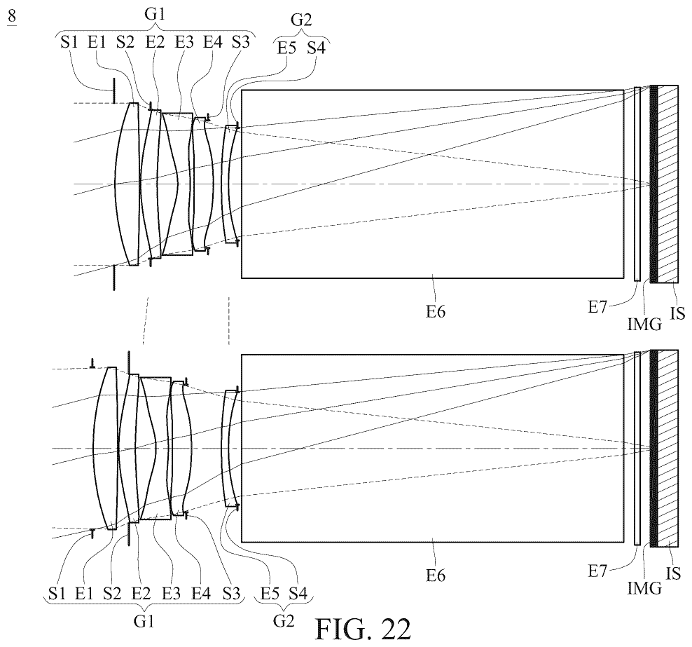

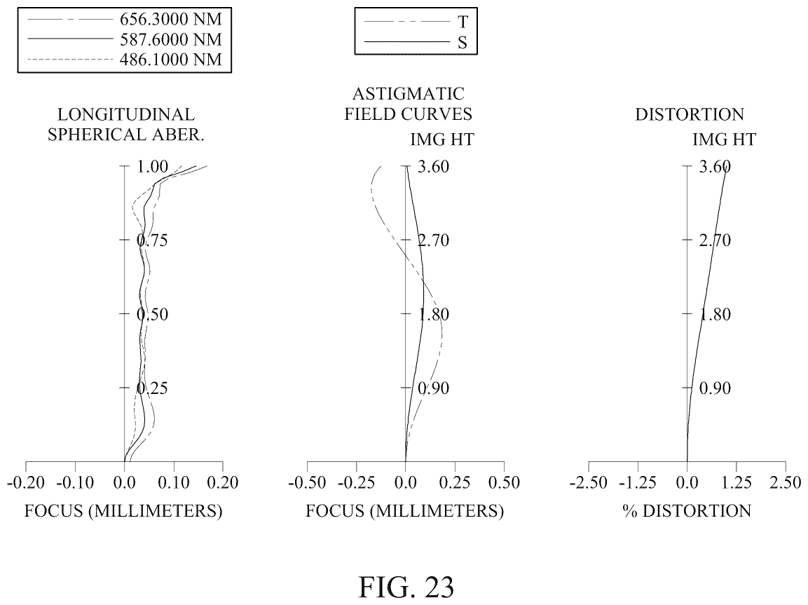

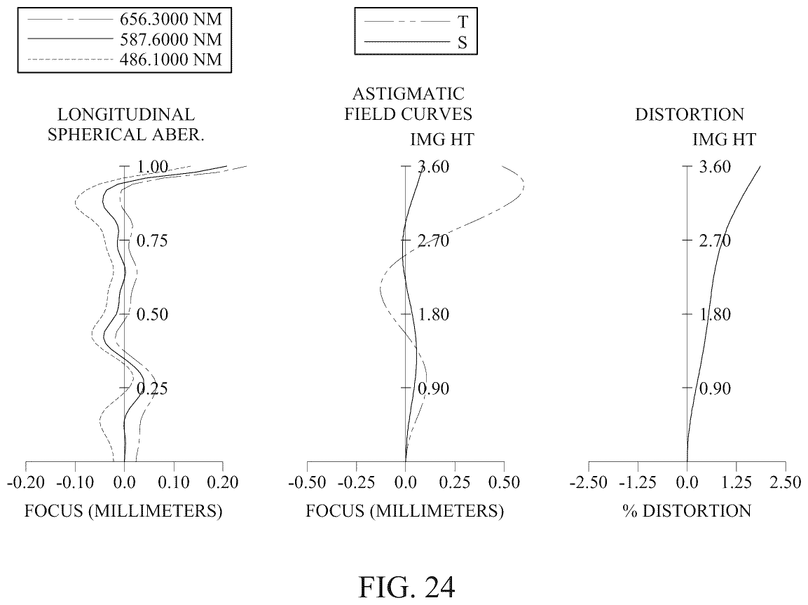

FIG. 22 shows schematic views of an image capturing unit respectively in a first state and a second state according to the 8th embodiment of the present disclosure. FIG. 23 shows, in order from left to right, spherical aberration curves, astigmatic field curves and a distortion curve of the image capturing unit in the first state according to the 8th embodiment. FIG. 24 shows, in order from left to right, spherical aberration curves, astigmatic field curves and a distortion curve of the image capturing unit in the second state according to the 8th embodiment. Moreover, the upper part of FIG. 22 shows the schematic view of the imaging optical lens system in the first state, and the lower part of FIG. 22 shows the schematic view of the imaging optical lens system in the second state. In FIG. 22, the image capturing unit 8 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 22. When an imaged object is located at a finite object distance, the imaging optical lens system is in the second state as shown in the lower part of FIG. 22. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 22, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being concave in a paraxial region thereof. The second lens element E2 is made of glass material and has the object-side surface and the image-side surface being both aspheric. The object-side surface of the second lens element E2 has one inflection point. The image-side surface of the second lens element E2 has two inflection points. The image-side surface of the second lens element E2 has one critical point in an off-axis region thereof.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has three inflection points. The image-side surface of the third lens element E3 has five inflection points. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has six inflection points. The image-side surface of the fourth lens element E4 has one inflection point. The object-side surface of the fourth lens element E4 has two critical points in an off-axis region thereof. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 22 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface IMG of the imaging optical lens system.

The detailed optical data of the 8th embodiment are shown in Table 8A and Table 8B, and the aspheric surface data are shown in Table 8C below.

TABLE 8A
8th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | 0.030 | | | | |
| 2 | Lens 1 | 8.4485 | (SPH) | 0.903 | Glass | 1.954 | 32.3 | 8.06 |
| 3 | | −80.8583 | (SPH) | 0.410 | | | | |
| 4 | Stop | Plano | | −0.370 | | | | |
| 5 | Lens 2 | 5.9705 | (ASP) | 0.607 | Glass | 1.497 | 81.6 | 29.41 |
| 6 | | 9.7514 | (ASP) | 0.758 | | | | |
| 7 | Lens 3 | −2.2716 | (ASP) | 0.456 | Plastic | 1.614 | 26.0 | −5.80 |
| 8 | | −6.7570 | (ASP) | 0.138 | | | | |
| 9 | Lens 4 | 12.5536 | (ASP) | 0.712 | Plastic | 1.544 | 56.0 | 9.56 |
| 10 | | −8.7090 | (ASP) | −0.198 | | | | |
| 11 | Stop | Plano | | D1 | | | | |
| 12 | Lens 5 | 21.5221 | (ASP) | 0.260 | Plastic | 1.639 | 23.5 | −22.01 |
| 13 | | 8.4624 | (ASP) | 0.328 | | | | |

| | | | | | | | |
|---|---|---|---|---|---|---|---|
| 14 | Stop | Plano | 0.150 | | | | |
| 15 | Prism | Plano | 14.032 | Glass | 1.835 | 42.7 | — |
| 16 | | Plano | 0.400 | | | | |
| 17 | Filter | Plano | 0.210 | Plastic | 1.517 | 64.2 | — |
| 18 | | Plano | 0.377 | | | | |
| 19 | Image | Plano | — | | | | |

Note:
Reference wavelength is 587.6 nm (d-line).
An effective radius of the stop S1 (Surface 1) is 2.980 mm.
An effective radius of the stop S2 (Surface 4) is 2.732 mm.
An effective radius of the stop S3 (Surface 11) is 2.343 mm.
An effective radius of the stop S4 (Surface 14) is 2.066 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 4 as the imaging optical lens system is in the second state (corresponding to finite object distance).

In this embodiment, the imaging optical lens system is transitioned to the second state to capture an imaged object at a finite object distance of 119.230 mm as an example, but the present disclosure is not limited to this distance.

TABLE 8B
Values of Optical And Physical Parameters/Definitions

| First State (Infinite | | Second State (Finite | |
|---|---|---|---|
| Object Distance) | | Object Distance) | |
| fL [mm] | 13.45 | fS [mm] | 12.80 |
| FnoL | 2.26 | FnoS | 2.48 |
| HFOVL [deg.] | 14.8 | HFOVS [deg.] | 13.5 |
| Object Distance [mm] | ∞ | Object Distance [mm] | 119.230 |
| D0 [mm] | ∞ | D0 [mm] | 119.200 |
| D1 [mm] | 0.498 | D1 [mm] | 1.298 |

The definitions of the parameters shown in Table 8B are the same as those stated in the 1st embodiment, with corresponding values for the 8th embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 8B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 119.230 mm, the imaging optical lens system is transitioned from the first state to the second state, the axial distance D1 between the movable lens group G1 and the last lens group G2 increases from 0.498 mm in the first state to 1.298 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 8C
Aspheric Coefficients

| Surface # | 5 | 6 | 7 | 8 |
|---|---|---|---|---|
| k= | 1.470450000E+00 | 7.512100000E+00 | −6.060350000E−01 | −9.903660000E−01 |
| A4= | −6.511187892E−03 | −2.018773073E−02 | 6.521566542E−03 | −1.367445581E−01 |
| A6= | −4.568732022E−03 | −5.172713979E−03 | 1.563839065E−01 | 6.645200233E−01 |
| A8= | 4.809137744E−03 | 1.939356777E−02 | −2.683570684E−01 | −1.289625443E+00 |
| A10= | −8.049055746E−04 | −1.725790307E−02 | 2.769180356E−01 | 1.507500873E+00 |
| A12= | −1.545584158E−03 | 8.129138576E−03 | −1.925283269E−01 | −1.168408951E+00 |
| A14= | 1.299589796E−03 | −1.958191764E−03 | 9.436837368E−02 | 6.330743105E−01 |
| A16= | −4.972590599E−04 | 6.772552728E−05 | −3.344661157E−02 | −2.469874641E−01 |
| A18= | 1.078273939E−04 | 1.035863335E−04 | 8.666686428E−03 | 7.035414141E−02 |
| A20= | −1.268118179E−05 | −3.441290427E−05 | −1.640722392E−03 | −1.465627490E−02 |
| A22= | 4.006617662E−07 | 5.827725652E−06 | 2.241533185E−04 | 2.209401718E−03 |
| A24= | 9.894314799E−08 | −6.122879509E−07 | −2.149882066E−05 | −2.346947506E−04 |
| A26= | −1.498992259E−08 | 4.105071587E−08 | 1.372761015E−06 | 1.666385312E−05 |
| A28= | 8.825408307E−10 | −1.652601769E−09 | −5.239765654E−08 | −7.098567141E−07 |
| A30= | −2.007383079E−11 | 3.106838827E−11 | 9.047004081E−10 | 1.371817899E−08 |
| Surface # | 9 | 10 | 12 | 13 |
| k= | 3.850530000E+00 | −3.829680000E+01 | −7.920820000E+01 | 5.846360000E+00 |
| A4= | −2.050500202E−01 | −5.718488607E−02 | −1.703113894E−02 | −2.741979692E−03 |
| A6= | 7.417977234E−01 | 1.968110808E−01 | 1.366256587E−01 | 6.237699660E−02 |
| A8= | −1.515141644E+00 | −4.367984013E−01 | −3.616562686E−01 | −1.908819713E−01 |
| A10= | 1.846227862E+00 | 5.633714475E−01 | 5.789172999E−01 | 3.563932259E−01 |
| A12= | −1.476924723E+00 | −4.716669356E−01 | −6.213579379E−01 | −4.483476022E−01 |
| A14= | 8.210148094E−01 | 2.729193003E−01 | 4.684887375E−01 | 3.935864486E−01 |
| A16= | −3.270491050E−01 | −1.127364309E−01 | −2.543594364E−01 | −2.463043345E−01 |
| A18= | 9.471388974E−02 | 3.373715358E−02 | 1.005615885E−01 | 1.111231619E−01 |
| A20= | −1.998223713E−02 | −7.326023619E−03 | −2.895062023E−02 | −3.619107832E−02 |
| A22= | 3.039622957E−03 | 1.141639726E−03 | 5.998682113E−03 | 8.422768469E−03 |
| A24= | −3.246935320E−04 | −1.242386154E−04 | −8.705609229E−04 | −1.365070645E−03 |
| A26= | 2.310532656E−05 | 8.949838145E−06 | 8.391158426E−05 | 1.462734057E−04 |
| A28= | −9.831915932E−07 | −3.828434010E−07 | −4.821750837E−06 | −9.311150697E−06 |
| A30= | 1.891800791E−08 | 7.349745619E−09 | 1.249269092E−07 | 2.665229599E−07 |

In the 8th embodiment, the equation of the aspheric surface profiles of the aforementioned lens elements is the same as the equation of the 1st embodiment. Also, the definitions of these parameters shown in Table 8D below are the same as those stated in the 1st embodiment, with corresponding values for the 8th embodiment; therefore, an explanation in this regard will not be provided again.

Moreover, these parameters can be calculated from Table 8A to Table 80 as the following values and satisfy the following conditions:

TABLE 8D
Values of Optical and Physical Parameters/Definitions

| | | | |
|---|---|---|---|
| fL [mm] | 13.45 | fL/R5 | −5.92 |
| FnoL | 2.26 | \|f3/f2\| | 0.20 |
| HFOVL [deg.] | 14.8 | \|R3/fL\| + \|R4/fL\| | 1.17 |
| FOVL [deg.] | 29.6 | (R1 − R4)/(R1 + R4) | −0.07 |
| fS [mm] | 12.80 | (R1 − R5)/(R1 + R5) | 1.74 |
| FnoS | 2.48 | CT1/CT2 | 1.49 |
| HFOVS [deg.] | 13.5 | CT1/Dr3r8L | 0.34 |
| FOVS [deg.] | 27.0 | T23L/CT4 | 1.06 |
| TLS/TLL | 1.041 | 10 × T45L/fL | 0.22 |
| fL/fG1 | 1.40 | CT5/T45L | 0.87 |
| \|TDS − TDL\| [mm] | 0.80 | N1 | 1.954 |
| 10 × \|TDS − TDL\|/TDL | 1.92 | V5 | 23.5 |
| DG2/DG1 | 0.07 | V5/N5 | 14.34 |
| TLL/fL | 1.46 | ET12L/CT2 | 0.81 |
| BLL/TDL | 3.71 | Sag2R1L/CT2 | 0.66 |
| SDL/TDL | 1.01 | Y1R1L/Y5R2L | 1.44 |
| fL/f3 | −2.32 | Y1R1L/ImgH | 0.83 |
| T34L/CT2 | 0.23 | — | — |

### 9th Embodiment

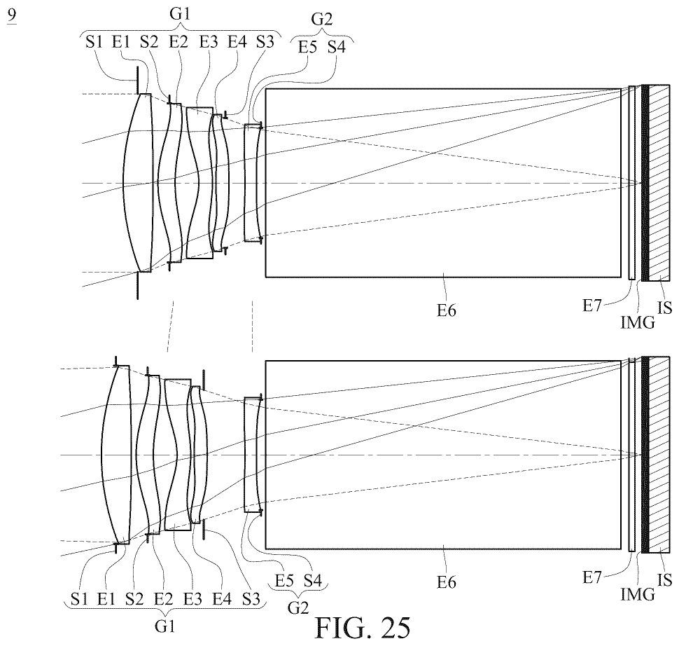

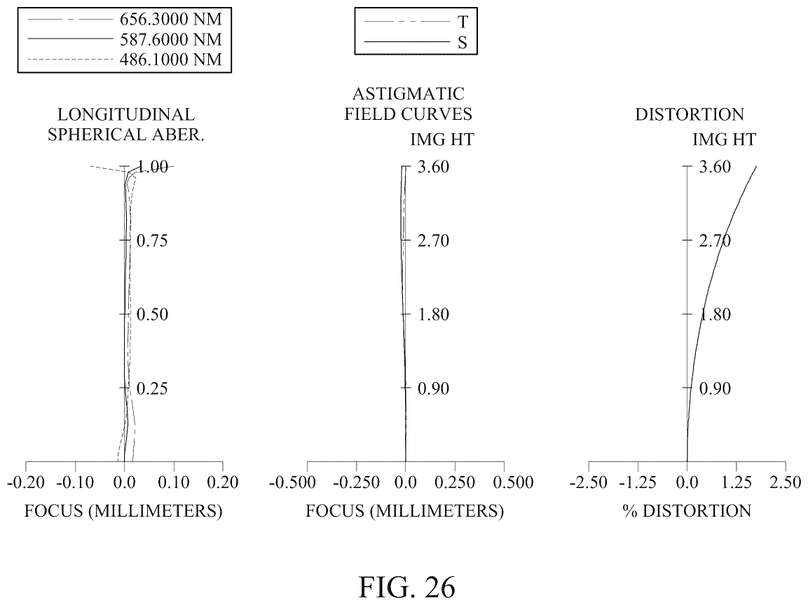

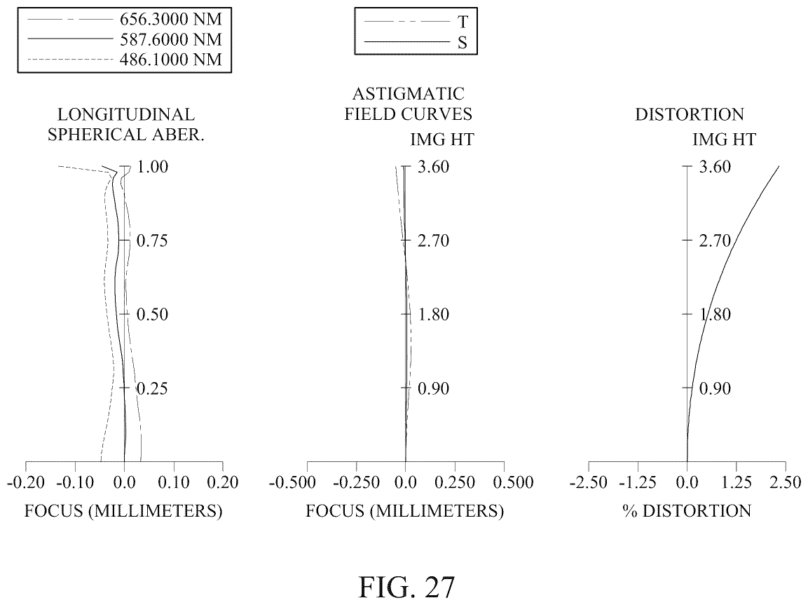

FIG. 25 shows schematic views of an image capturing unit respectively in a first state and a second state according to the 9th embodiment of the present disclosure. FIG. 26 shows, in order from left to right, spherical aberration curves, astigmatic field curves and a distortion curve of the image capturing unit in the first state according to the 9th embodiment. FIG. 27 shows, in order from left to right, spherical aberration curves, astigmatic field curves and a distortion curve of the image capturing unit in the second state according to the 9th embodiment. Moreover, the upper part of FIG. 25 shows the schematic view of the imaging optical lens system in the first state, and the lower part of FIG. 25 shows the schematic view of the imaging optical lens system in the second state. In FIG. 25, the image capturing unit 9 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 25. When an imaged object is located at a finite object distance, the imaging optical lens system is in the second state as shown in the lower part of FIG. 25. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 25, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The image-side surface of the first lens element E1 has one inflection point. The image-side surface of the first lens element E1 has one critical point in an off-axis region thereof.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has two inflection points. The object-side surface of the second lens element E2 has one critical point in an off-axis region thereof. The image-side surface of the second lens element E2 has one critical point in an off-axis region thereof.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has one inflection point. The object-side surface of the fourth lens element E4 has two critical points in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The object-side surface of the fifth lens element E5 has one critical point in an off-axis region thereof.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 25 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface IMG of the imaging optical lens system.

The detailed optical data of the 9th embodiment are shown in Table 9A and Table 9B, and the aspheric surface data are shown in Table 90 below.

TABLE 9A
9th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | −0.535 | | | | |
| 2 | Lens 1 | 8.7650 | (ASP) | 1.096 | Glass | 1.883 | 39.2 | 8.79 |
| 3 | | −64.1356 | (ASP) | 0.603 | | | | |
| 4 | Stop | Plano | | −0.421 | | | | |
| 5 | Lens 2 | 4.3840 | (ASP) | 0.629 | Plastic | 1.544 | 56.0 | 43.67 |
| 6 | | 5.1042 | (ASP) | 0.872 | | | | |
| 7 | Lens 3 | −2.2999 | (ASP) | 0.502 | Plastic | 1.639 | 23.5 | −8.20 |
| 8 | | −4.4518 | (ASP) | 0.125 | | | | |
| 9 | Lens 4 | 8.8083 | (ASP) | 0.478 | Plastic | 1.566 | 37.4 | 12.24 |
| 10 | | −31.8195 | (ASP) | −0.128 | | | | |
| 11 | Stop | Plano | | D1 | | | | |
| 12 | Lens 5 | −14.9276 | (ASP) | 0.422 | Plastic | 1.669 | 19.5 | −19.88 |
| 13 | | 123.4659 | (ASP) | 0.164 | | | | |

| | | | | | | | |
|---|---|---|---|---|---|---|---|
| 14 | Stop | Plano | 0.179 | | | | |
| 15 | Prism | Plano | 13.050 | Glass | 1.835 | 42.7 | — |
| 16 | | Plano | 0.300 | | | | |
| 17 | Filter | Plano | 0.210 | Plastic | 1.517 | 64.2 | — |
| 18 | | Plano | 0.258 | | | | |
| 19 | Image | Plano | — | | | | |

Note:
Reference wavelength is 587.6 nm (d-line).
An effective radius of the stop S1 (Surface 1) is 3.272 mm.
An effective radius of the stop S2 (Surface 4) is 2.921 mm.
An effective radius of the stop S3 (Surface 11) is 2.385 mm.
An effective radius of the stop S4 (Surface 14) is 2.027 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 11 as the imaging optical lens system is in the second state (corresponding to finite object distance).

In this embodiment, the imaging optical lens system is transitioned to the second state to capture an imaged object at a finite object distance of 118.665 mm as an example, but the present disclosure is not limited to this distance.

TABLE 9B
Values of Optical And Physical Parameters/Definitions

| First State (Infinite | | Second State (Finite | |
|---|---|---|---|
| Object Distance) | | Object Distance) | |
| fL [mm] | 13.43 | fS [mm] | 12.71 |
| FnoL | 2.05 | FnoS | 2.29 |
| HFOVL [deg.] | 14.7 | HFOVS [deg.] | 13.1 |
| Object Distance [mm] | ∞ | Object Distance [mm] | 118.665 |
| D0 [mm] | ∞ | D0 [mm] | 119.200 |
| D1 [mm] | 0.720 | D1 [mm] | 1.520 |

The definitions of the parameters shown in Table 9B are the same as those stated in the 1st embodiment, with corresponding values for the 9th embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 9B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 118.665 mm, the imaging optical lens system is transitioned from the first state to the second state, the axial distance D1 between the movable lens group G1 and the last lens group G2 increases from 0.720 mm in the first state to 1.520 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 9C
Aspheric Coefficients

| Surface # | 2 | 3 | 5 | 6 |
|---|---|---|---|---|
| k= | −1.352640000E−02 | −6.949330000E+01 | 1.701890000E−02 | 1.124840000E−02 |
| A4= | 1.151633365E−03 | 3.849587079E−03 | −3.307488865E−03 | −1.539937690E−02 |
| A6= | −3.881562281E−04 | −3.579998299E−03 | −1.788225343E−03 | 5.118655055E−03 |
| A8= | 4.550075071E−05 | 1.630895200E−03 | −2.686545860E−03 | −6.215266474E−03 |
| A10= | 1.037645427E−05 | −4.385625921E−04 | 4.121548750E−03 | 5.960146193E−03 |
| A12= | −4.876070995E−06 | 7.235187289E−05 | −2.818077764E−03 | −3.897068063E−03 |
| A14= | 7.548463499E−07 | −7.465569339E−06 | 1.234670852E−03 | 1.823111163E−03 |
| A16= | −5.732364084E−08 | 4.754586371E−07 | −3.760249267E−04 | −6.207341660E−04 |
| A18= | 2.158856353E−09 | −1.725062544E−08 | 8.033422361E−05 | 1.520270679E−04 |
| A20= | −3.184553696E−11 | 2.747956099E−10 | −1.186117918E−05 | −2.628240075E−05 |
| A22= | — | — | 1.172517145E−06 | 3.135223417E−06 |
| A24= | — | — | −7.277057055E−08 | −2.492552838E−07 |
| A26= | — | — | 2.426175263E−09 | 1.240296661E−08 |
| A28= | — | — | −2.167846969E−11 | −3.400663608E−10 |
| A30= | — | — | −6.077950262E−13 | 3.708006754E−12 |

| Surface # | 7 | 8 | 9 | 10 |
|---|---|---|---|---|
| k= | −6.440900000E−01 | 2.725900000E−02 | −1.929050000E+00 | 9.900000000E+01 |
| A4= | 6.121597598E−02 | 5.201867947E−02 | −1.210079426E−02 | −1.171669913E−02 |
| A6= | −1.759384282E−02 | −3.663176913E−02 | −3.185624169E−02 | 8.968394131E−04 |
| A8= | 7.937780647E−03 | 3.084577474E−02 | 2.971021889E−02 | −1.209134256E−02 |
| A10= | −4.820034313E−03 | −1.828385374E−02 | −1.972616110E−02 | 1.617558355E−02 |
| A12= | 2.984193340E−03 | 5.131876026E−03 | 1.004315556E−02 | −1.154916747E−02 |
| A14= | −1.464980635E−03 | 1.745858784E−03 | −3.440526880E−03 | 5.369335864E−03 |
| A16= | 5.377297516E−04 | −2.573797755E−03 | 6.085935467E−04 | −1.659527818E−03 |
| A18= | −1.476285587E−04 | 1.346599897E−03 | 5.911971613E−05 | 3.222730355E−04 |
| A20= | 3.026640492E−05 | −4.291262697E−04 | −7.153827581E−05 | −2.984599265E−05 |
| A22= | −4.558607988E−06 | 9.080473824E−05 | 2.211193701E−05 | −2.091870516E−06 |
| A24= | 4.873720631E−07 | −1.285773860E−05 | −3.875540885E−06 | 1.036920041E−06 |
| A26= | −3.482765457E−08 | 1.173987745E−06 | 4.100874565E−07 | −1.408648893E−07 |
| A28= | 1.485185922E−09 | −6.256350943E−08 | −2.442397207E−08 | 9.343689989E−09 |
| A30= | −2.848997344E−11 | 1.478642738E−09 | 6.295206363E−10 | −2.565601849E−10 |

| Surface # | 12 | 13 |
|---|---|---|
| k= | −4.184770000E+01 | 9.900000000E+01 |
| A4= | 6.773424278E−03 | 9.949760211E−03 |
| A6= | 7.065606659E−03 | 1.552603903E−03 |
| A8= | −1.253934535E−02 | 5.691938584E−04 |
| A10= | 1.119534828E−02 | −8.221767211E−03 |
| A12= | −4.953685729E−03 | 1.500024178E−02 |
| A14= | −4.474275357E−04 | −1.535507371E−02 |
| A16= | 2.092541393E−03 | 1.033124511E−02 |
| A18= | −1.435908202E−03 | −4.813437848E−03 |
| A20= | 5.618288687E−04 | 1.581608485E−03 |
| A22= | −1.429759005E−04 | −3.658180186E−04 |
| A24= | 2.415308904E−05 | 5.829406843E−05 |
| A26= | −2.625109025E−06 | −6.090327695E−06 |
| A28= | 1.667266566E−07 | 3.752647151E−07 |
| A30= | −4.713591401E−09 | −1.032726463E−08 |

In the 9th embodiment, the equation of the aspheric surface profiles of the aforementioned lens elements is the same as the equation of the 1st embodiment. Also, the definitions of these parameters shown in Table 9D below are the same as those stated in the 1st embodiment, with corresponding values for the 9th embodiment; therefore, an explanation in this regard will not be provided again.

Moreover, these parameters can be calculated from Table 9A to Table 90 as the following values and satisfy the following conditions:

TABLE 9D
Values of Optical and Physical Parameters/Definitions

| | | | |
|---|---|---|---|
| fL [mm] | 13.43 | fL/R5 | −5.84 |
| FnoL | 2.05 | \|f3/f2\| | 0.19 |
| HFOVL [deg.] | 14.7 | \|R3/fL\| + \|R4/fL\| | 0.71 |
| FOVL [deg.] | 29.4 | (R1 − R4)/(R1 + R4) | 0.26 |
| fS [mm] | 12.71 | (R1 − R5)/(R1 + R5) | 1.71 |
| FnoS | 2.29 | CT1/CT2 | 1.74 |
| HFOVS [deg.] | 13.1 | CT1/Dr3r8L | 0.42 |
| FOVS [deg.] | 26.2 | T23L/CT4 | 1.82 |
| TLS/TLL | 1.042 | 10 × T45L/fL | 0.44 |
| fL/fG1 | 1.42 | CT5/T45L | 0.71 |
| \|TDS − TDL\| [mm] | 0.80 | N1 | 1.883 |
| 10 × \|TDS − TDL\|/TDL | 1.63 | V5 | 19.5 |
| DG2/DG1 | 0.11 | V5/N5 | 11.68 |
| TLL/fL | 1.42 | ET12L/CT2 | 1.12 |
| BLL/TDL | 2.89 | Sag2R1L/CT2 | 0.71 |
| SDL/TDL | 0.89 | Y1R1L/Y5R2L | 1.61 |
| fL/f3 | −1.64 | Y1R1L/ImgH | 0.91 |
| T34L/CT2 | 0.20 | — | — |

### 10th Embodiment

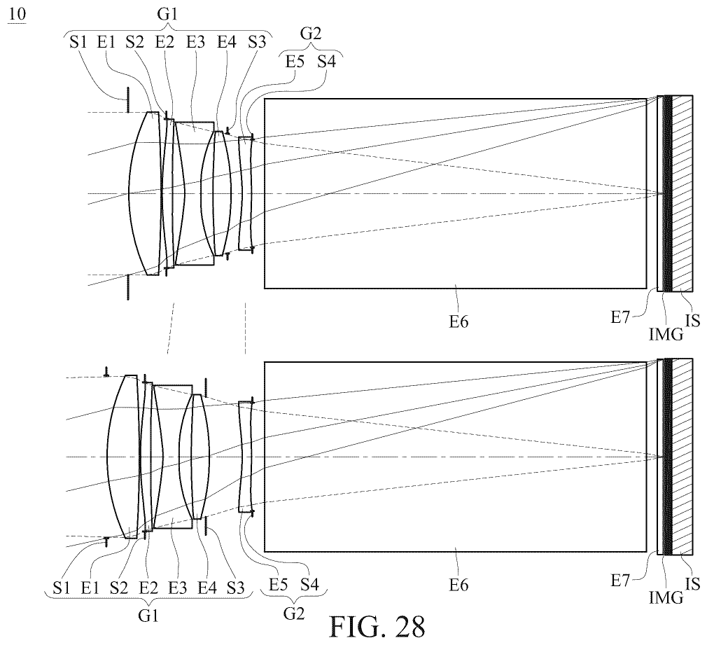

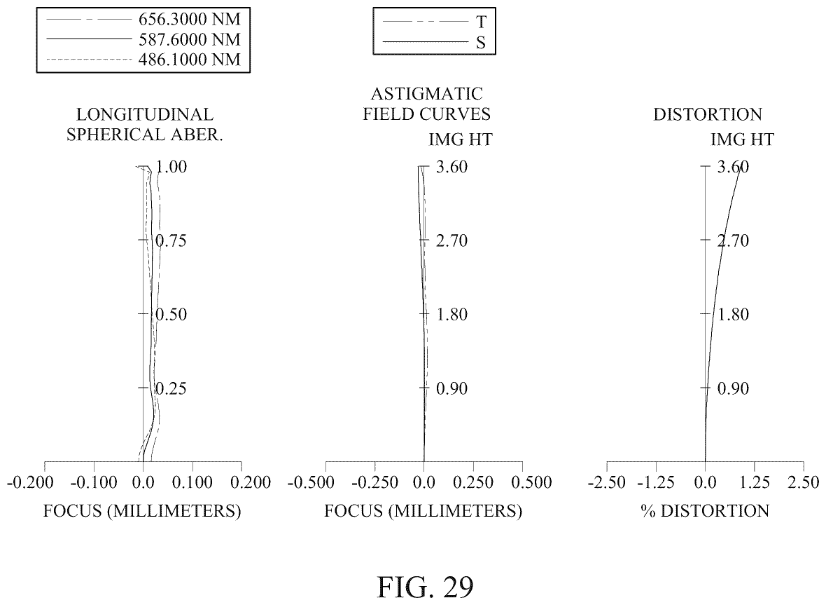

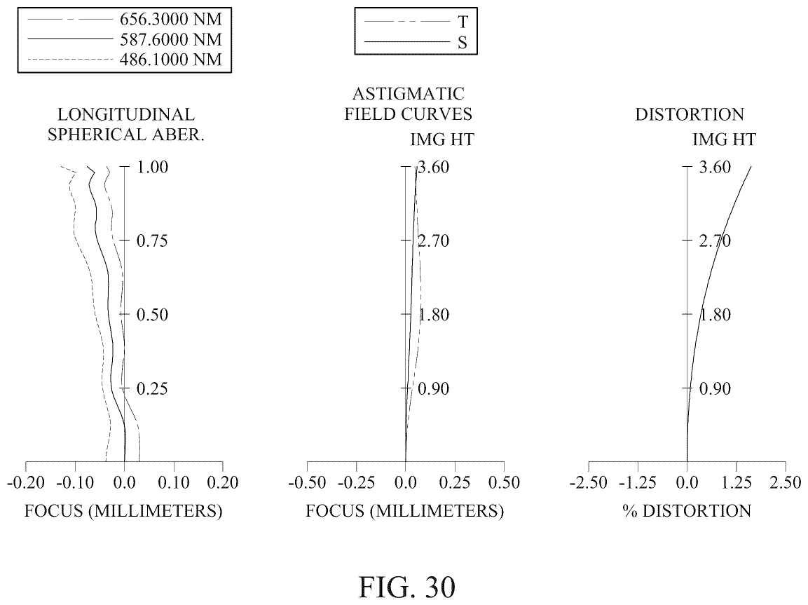

FIG. 28 shows schematic views of an image capturing unit respectively in a first state and a second state according to the 10th embodiment of the present disclosure. FIG. 29 shows, in order from left to right, spherical aberration curves, astigmatic field curves and a distortion curve of the image capturing unit in the first state according to the 10th embodiment. FIG. 30 shows, in order from left to right, spherical aberration curves, astigmatic field curves and a distortion curve of the image capturing unit in the second state according to the 10th embodiment. Moreover, the upper part of FIG. 28 shows the schematic view of the imaging optical lens system in the first state, and the lower part of FIG. 28 shows the schematic view of the imaging optical lens system in the second state. In FIG. 28, the image capturing unit 10 includes the imaging optical lens system (its reference numeral is omitted) of the present disclosure and an image sensor IS. The imaging optical lens system includes, in order from an object side to an image side along a traveling direction of an optical path, a stop S1, a first lens element E1, a stop S2, a second lens element E2, a third lens element E3, a fourth lens element E4, a stop S3, a fifth lens element E5, a stop S4, a reflective element E6, a filter E7 and an image surface IMG. Furthermore, the imaging optical lens system has a movable lens group G1 and a last lens group G2 in order from the object side to the image side along the traveling direction of the optical path. The movable lens group G1 includes the stop S1, the first lens element E1, the stop S2, the second lens element E2, the third lens element E3, the fourth lens element E4 and the stop S3, and the last lens group G2 includes the fifth lens element E5 and the stop S4. The imaging optical lens system includes five lens elements (E1, E2, E3, E4 and E5) with no additional lens element disposed between each of the adjacent five lens elements. Additionally, there is no additional lens element located between the last lens group G2 and the reflective element E6 along the optical axis.

A focal length of the imaging optical lens system is variable by change of an axial distance between the two lens groups (G1 and G2) in a focus adjustment process. When an imaged object is located at an infinite object distance, the imaging optical lens system is in the first state as shown in the upper part of FIG. 28. When an imaged object is located at a finite object distance, the imaging optical lens system is in the second state as shown in the lower part of FIG. 28. In specific, when an imaged object is moved from an infinite object distance to a finite object distance, the imaging optical lens system can undergo the focus adjustment process to transition from the first state to the second state. Conversely, when an imaged object is moved from a finite object distance to an infinite object distance, the imaging optical lens system can also undergo the focus adjustment process to transition from the second state to the first state. The imaging optical lens system being in the first state refers to a state where an imaged object is at an infinite object distance; the imaging optical lens system being in the second state refers to a state where an imaged object is at a finite object distance. As shown in FIG. 28, the movable lens group G1 is moved along the optical axis relative to the last lens group G2 in the focus adjustment process. Moreover, the movable lens group G1 is moved toward the object side along the optical axis relative to the last lens group G2 when the imaging optical lens system transitions from the first state to the second state in the focus adjustment process. It should be noted that all elements (e.g., the lens element, stop, and/or aperture stop) in the movable lens group G1 are immovable relative to one another during the focus adjustment process, and all elements (e.g., the lens element, stop, and/or aperture stop) in the last lens group G2 are immovable relative to one another during the focus adjustment process. In addition, during the focus adjustment process, the last lens group G2 is immovable relative to the reflective element E6.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric. The object-side surface of the second lens element E2 has one inflection point. The image-side surface of the second lens element E2 has five inflection points. The object-side surface of the second lens element E2 has one critical point in an off-axis region thereof. The image-side surface of the second lens element E2 has one critical point in an off-axis region thereof.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has three inflection points.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has four inflection points. The object-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The reflective element E6 is made of glass material and located between the fifth lens element E5 and the image surface IMG along the optical path, and will not affect the focal length of the imaging optical lens system. The reflective element E6 is a prism with optical path folding function. For simplicity in illustration, FIG. 28 does not show the folding effect caused by the reflective element E6 on the optical path. However, the reflective element E6 can have various configurations depending on the actual design requirements, thereby creating different folding effects on the optical path. Moreover, the reflective element E6 of this embodiment can have a configuration similar to, for example, one of the configurations shown in FIG. 53 to FIG. 58, which can be referred to foregoing descriptions corresponding to FIG. 53 to FIG. 58, and the details in this regard will not be provided again. Furthermore, the reflective element E6 of this embodiment can also have a configuration similar to, for example, the configuration shown in FIG. 50, deflecting the optical path five times, which can be referred to foregoing descriptions corresponding to FIG. 50, and the details in this regard will not be provided again.

The filter E7 is made of plastic material and located between the reflective element E6 and the image surface IMG, and will not affect the focal length of the imaging optical lens system. The image sensor IS is disposed on or near the image surface IMG of the imaging optical lens system.

The detailed optical data of the 10th embodiment are shown in Table 10A and Table 10B, and the aspheric surface data are shown in Table 10C below.

TABLE 10A
10th Embodiment

| Surface # | | Curvature Radius | | Thickness | Material | Index | Abbe # | Focal Length |
|---|---|---|---|---|---|---|---|---|
| 0 | Object | Plano | | D0 | | | | |
| 1 | Stop | Plano | | 0.030 | | | | |
| 2 | Lens 1 | 6.9856 | (SPH) | 1.186 | Glass | 1.954 | 32.3 | 6.43 |
| 3 | | −45.8663 | (SPH) | 0.197 | | | | |
| 4 | Stop | Plano | | −0.157 | | | | |
| 5 | Lens 2 | 13.9263 | (ASP) | 0.381 | Plastic | 1.551 | 44.8 | 15.80 |
| 6 | | −22.9539 | (ASP) | 0.446 | | | | |
| 7 | Lens 3 | −3.1529 | (ASP) | 0.590 | Plastic | 1.614 | 25.6 | −4.88 |
| 8 | | 64.1808 | (ASP) | 0.450 | | | | |
| 9 | Lens 4 | −1523.7966 | (ASP) | 0.664 | Plastic | 1.544 | 56.0 | 14.33 |
| 10 | | −7.7556 | (ASP) | −0.133 | | | | |
| 11 | Stop | Plano | | D1 | | | | |
| 12 | Lens 5 | −6.9592 | (ASP) | 0.343 | Plastic | 1.656 | 21.3 | −22.62 |
| 13 | | −13.3615 | (ASP) | 0.032 | | | | |

| | | | | | | | |
|---|---|---|---|---|---|---|---|
| 14 | Stop | Plano | 0.446 | | | | |
| 15 | Prism | Plano | 14.032 | Glass | 1.835 | 42.7 | — |
| 16 | | Plano | 0.400 | | | | |
| 17 | Filter | Plano | 0.210 | Plastic | 1.517 | 64.2 | — |
| 18 | | Plano | 0.067 | | | | |
| 19 | Image | Plano | — | | | | |

Note:
Reference wavelength is 587.6 nm (d-line).
An effective radius of the stop S1 (Surface 1) is 2.989 mm.
An effective radius of the stop S2 (Surface 4) is 2.738 mm.
An effective radius of the stop S3 (Surface 11) is 2.204 mm.
An effective radius of the stop S4 (Surface 14) is 1.987 mm.
The imaging optical lens system can further include an aperture stop, and the position of the aperture stop can be adjusted depending on the object distance.
In this embodiment, the position of the aperture stop is at Surface 1 as the imaging optical lens system is in the first state (corresponding to infinite object distance).
In this embodiment, the position of the aperture stop is at Surface 11 as the imaging optical lens system is in the second state (corresponding to finite object distance).

In this embodiment, the imaging optical lens system is transitioned to the second state to capture an imaged object at a finite object distance of 119.233 mm as an example, but the present disclosure is not limited to this distance.

TABLE 10B
Values of Optical And Physical Parameters/Definitions

| First State (Infinite | | Second State (Finite | |
|---|---|---|---|
| Object Distance) | | Object Distance) | |
| fL [mm] | 13.49 | fS [mm] | 12.85 |
| FnoL | 2.26 | FnoS | 2.50 |
| HFOVL [deg.] | 14.8 | HFOVS [deg.] | 13.2 |
| Object Distance [mm] | ∞ | Object Distance [mm] | 119.233 |
| D0 [mm] | ∞ | D0 [mm] | 119.203 |
| D1 [mm] | 0.540 | D1 [mm] | 1.337 |

The definitions of the parameters shown in Table 10B are the same as those stated in the 1st embodiment, with corresponding values for the 10th embodiment; therefore, no further explanation will be provided. It should be understood that, in this embodiment, only two moving focus states (i.e., the first state and the second state) are disclosed, but the present disclosure is not limited thereto. Besides the first state and the second state, the imaging optical lens system in this embodiment can also have other moving focus states with different focal lengths between the first state and the second state to accommodate focusing conditions for other object distances.

As seen in Table 10B, the imaging optical lens system can undergo the focus adjustment process for focus adjustment according to the change of object distance, and the movable lens group G1 is moved toward the object side along the optical axis relative to the last lens group G2 when the imaging optical lens system transitions from the first state to the second state in the focus adjustment process. Specifically, when the object distance changes from infinite to a finite object distance of 119.233 mm, the imaging optical lens system is transitioned from the first state to the second state, the axial distance D1 between the movable lens group G1 and the last lens group G2 increases from 0.540 mm in the first state to 1.337 mm in the second state, and the last lens group G2 is immovable relative to the reflective element E6 during the focus adjustment process. In other words, when the object distance decreases, the movable lens group G1 is moved toward the object side along the optical axis relative to the last lens group G2 during the focus adjustment process.

TABLE 10C
Aspheric Coefficients

| Surface # | 5 | 6 | 7 | 8 |
|---|---|---|---|---|
| k= | 0.000000000E+00 | 0.000000000E+00 | −3.763160000E−01 | 0.000000000E+00 |
| A4= | −9.469863639E−05 | 2.328110720E−02 | 1.244531986E−01 | 1.182313386E−01 |
| A6= | 7.769224649E−03 | 1.668382326E−03 | −1.016850475E−01 | −9.721582141E−02 |
| A8= | −1.384610344E−02 | −2.017222496E−02 | 6.640937067E−02 | 5.498550647E−02 |
| A10= | 1.264032258E−02 | 2.269253845E−02 | −3.507276662E−02 | −2.419374832E−02 |
| A12= | −7.372618320E−03 | −1.485980169E−02 | 1.481426489E−02 | 7.722914460E−03 |
| A14= | 2.889798089E−03 | 6.445289511E−03 | −4.754264528E−03 | −7.246259637E−04 |
| A16= | −7.727678781E−04 | −1.899454814E−03 | 1.107509108E−03 | −7.660384598E−04 |
| A18= | 1.407409649E−04 | 3.798327314E−04 | −1.813258674E−04 | 4.345984688E−04 |
| A20= | −1.713337036E−05 | −5.056035337E−05 | 2.021048420E−05 | −1.115358209E−04 |
| A22= | 1.331969689E−06 | 4.280347180E−06 | −1.458655059E−06 | 1.582264197E−05 |
| A24= | −5.973947970E−08 | −2.082951551E−07 | 6.157257003E−08 | −1.197078795E−06 |
| A26= | 1.175564463E−09 | 4.434250110E−09 | −1.157999974E−09 | 3.774975132E−08 |
| Surface # | 9 | 10 | 12 | 13 |
| k= | 0.000000000E+00 | 0.000000000E+00 | 0.000000000E+00 | 0.000000000E+00 |
| A4= | 3.515033830E−02 | 5.908401865E−04 | 5.569932432E−03 | 9.565165425E−03 |
| A6= | −2.829950731E−02 | 7.079814293E−03 | 1.803837657E−02 | 8.358844328E−03 |
| A8= | 1.781065552E−02 | −7.991290885E−03 | −2.322032207E−02 | −1.075557413E−02 |
| A10= | −1.372816183E−02 | 9.720316795E−04 | 1.841979401E−02 | 8.912007153E−03 |
| A12= | 7.919705678E−03 | 3.372927204E−03 | −9.626817167E−03 | −5.184392887E−03 |
| A14= | −1.990654229E−03 | −2.661234917E−03 | 3.268808729E−03 | 2.044477550E−03 |
| A16= | −3.373702456E−04 | 9.459065098E−04 | −6.889404632E−04 | −5.283180454E−04 |
| A18= | 3.827529589E−04 | −1.750171737E−04 | 7.900321598E−05 | 8.524196159E−05 |
| A20= | −1.156534184E−04 | 1.322281793E−05 | −2.395597388E−06 | −7.770724163E−06 |
| A22= | 1.784081261E−05 | 7.263173936E−07 | −4.093602631E−07 | 3.051880166E−07 |
| A24= | −1.428449022E−06 | −1.969977466E−07 | 3.296119319E−08 | — |
| A26= | 4.713882565E−08 | 9.928574266E−09 | — | — |

In the 10th embodiment, the equation of the aspheric surface profiles of the aforementioned lens elements is the same as the equation of the 1st embodiment. Also, the definitions of these parameters shown in Table 1 OD below are the same as those stated in the 1st embodiment, with corresponding values for the 10th embodiment; therefore, an explanation in this regard will not be provided again.

Moreover, these parameters can be calculated from Table 1CA to Table 10C as the following values and satisfy the following conditions:

TABLE 10D
Values of Optical and Physical Parameters/Definitions

| | | | |
|---|---|---|---|
| fL [mm] | 13.49 | fL/R5 | −4.28 |
| FnoL | 2.26 | \|f3/f2\| | 0.31 |
| HFOVL [deg.] | 14.8 | \|R3/fL\| + \|R4/fL\| | 2.73 |
| FOVL [deg.] | 29.6 | (R1 − R4)/(R1 + R4) | −1.87 |
| fS [mm] | 12.85 | (R1 − R5)/(R1 + R5) | 2.65 |
| FnoS | 2.50 | CT1/CT2 | 3.11 |
| HFOVS [deg.] | 13.2 | CT1/Dr3r8L | 0.47 |
| FOVS [deg.] | 26.4 | T23L/CT4 | 0.67 |
| TLS/TLL | 1.040 | 10 × T45L/fL | 0.30 |
| fL/fG1 | 1.40 | CT5/T45L | 0.84 |
| \|TDS − TDL\| [mm] | 0.80 | N1 | 1.954 |
| 10 × \|TDS − TDL\|/TDL | 1.77 | V5 | 21.3 |
| DG2/DG1 | 0.09 | V5/N5 | 12.86 |
| TLL/fL | 1.46 | ET12L/CT2 | 0.80 |
| BLL/TDL | 3.37 | Sag2R1L/CT2 | 0.45 |
| SDL/TDL | 1.01 | Y1R1L/Y5R2L | 1.50 |
| fL/f3 | −2.76 | Y1R1L/ImgH | 0.83 |
| T34L/CT2 | 1.18 | — | — |

### 11th Embodiment

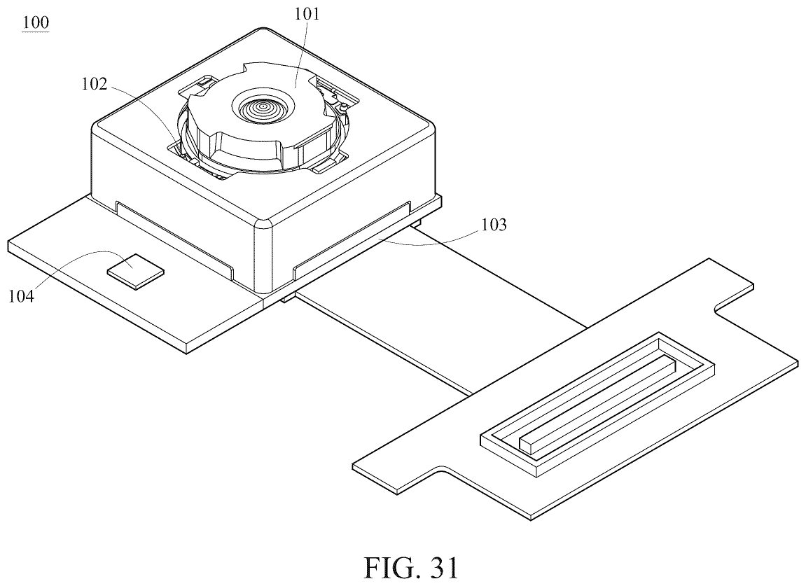

FIG. 31 is a perspective view of an image capturing unit according to the 11th embodiment of the present disclosure. In this embodiment, an image capturing unit 100 is a camera module including a lens unit 101, a driving device 102, an image sensor 103 and an image stabilizer 104. The lens unit 101 includes the imaging optical lens system as disclosed in the 1st embodiment, a barrel and a holder member (their reference numerals are omitted) for holding the imaging optical lens system. However, the lens unit 101 may alternatively be provided with the imaging optical lens system as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have an auto-focusing function, and different driving configurations can be achieved using lead screws, voice coil motors (VCM), micro electro-mechanical systems (MEMS), piezoelectric systems, shape memory alloys, spring type, or ball type driving systems, but the present disclosure is not limited thereto. The driving device 102 is favorable for obtaining a better imaging position for the lens unit 101, so that a clear image of the imaged object can be captured by the lens unit 101 with different object distances. The image sensor 103 (for example, CMOS or CCD), which can feature high photosensitivity and low noise, is disposed on the image surface of the imaging optical lens system to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in dynamic and low-light scenarios.

### 12th Embodiment

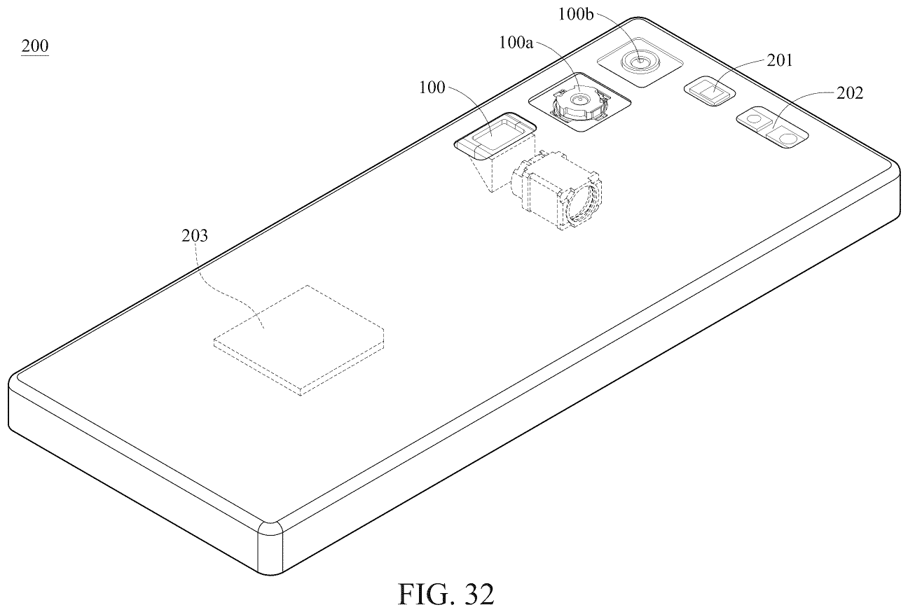

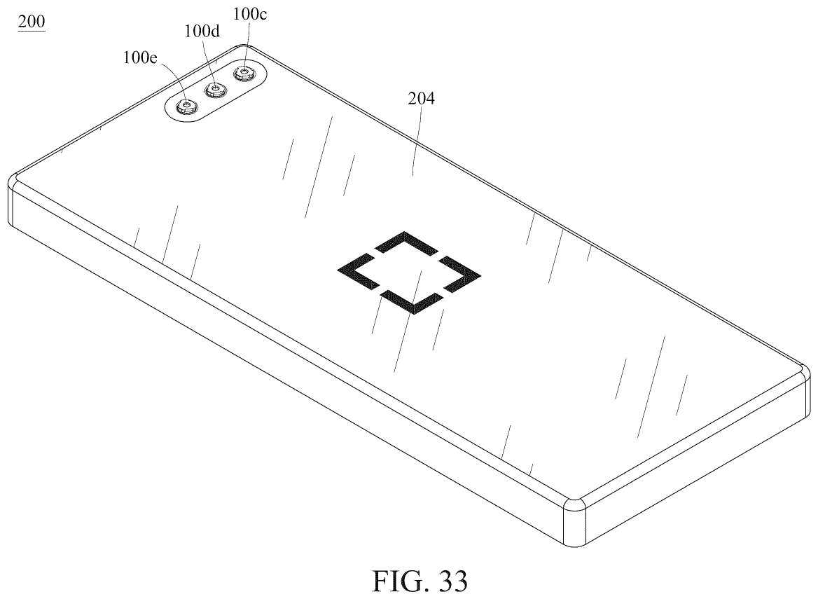

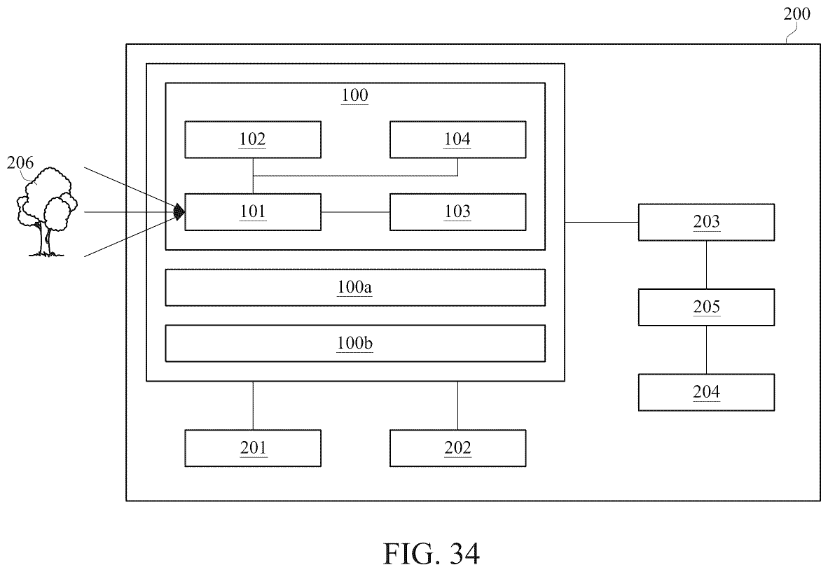

FIG. 32 is one perspective view of an electronic device according to the 12th embodiment of the present disclosure, FIG. 33 is another perspective view of the electronic device in FIG. 32, and FIG. 34 is a block diagram of the electronic device in FIG. 32.

In this embodiment, an electronic device 200 is a smartphone including the image capturing unit 100 as disclosed in the 11th embodiment, an image capturing unit 100a, an image capturing unit 100b, an image capturing unit 100c, an image capturing unit 100d, an image capturing unit 100e, a flash module 201, a focus assist module 202, an image signal processor 203, a display module 204 and an image software processor 205. The image capturing unit 100, the image capturing unit 100a and the image capturing unit 100b are disposed on the same side of the electronic device 200, and each of the image capturing units 100, 100a and 100b has a single focal point. The focus assist module 202 can be a laser rangefinder or a ToF (time of flight) module, but the present disclosure is not limited thereto. The image capturing unit 100c, the image capturing unit 100d, the image capturing unit 100e and the display module 204 are disposed on the opposite side of the electronic device 200, and the display module 204 can be a user interface, allowing the image capturing units 100c, 100d and 100e to serve as front-facing cameras of the electronic device 200 for taking selfies, but the present disclosure is not limited thereto. Furthermore, each of the image capturing units 100a, 100b, 100c, 100d and 100e can include the imaging optical lens system of the present disclosure and can have a configuration similar to that of the image capturing unit 100. In detail, each of the image capturing units 100a, 100b, 100c, 100d and 100e can include a lens unit, a driving device, an image sensor and an image stabilizer, and can also include a reflective element for folding optical path. In addition, each lens unit of the image capturing units 100a, 100b, 100c, 100d and 100e can include the imaging optical lens system of the present disclosure, a barrel and a holder member for holding the imaging optical lens system.

The image capturing unit 100 is a telephoto image capturing unit with optical path folding function, the image capturing unit 100a is a wide-angle image capturing unit, the image capturing unit 100b is an ultra-wide-angle image capturing unit, the image capturing unit 100c is a wide-angle image capturing unit, the image capturing unit 100d is an ultra-wide-angle image capturing unit, and the image capturing unit 100e is a ToF image capturing unit. In this embodiment, the image capturing units 100, 100a and 100b have different fields of view, such that the electronic device 200 can have various magnification ratios so as to meet the requirement of optical zoom functionality. In addition, the image capturing unit 100e can determine depth information of the imaged object. Moreover, the light-folding configuration of the image capturing unit 100 can be similar to, for example, one of the configurations as shown in FIG. 42 to FIG. 52, which can be referred to foregoing descriptions corresponding to FIG. 42 to FIG. 52, and the details in this regard will not be provided again. In addition, each of the image capturing units 100a, 100b, 100c, 100d and 100e can also have a light-folding configuration similar to, for example, one of the configurations as shown in FIG. 42 to FIG. 52, which can be referred to foregoing descriptions corresponding to FIG. 42 to FIG. 52, and the details in this regard will not be provided again. In this embodiment, the electronic device 200 includes multiple image capturing units 100, 100a, 100b, 100c, 100d and 100e, but the present disclosure is not limited to the number and arrangement of image capturing units.

When a user captures images of an object 206, the light rays converge in the image capturing unit 100, the image capturing unit 100a or the image capturing unit 100b to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100c, 100d or 100e to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 13th Embodiment

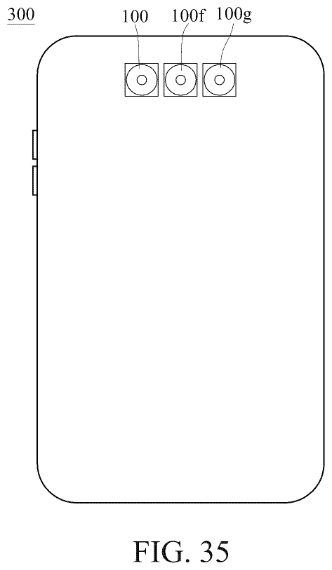

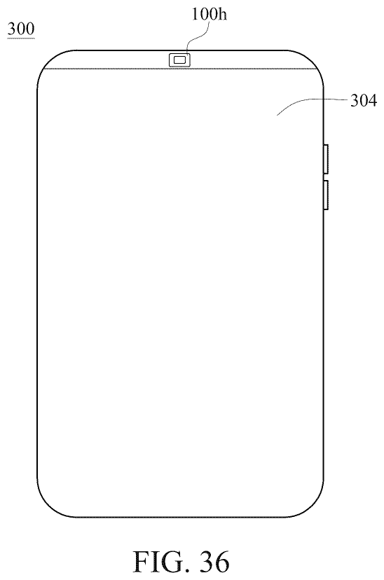

FIG. 35 is one schematic view of an electronic device according to the 13th embodiment of the present disclosure, and FIG. 36 is another schematic view of the electronic device in FIG. 35.

In this embodiment, an electronic device 300 is a smartphone including the image capturing unit 100 as disclosed in the 11th embodiment, an image capturing unit 100f, an image capturing unit 100g, an image capturing unit 100h and a display module 304. As shown in FIG. 35, the image capturing unit 100, the image capturing unit 100f and the image capturing unit 100g are disposed on the same side of the electronic device 300, and each of the image capturing units 100, 100f and 100g has a single focal point. As shown in FIG. 36, the image capturing unit 100h and the display module 304 are disposed on the opposite side of the electronic device 300, allowing the image capturing unit 100h to serve as a front-facing camera of the electronic device 300 for taking selfies, but the present disclosure is not limited thereto. Furthermore, each of the image capturing units 100f, 100g and 100h can include the imaging optical lens system of the present disclosure and can have a configuration similar to that of the image capturing unit 100. In detail, each of the image capturing units 100f, 100g and 100h can include a lens unit, a driving device, an image sensor and an image stabilizer. In addition, each lens unit of the image capturing units 100f, 100g and 100h can include the imaging optical lens system of the present disclosure, a barrel and a holder member for holding the imaging optical lens system.

The image capturing unit 100 is a telephoto image capturing unit, the image capturing unit 100f is a wide-angle image capturing unit, the image capturing unit 100g is an ultra-wide-angle image capturing unit, and the image capturing unit 100h is a wide-angle image capturing unit. In this embodiment, the image capturing units 100, 100f and 100g have different fields of view, such that the electronic device 300 can have various magnification ratios so as to meet the requirement of optical zoom functionality. Moreover, as shown in FIG. 36, the image capturing unit 100h can have a non-circular opening, and the barrel or lens elements in the image capturing unit 100h can have trimmed edges at their outermost positions so as to coordinate with the shape of the non-circular opening. Therefore, the single-axis length of the image capturing unit 100h can be further reduced, which is favorable for reducing the size of the image capturing unit 100h so as to increase the ratio of the area of the display module 304 relative to that of the electronic device 300, and reduce the thickness of the electronic device 300, thereby achieving compactness. Moreover, at least one of the lens elements can have a non-circular optically effective area when having trimmed edges at its outermost positions. In this embodiment, the electronic device 300 includes multiple image capturing units 100, 100f, 100g and 100h, but the present disclosure is not limited to the number and arrangement of image capturing units.

### 14th Embodiment

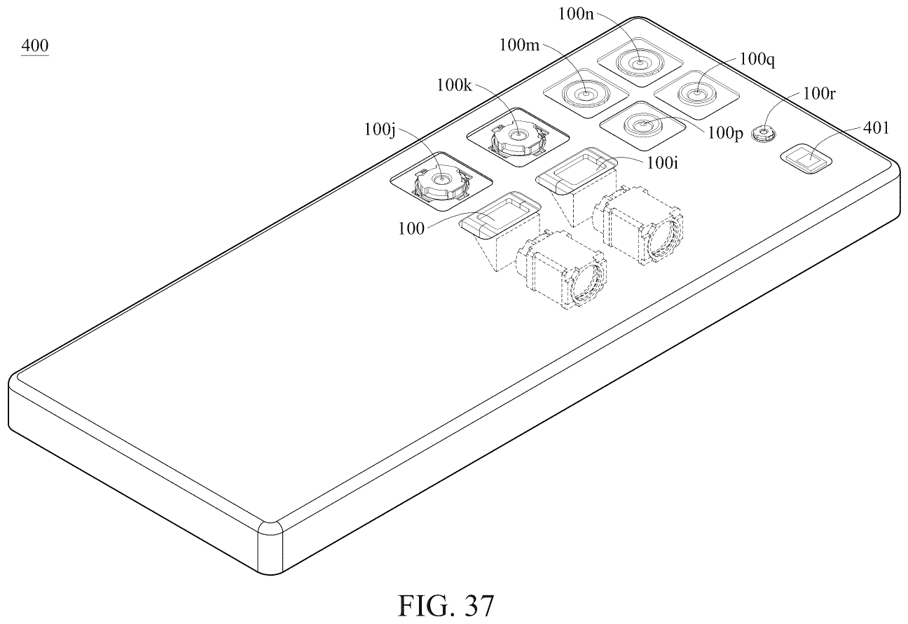

FIG. 37 is one perspective view of an electronic device according to the 14th embodiment of the present disclosure.

In this embodiment, an electronic device 400 is a smartphone including the image capturing unit 100 as disclosed in the 11th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module, and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the imaging optical lens system of the present disclosure and can have a configuration similar to that of the image capturing unit 100, and the details in this regard will not be provided again.

The image capturing unit 100 is a telephoto image capturing unit with optical path folding function, the image capturing unit 100i is a telephoto image capturing unit with optical path folding function, the image capturing unit 100j is a wide-angle image capturing unit, the image capturing unit 100k is a wide-angle image capturing unit, the image capturing unit 100m is an ultra-wide-angle image capturing unit, the image capturing unit 100n is an ultra-wide-angle image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p and 100q have different fields of view, such that the electronic device 400 can have various magnification ratios so as to meet the requirement of optical zoom functionality. In addition, the image capturing unit 100r can determine depth information of the imaged object. In addition, the light-folding configuration of each of the image capturing units 100 and 100i can be similar to, for example, one of the configurations as shown in FIG. 42 to FIG. 52, which can be referred to foregoing descriptions corresponding to FIG. 42 to FIG. 52, and the details in this regard will not be provided again. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

The smartphones in the embodiments are only exemplary for showing the image capturing unit of the present disclosure installed in an electronic device, and the present disclosure is not limited thereto. The image capturing unit can be optionally applied to optical systems with a movable focus. Furthermore, the imaging optical lens system of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, unmanned aerial vehicles, wearable devices, portable video recorders and other electronic imaging devices.

The foregoing description, for the purpose of explanation, has been described with reference to specific embodiments. It is to be noted that TABLES 1A-10D show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging optical lens system comprising five lens elements, the five lens elements being, in order from an object side to an image side along a traveling direction of an optical path, a first lens element, a second lens element, a third lens element, a fourth lens element and a fifth lens element, and each of the five lens elements having an object-side surface facing toward the object side and an image-side surface facing toward the image side;
wherein the first lens element has positive refractive power, the object-side surface of the first lens element is convex in a paraxial region thereof, the object-side surface of the second lens element is convex in a paraxial region thereof, the image-side surface of the second lens element is concave in a paraxial region thereof, the third lens element has negative refractive power, the object-side surface of the third lens element is concave in a paraxial region thereof, the fourth lens element has positive refractive power, and at least one surface of at least one lens element in the imaging optical lens system has at least one inflection point;
wherein the imaging optical lens system is in a first state when an imaged object is at an infinite object distance; and
wherein an axial distance between the object-side surface of one lens element closest to the object side and the image-side surface of another lens element closest to the image side in the imaging optical lens system as the imaging optical lens system is in the first state is TDL, an axial distance between the image-side surface of the another lens element closest to the image side and an image surface in the imaging optical lens system as the imaging optical lens system is in the first state is BLL, a curvature radius of the object-side surface of the first lens element is R1, a curvature radius of the object-side surface of the third lens element is R5, a focal length of the second lens element is f2, a focal length of the third lens element is f3, and the following conditions are satisfied:
$$2. < BLL / TDL < 5.5 ;$$
$$- 0.5 \; 0 < ( R 1 - R 5 ) / ( R 1 + R 5 ) < 5. ; and$$
$$0 < \vert f 3 / f 2 \vert < 1. .$$

2. The imaging optical lens system of claim 1, wherein the axial distance between the image-side surface of the another lens element closest to the image side and the image surface in the imaging optical lens system as the imaging optical lens system is in the first state is BLL, the axial distance between the object-side surface of the one lens element closest to the object side and the image-side surface of the another lens element closest to the image side in the imaging optical lens system as the imaging optical lens system is in the first state is TDL, and the following condition is satisfied:
$$2.3 < BLL / TDL < 4.50 .$$

3. The imaging optical lens system of claim 1, wherein the focal length of the second lens element is f2, the focal length of the third lens element is f3, and the following condition is satisfied:
$$0 < \vert f 3 / f 2 \vert < 0. 80 .$$

4. The imaging optical lens system of claim 1, wherein the fifth lens element has negative refractive power; and
wherein the curvature radius of the object-side surface of the first lens element is R1, the curvature radius of the object-side surface of the third lens element is R5, and the following condition is satisfied:
$$0.5 < ( R 1 - R 5 ) / ( R 1 + R 5 ) < 4.50 .$$

5. The imaging optical lens system of claim 1, wherein an axial distance between the object-side surface of the one lens element closest to the object side and the image surface in the imaging optical lens system as the imaging optical lens system is in the first state is TLL, a focal length of the imaging optical lens system in the first state is fL, an axial distance between the fourth lens element and the fifth lens element as the imaging optical lens system is in the first state is T45L, and the following conditions are satisfied:
$$1.3 < TLL / fL < 1.7 ; and$$
$$0.12 < 10 \times T 45 L / fL < 1. .$$

6. The imaging optical lens system of claim 1, wherein a focal length of the imaging optical lens system in the first state is fL, the focal length of the third lens element is f3, and the following condition is satisfied:
$$- 3.00 < fL / f 3 < - 1. .$$

7. The imaging optical lens system of claim 1, wherein the curvature radius of the object-side surface of the first lens element is R1, a curvature radius of the image-side surface of the second lens element is R4, an Abbe number of the fifth lens element is V5, and the following conditions are satisfied:
$$- 1. < ( R 1 - R 4 ) / ( R 1 + R 4 ) < 1.5 ; and$$
$$5. < V 5 < 30.0 .$$

8. The imaging optical lens system of claim 1, wherein an axial distance between the second lens element and the third lens element as the imaging optical lens system is in the first state is T23L, a central thickness of the fourth lens element is CT4, and the following condition is satisfied:
$$0.65 < T 23 L / CT 4 < 2.50 .$$

9. The imaging optical lens system of claim 1, wherein half of a maximum field of view of the imaging optical lens system in the first state is HFOVL, a maximum effective radius of the object-side surface of the first lens element as the imaging optical lens system is in the first state is Y1R1L, a maximum effective radius of the image-side surface of the fifth lens element as the imaging optical lens system is in the first state is Y5R2L, a maximum image height of the imaging optical lens system is ImgH, and the following conditions are satisfied:
$$8. degrees < HFOVL < 20. degrees ;$$
$$1.3 < Y 1 R 1 L / Y 5 R 2 L < 1.8 ; and$$
$$0.65 < Y 1 R 1 L / ImgH < 1.2 .$$

10. An image capturing unit comprising:
the imaging optical lens system of claim 1; and
an image sensor disposed on the image surface of the imaging optical lens system.

11. An electronic device comprising:
the image capturing unit of claim 10.

12. An imaging optical lens system comprising five lens elements, the five lens elements being, in order from an object side to an image side along a traveling direction of an optical path, a first lens element, a second lens element, a third lens element, a fourth lens element and a fifth lens element, and each of the five lens elements having an object-side surface facing toward the object side and an image-side surface facing toward the image side;
wherein the first lens element has positive refractive power, the object-side surface of the first lens element is convex in a paraxial region thereof, the object-side surface of the second lens element is convex in a paraxial region thereof, the third lens element has negative refractive power, the object-side surface of the third lens element is concave in a paraxial region thereof, the fourth lens element has positive refractive power, and at least one surface of at least one lens element in the imaging optical lens system has at least one inflection point;
wherein the imaging optical lens system is in a first state when an imaged object is at an infinite object distance; and
wherein an axial distance between the object-side surface of one lens element closest to the object side and the image-side surface of another lens element closest to the image side in the imaging optical lens system as the imaging optical lens system is in the first state is TDL, an axial distance between the image-side surface of the another lens element closest to the image side and an image surface in the imaging optical lens system as the imaging optical lens system is in the first state is BLL, a refractive index of the first lens element is N1, a refractive index of the fifth lens element is N5, an Abbe number of the fifth lens element is V5, a central thickness of the fifth lens element is CT5, an axial distance between the fourth lens element and the fifth lens element as the imaging optical lens system is in the first state is T45L, and the following conditions are satisfied:
$$2. < BLL / TDL < 5.5 ;$$
$$1.75 < N 1 < 2 \text{.200} ;$$
$$5. < V 5 / N 5 < 15.2 ; and$$
$$0.1 < CT 5 / T 45 L < 3.00 .$$

13. The imaging optical lens system of claim 12, wherein an f-number of the imaging optical lens system in the first state is FnoL, the central thickness of the fifth lens element is CT5, the axial distance between the fourth lens element and the fifth lens element as the imaging optical lens system is in the first state is T45L, and the following conditions are satisfied:
$$1.8 < FnoL < 2.5 ; and$$
$$0.15 < CT 5 / T 45 L < 2.00 .$$

14. The imaging optical lens system of claim 12, wherein a central thickness of the first lens element is CT1, a central thickness of the second lens element is CT2, a focal length of the imaging optical lens system in the first state is fL, a curvature radius of the object-side surface of the third lens element is R5, and the following conditions are satisfied:
$$0.5 < CT 1 / CT 2 < 2.2 ; and$$
$$- 9. 0 < fL / R 5 < - 2.00 .$$

15. The imaging optical lens system of claim 12, wherein the second lens element has positive refractive power; and
wherein a curvature radius of the object-side surface of the second lens element is R3, a curvature radius of the image-side surface of the second lens element is R4, a focal length of the imaging optical lens system in the first state is fL, and the following condition is satisfied:
$$0.2 < \vert R 3 / fL \vert + \vert R 4 / fL \vert < 2.2 .$$

16. The imaging optical lens system of claim 12, wherein the first lens element is made of glass material; and
wherein the refractive index of the first lens element is N1, and the following condition is satisfied:
$$1. 800 < N 1 < 2.100 .$$

17. The imaging optical lens system of claim 12, further comprising an aperture stop, wherein an axial distance between the aperture stop and the image-side surface of the another lens element closest to the image side in the imaging optical lens system as the imaging optical lens system is in the first state is SDL, the axial distance between the object-side surface of the one lens element closest to the object side and the image-side surface of the another lens element closest to the image side in the imaging optical lens system as the imaging optical lens system is in the first state is TDL, and the following condition is satisfied:
$$0.87 < SDL / TDL < 1.2 .$$

18. The imaging optical lens system of claim 12, wherein at least one surface of at least one lens element in the imaging optical lens system has at least one critical point in an off-axis region thereof; and
wherein an axial distance between the third lens element and the fourth lens element as the imaging optical lens system is in the first state is T34L, a central thickness of the second lens element is CT2, and the following condition is satisfied:
$$0.8 < T 34 L / CT 2 < 2.00 .$$

19. The imaging optical lens system of claim 12, wherein a displacement in parallel with an optical axis from an axial vertex of the object-side surface of the second lens element to a maximum effective radius position of the object-side surface of the second lens element as the imaging optical lens system is in the first state is Sag2R1L, a central thickness of the second lens element is CT2, a distance in parallel with the optical axis between a maximum effective radius position of the image-side surface of the first lens element and the maximum effective radius position of the object-side surface of the second lens element as the imaging optical lens system is in the first state is ET12L, and the following conditions are satisfied:
$$0.4 < Sag 2 R 1 L / CT 2 < 1.2 ; and$$
$$0.7 < ET 12 L / CT 2 < 1.5 .$$

20. The imaging optical lens system of claim 12, wherein the axial distance between the image-side surface of the another lens element closest to the image side and the image surface in the imaging optical lens system as the imaging optical lens system is in the first state is BLL, the axial distance between the object-side surface of the one lens element closest to the object side and the image-side surface of the another lens element closest to the image side in the imaging optical lens system as the imaging optical lens system is in the first state is TDL, a curvature radius of the object-side surface of the first lens element is R1, a curvature radius of the object-side surface of the third lens element is R5, a focal length of the imaging optical lens system in the first state is fL, a focal length of the second lens element is f2, a focal length of the third lens element is f3, the refractive index of the first lens element is N1, a refractive index of the fifth lens element is N5, an Abbe number of the fifth lens element is V5, the central thickness of the fifth lens element is CT5, the axial distance between the fourth lens element and the fifth lens element as the imaging optical lens system is in the first state is T45L, and the following conditions are satisfied:
$$2.67 \leq BLL / TDL \leq 3.76 ;$$
$$1.36 \leq ( R 1 - R 5 ) / ( R 1 + R 5 ) \leq 3 \text{.46} ;$$
$$0.02 \leq \vert f 3 / f 2 \vert \leq 0.4 ;$$
$$1.883 \leq N 1 \leq 1.954 ;$$
$$10.91 \leq V 5 / N 5 \leq 14 \text{.34} ;$$
$$0.3 \leq CT 5 / T 45 L \leq 0.87 ; and$$
$$- 2.7 \; 6 \leq fL / f 3 \leq - 1.48 .$$

21. An imaging optical lens system comprising a movable lens group and a last lens group in order from an object side to an image side along a traveling direction of an optical path, the movable lens group comprising at least one lens element, the last lens group comprising at least one lens element, and each lens element in the imaging optical lens system having an object-side surface facing toward the object side and an image-side surface facing toward the image side;
wherein the imaging optical lens system is in a first state when an imaged object is at an infinite object distance, the imaging optical lens system is in a second state when an imaged object is at a finite object distance, the imaging optical lens system undergoes a focus adjustment process to transition from the first state to the second state when an imaged object is moved from an infinite object distance to a finite object distance, and the movable lens group is moved along an optical axis relative to the last lens group when the imaging optical lens system transitions from the first state to the second state in the focus adjustment process;
wherein the object-side surface of one lens element closest to the object side in the imaging optical lens system is convex in a paraxial region thereof, and at least one surface of at least one lens element in the imaging optical lens system has at least one inflection point; and
wherein an axial distance between the object-side surface of the one lens element closest to the object side and the image-side surface of another lens element closest to the image side in the imaging optical lens system as the imaging optical lens system is in the first state is TDL, an axial distance between the image-side surface of the another lens element closest to the image side and an image surface in the imaging optical lens system as the imaging optical lens system is in the first state is BLL, an f-number of the imaging optical lens system in the first state is FnoL, and the following conditions are satisfied:
$$2. < BLL / TDL < 5.5 ; and$$
$$1.8 < FnoL < 2.5 .$$

22. The imaging optical lens system of claim 21, wherein a focal length of the imaging optical lens system in the first state is fL, a focal length of the movable lens group is fG1, an axial distance between the object-side surface of the one lens element closest to the object side and the image-side surface of the another lens element closest to the image side in the imaging optical lens system as the imaging optical lens system is in the second state is TDS, the axial distance between the object-side surface of the one lens element closest to the object side and the image-side surface of the another lens element closest to the image side in the imaging optical lens system as the imaging optical lens system is in the first state is TDL, and the following conditions are satisfied:
$$0.8 < fL / fG 1 < 1.8 ; and$$
$$0.3 mm < \vert TDS - TDL \vert < 1.1 mm .$$

23. The imaging optical lens system of claim 21, wherein an axial distance between the object-side surface of one lens element closest to the object side and the image-side surface of another lens element closest to the image side in the movable lens group is DG1, an axial distance between the object-side surface of one lens element closest to the object side and the image-side surface of another lens element closest to the image side in the last lens group is DG2, and the following condition is satisfied:
$$0.01 < DG 2 / DG 1 < 0.40 .$$

24. The imaging optical lens system of claim 21, wherein an axial distance between the object-side surface of the one lens element closest to the object side and the image-side surface of the another lens element closest to the image side in the imaging optical lens system as the imaging optical lens system is in the second state is TDS, the axial distance between the object-side surface of the one lens element closest to the object side and the image-side surface of the another lens element closest to the image side in the imaging optical lens system as the imaging optical lens system is in the first state is TDL, an axial distance between the object-side surface of the one lens element closest to the object side and the image surface in the imaging optical lens system as the imaging optical lens system is in the second state is TLS, an axial distance between the object-side surface of the one lens element closest to the object side and the image surface in the imaging optical lens system as the imaging optical lens system is in the first state is TLL, and the following conditions are satisfied:
$$1. < 10 \times \vert TDS - TDL \vert / TDL < 2.5 ; and$$
$$1.025 < TLS / TLL < 1.1 .$$

25. The imaging optical lens system of claim 21, further comprising a reflective element, wherein the reflective element is located between the last lens group and the image surface along the traveling direction of the optical path, and no additional lens element is located between the last lens group and the reflective element along the optical axis; and
wherein the last lens group is immovable relative to the reflective element during the focus adjustment process.

26. The imaging optical lens system of claim 21, wherein the imaging optical lens system comprises five lens elements, the five lens elements are, in order from the object side to the image side along the traveling direction of the optical path, a first lens element, a second lens element, a third lens element, a fourth lens element and a fifth lens element, the movable lens group comprises the first lens element, the second lens element, the third lens element and the fourth lens element, the last lens group comprises the fifth lens element, all lens elements in the movable lens group are immovable relative to one another during the focus adjustment process, all lens elements in the last lens group are immovable relative to one another during the focus adjustment process, and the first lens element has positive refractive power.

27. The imaging optical lens system of claim 26, wherein the object-side surface of the second lens element is convex in a paraxial region thereof, the object-side surface of the third lens element is concave in a paraxial region thereof, and the third lens element has negative refractive power.

28. The imaging optical lens system of claim 26, wherein the fourth lens element has positive refractive power; and
wherein a central thickness of the first lens element is CT1, an axial distance between the object-side surface of the second lens element and the image-side surface of the fourth lens element as the imaging optical lens system is in the first state is Dr3r8L, and the following condition is satisfied:
$$0.15 < CT 1 / Dr 3 r 8 L < 0.65 .$$

29. The imaging optical lens system of claim 21, further comprising a prism, wherein the prism is located between the last lens group and the image surface along the traveling direction of the optical path, and the prism has at least two reflective surfaces.

30. The imaging optical lens system of claim 29, wherein the prism further has a first light permeable surface, the at least two reflective surfaces of the prism comprise a first reflective surface and a second reflective surface in order from the object side to the image side along the traveling direction of the optical path, and the first light permeable surface, the first reflective surface and the second reflective surface are arranged in order from the object side to the image side along the traveling direction of the optical path; and
wherein the first light permeable surface and the second reflective surface are coplanar.
